(19) United States
(12) Patent Application Publication
(10) Pub. No.: US 2026/0088904 A1
(43) Pub. Date: Mar. 26, 2026

(54) INTEGRATED HIGH-SPEED HIGH-CHANNEL-COUNT OPTICAL TRANSCEIVERS

(71) Applicant: Artilux, Inc., Menlo Park, CA (US)

(72) Inventors: Neil Y. Na, San Jose, CA (US); Yen-Ju Lin, Hsinchu County (TW); Chien-Yu Chen, Hsinchu County (TW); Yu-Hsuan Liu, Hsinchu County (TW); Andrew I. Shieh, Hsinchu County (TW); Chia-Peng Lin, Hsinchu County (TW); Jian-Wen Lai, Hsinchu County (TW); Che-Fu Liang, Hsinchu County (TW); Shu-Lu Chen, Hsinchu County (TW)

(21) Appl. No.: 19/330,774

(22) Filed: Sep. 16, 2025

Related U.S. Application Data
(60) Provisional application No. 63/697,577, filed on Sep. 22, 2024.
(60) Provisional application No. 63/734,751, filed on Dec. 17, 2024.
(60) Provisional application No. 63/739,670, filed on Dec. 29, 2024.
(60) Provisional application No. 63/742,422, filed on Jan. 6, 2025.
(60) Provisional application No. 63/795,639, filed on Apr. 28, 2025.
(60) Provisional application No. 63/798,523, filed on May 1, 2025.

(51) Int. Cl. H04B 10/40; H04B 10/54; H04B 10/69

(52) U.S. Cl. CPC H04B 10/40; H04B 10/541; H04B 10/6911

(57) ABSTRACT

An optical link includes an optical transceiver. The optical transceiver includes an optical-emitter chip having multiple light sources configured to emit first optical signals in parallel, an optical-receiver chip having multiple photodetectors configured to detect second optical signals in parallel, and a circuitry chip having circuitry configured to control the optical-emitter chip and the optical-receiver chip. The optical-receiver chip is stacked between the optical-emitter chip and the circuitry chip.

### CROSS-REFERENCE TO RELATED APPLICATIONS

This application claims the benefit of U.S. Provisional Patent Application No. 63/697,577 filed Sep. 22, 2024, U.S. Provisional Patent Application No. 63/734,751 filed Dec. 17, 2024, U.S. Provisional Patent Application No. 63/739,670 filed Dec. 29, 2024, U.S. Provisional Patent Application No. 63/742,422 filed Jan. 6, 2025, U.S. Provisional Patent Application No. 63/795,639 filed Apr. 28, 2025, and U.S. Provisional Patent Application No. 63/798,523 filed May 1, 2025, all of which are incorporated by reference herein in their entireties.

### TECHNICAL FIELD

This application relates to optical transceivers for data communications.

### BACKGROUND

An optical transceiver is configured to transmit and receive data using light over an optical medium (e.g., an optical fiber). It converts electrical signals into optical signals for transmission, and optical signals back into electrical signals upon reception, enabling high-speed data communication between devices.

### SUMMARY

The present disclosure describes methods, circuits, devices, systems and techniques for data communications using integrated optical transceivers, e.g., integrated high-speed high-channel-count optical transceivers.

One aspect of the present disclosure features an optical link, including an optical transceiver. The optical transceiver includes: an optical-emitter chip having multiple light sources configured to emit first optical signals in parallel; an optical-receiver chip having multiple photodetectors configured to detect second optical signals in parallel; and a circuitry chip having circuitry configured to control the optical-emitter chip and the optical-receiver chip. The optical-receiver chip is stacked between the optical-emitter chip and the circuitry chip.

In some implementations, the optical link further includes a fiber-array unit having a first group of fibers and a second group of fibers, where the first group of fibers is optically coupled to the multiple light sources, and where the second group of fibers is optically coupled to the multiple photodetectors.

In some implementations, each of the first group of fibers and the second group of fibers includes multiple multi-mode fibers.

In some implementations, the first group of fibers forms a first fiber array and the second group of fibers forms a second fiber array, and the first fiber array and the second fiber array are separated from each other in the fiber-array unit.

In some implementations, the first group of fibers and the second group of fibers form a single fiber array, and the optical-emitter chip includes openings having a predetermined arrangement configured to expose corresponding photodetectors of the optical-receiver chip to the second group of fibers.

In some implementations, each of the multiple light sources includes a micro-light-emitting-diode (micro-LED) or a vertical-cavity surface-emitting laser (VCSEL).

In some implementations, each of the multiple light sources includes a micro lens or metalens formed over the micro-LED or the VCSEL.

In some implementations, the multiple photodetectors include photodiodes (PD) or avalanche photodiodes (APD).

In some implementations, the optical transceiver is packaged on a printed-circuit-board.

In some implementations, the optical transceiver is packaged on a multi-chip module (MCM) substrate.

In some implementations, the optical transceiver is packaged on an interposer.

In some implementations, the optical transceiver is packaged on a processor chip or a memory.

In some implementations, the processor chip includes one or more of a graphics processing unit (GPU) chip, a central processing unit (CPU) chip, or a neural processing unit (NPU) chip.

In some implementations, the multiple light sources are arranged in a two-dimensional array, and where the multiple photodetectors are arranged in a two-dimensional array.

In some implementations, each of the multiple photodetectors includes multiple subsets of photodetectors, and where each subset of photodetectors is electrically binned together to detect optical signals from a corresponding light source of the multiple light sources.

In some implementations, a wavelength of the first optical signals emitted by the multiple light sources is in a visible wavelength range.

In some implementations, a wavelength of the first optical signals emitted by the multiple light sources is in a near-infrared or a short-wave-infrared wavelength range.

In some implementations, each of the multiple photodetectors includes a silicon absorption region.

In some implementations, each of the multiple photodetectors includes a silicon layer including: a trench filled with a dielectric material; an n-doped region at least partially surrounding the trench; a p-doped region; and the silicon absorption region formed between the n-doped region and the p-doped region.

In some implementations, a thickness of the silicon layer is greater than an absorption length associated with a wavelength of the second optical signals, and where a thickness of the p-doped region is less than the absorption length.

In some implementations, the optical link further includes an optical element formed over a single photodetector or the multiple photodetectors, where the optical element includes at least one of a micro lens or a metalens.

In some implementations, each of the multiple photodetectors includes a germanium absorption region.

In some implementations, each of the multiple photodetectors includes a silicon layer including: a trench filled with a germanium region, where the germanium region includes the germanium absorption region formed between two p-doped regions each having a respective dopant concentration higher than a dopant concentration of the germanium absorption region; and a silicon structure for extracting or amplifying photo-carriers generated by the absorption region.

In some implementations, the optical link further includes an optical element formed over a single photodetector or the multiple photodetectors, where the optical element includes at least one of a micro lens or a metalens.

In some implementations, the optical link further includes an isolation structure in a wafer or in a module to reduce an optical cross-talk between the optical-emitter chip and the optical-receiver chip.

In some implementations, the circuitry chip includes a receiver circuitry.

In some implementations, the receiver circuitry includes a transimpedance amplifier (TIA) circuitry.

In some implementations, the receiver circuitry includes no transimpedance amplifier (TIA) circuitry.

In some implementations, the optical transceiver is configured to receive electrical data at a first data rate over a first number of lanes, and to output optical data at a second data rate over a second number of lanes, where the first data rate and the second data rate are different, and where the first number of lanes and the second number of lanes are different.

In some implementations, the electrical data is encoded using a first encoding scheme, and where the optical data is encoded using a second encoding scheme.

In some implementations, the first encoding scheme is a PAM4 encoding scheme, and where the second encoding scheme is an NRZ encoding scheme.

In some implementations, the optical transceiver includes: a transmitter (TX) encoding converter configured to receive the electrical data having the first encoding scheme at the first data rate, and convert the electrical data having the first encoding scheme into second electrical data having a second encoding scheme at the first data rate; a TX data rate converter configured to receive the second electrical data having the second encoding scheme at the first data rate from the TX encoding converter, and convert the second electrical data into third electrical data having the second encoding scheme at the second data rate; and a TX electrical/optical (E/O) interface configured to receive the third electrical data from the TX data rate converter, and output the optical data representing the third electrical data.

In some implementations, the TX E/O interface includes the optical-emitter chip.

In some implementations, the optical transceiver includes: a receiver (RX) encoding converter; a RX data rate converter; and a RX O/E interface.

In some implementations, the RX O/E interface includes the optical-receiver chip.

Another aspect of the present disclosure features a photodetector including a silicon layer having a first surface and a second surface. The silicon layer includes: a trench formed along the first surface; an n-doped region; a p-doped region; and an absorption region formed between the n-doped region and the p-doped region. The absorption region is configured to receive an optical signal and convert the optical signal into an electrical signal. A thickness of the absorption region is smaller than a distance between the first surface and the second surface.

In some implementations, the trench is filled with a dielectric material.

In some implementations, the trench is at least partially surrounded by the n-doped region configured to couple at least a portion the electrical signal to a conductive region.

In some implementations, the photodetector further includes a via formed inside the trench, where the via is configured to couple at least a portion the electrical signal to a conductive region.

In some implementations, the trench is filled with a semiconductor material, and where the photodetector further includes a cladding layer formed over the first surface of the silicon layer, and a via formed inside the cladding layer to couple at least a portion the electrical signal to a conductive region.

In some implementations, a thickness of the silicon layer is greater than an absorption length associated with a wavelength of the optical signal, and where a thickness of the p-doped region is less than the absorption length.

In some implementations, the photodetector further includes an optical element formed over the second surface of the silicon layer, where the optical element includes at least one of a micro lens or a metalens.

In some implementations, the p-doped region is patterned to form one or more undoped regions for receiving the optical signal.

In some implementations, the photodetector further includes: a first dielectric layer formed over the second surface of the silicon layer; a first conductive region formed in the first dielectric layer; a second dielectric layer formed over the first dielectric layer; a second conductive region formed in the second dielectric layer; and a through-silicon-via formed in the silicon layer. The first conductive region is coupled to the p-doped region and the second conductive region. The through-silicon-via is coupled to the second conductive region.

In some implementations, the photodetector further includes a cladding layer formed over the first surface of the silicon layer.

Another aspect of the present disclosure features an optical link, including an optical-receiver chip having multiple photodetectors configured to detect optical signals in parallel, where each photodetector of the multiple photodetectors includes the photodetector according to any implementation of the present disclosure.

Another aspect of the present disclosure features a photodetector including a silicon layer having a first surface and a second surface. The silicon layer includes: a first p-doped region; an n-doped region; a second p-doped region formed between the first p-doped region and the n-doped region; an absorption region formed between the first p-doped region and the second p-doped region, where the absorption region is configured to receive an optical signal and convert at least a first part of the optical signal into an electrical signal having electrons and holes; and an amplification region formed between the second p-doped region and the n-doped region, where the amplification region is configured to amplify the electrons.

In some implementations, the silicon layer further includes a trench formed along the first surface.

In some implementations, the trench is filled with a dielectric material.

In some implementations, a thickness of the absorption region is smaller than a distance between the first surface and the second surface.

In some implementations, the first p-doped region is more highly-doped than the second p-doped region.

In some implementations, the amplified electrons are collected as a readout signal.

Another aspect of the present disclosure features an optical link, including: an optical-receiver chip having multiple photodetectors configured to detect optical signals in parallel, where each photodetector of the multiple photodetectors includes the photodetector according to any implementation of the present disclosure.

Another aspect of the present disclosure features a photodetector including a silicon layer having a first surface and a second surface. The silicon layer includes: a p-doped region; a first n-doped region; a second n-doped region formed between the first n-doped region and the p-doped region; an absorption region formed between the first n-doped region and the second n-doped region, where the absorption region is configured to receive an optical signal and convert at least a first part of the optical signal into an electrical signal having electrons and holes; and an amplification region formed between the p-doped region and the second n-doped region, where the amplification region is configured to amplify the electrons.

In some implementations, the silicon layer further includes a trench formed along the first surface.

In some implementations, the trench is filled with a dielectric material.

In some implementations, a thickness of the absorption region is smaller than a distance between the first surface and the second surface.

In some implementations, the first n-doped region is more highly-doped than the second n-doped region.

In some implementations, the amplified electrons are collected as a readout signal.

Another aspect of the present disclosure features an optical link, including: an optical-receiver chip having multiple photodetectors configured to detect optical signals in parallel, where each photodetector of the multiple photodetectors includes the photodetector according to any implementation of the present disclosure.

Another aspect of the present disclosure features a photodetector including a silicon layer having a first surface and a second surface. The silicon layer includes: a trench formed along the first surface; an n-doped region; a p-doped region formed along the second surface; a first absorption region formed between the n-doped region and the p-doped region; and a second absorption region formed in the trench. The n-doped region and the p-doped region are biased to form an amplification region in the first absorption region.

In some implementations, the n-doped region and the second absorption region are reverse-biased.

In some implementations, the n-doped region and the second absorption region are electrically shorted.

In some implementations, during an operation of the photodetector, the first absorption region is configured to receive an optical signal and convert a first portion of the optical signal into a first electrical signal having holes and electrons, where the holes are collected by the p-doped region, and where the electrons are amplified by the first absorption region and collected by the n-doped region as a readout signal.

In some implementations, the second absorption region is configured to receive a second portion of the optical signal and convert the second portion of the optical signal into a second electrical signal having second holes and second electrons.

In some implementations, the second absorption region includes a second p-doped region configured to collect the second holes, and where the second electrons are drifted to and collected by the n-region as a readout signal.

Another aspect of the present disclosure features an optical link including: an optical-receiver chip having multiple photodetectors configured to detect optical signals in parallel, where each photodetector of the multiple photodetectors includes the photodetector according to any implementation of the present disclosure.

Another aspect of the present disclosure features a photodetector including a silicon layer having a first surface and a second surface. The silicon layer includes: a buried-dopant region formed near the second surface, where the buried-dopant region is configured to collect a first type of photo-carriers; and an intrinsic region. The photodetector further includes: a germanium region including an absorption region configured to receive an optical signal; and a highly-doped region formed near the first surface and configured to collect a second type of photo-carriers.

In some implementations, the buried-dopant region is n-doped, and the highly-doped region is p-doped.

In some implementations, the buried-dopant region is p-doped, and the highly-doped region is n-doped.

In some implementations, the germanium region is filled in a trench formed near the second surface, and where the photodetector is arranged such that the optical signal enters the germanium region before the intrinsic region of the silicon.

In some implementations, the highly-doped region is formed in the silicon layer.

In some implementations, the germanium region is filled in a trench formed near the first surface, and where the photodetector is arranged such that the optical signal enters the intrinsic region of the silicon before the germanium region.

In some implementations, the highly-doped region is formed in the germanium region.

In some implementations, the silicon layer further includes an interface-dopant region formed between the germanium region and the intrinsic region of the silicon layer, where the highly-doped region and the interface-dopant region are p-doped, and where the buried-dopant region is n-doped.

In some implementations, during an operation of the photodetector, the photodetector is reverse-biased to form an avalanche region in the intrinsic region of the silicon layer.

In some implementations, at least one or more properties of the interface-dopant region or the buried-dopant region is controlled to form one or more blocking regions surrounding one or more punch-through regions. The one or more punch-through regions have a first break-down voltage lower than a second break-down voltage associated with the one or more blocking regions, such that a carrier collection or a carrier amplification begins to occur in the one or more punch-through regions before the one or more blocking regions.

In some implementations, the photodetector further includes an optical element formed over the second surface of the silicon layer, where the optical element includes at least one of a micro lens or a metalens.

In some implementations, the buried-dopant region is patterned to form one or more undoped regions for receiving the optical signal.

In some implementations, a thickness of the buried-dopant region is smaller than an absorption length associated with a wavelength of the optical signal.

Another aspect of the present disclosure features an optical link including: an optical-receiver chip having multiple photodetectors configured to detect optical signals in parallel, where each photodetector of the multiple photodetectors includes the photodetector according to any implementation of the present disclosure.

Another aspect of the present disclosure features a photodetector including: a high-conductivity region that is p-doped; a high-field region that is n-doped; and an absorption region arranged between the high-conductivity region and the high-field region. The absorption region is configured to receive an optical signal and to generate electrons and holes. The high-conductivity region is configured to collect at least a portion of the holes. The high-field region is configured to collect at least a portion of the electrons. A peak doping concentration of the absorption region is lower than a peak doping concentration of the high-conductivity region. A thickness of the high-field region is smaller than an absorption length associated with a wavelength of the optical signal.

In some implementations, the wavelength of the optical signal is in a visible wavelength spectrum.

In some implementations, the high-conductivity region includes one of germanium, silicon, amorphous silicon, or silicon carbide.

In some implementations, the high-field region includes silicon.

In some implementations, the absorption region includes germanium.

Another aspect of the present disclosure features an optical link, including: a first optical waveguide; an optical emitter having multiple first light sources optically coupled with the first optical waveguide; a processor configured to control the optical emitter; and an optical receiver having one or more first photodetectors optically coupled with the first optical waveguide, where a count of the multiple first light sources is different from a count of the one or more first photodetectors.

In some implementations, the multiple first light sources are arranged in a one-dimensional array or a two-dimensional array on a first substrate, and the one or more first photodetectors are arranged in a one-dimensional array or a two-dimensional array on a second substrate.

In some implementations, the optical link further includes a second waveguide. The optical emitter further includes multiple second light sources optically coupled with the second optical waveguide. The optical receiver further includes one or more second photodetectors optically coupled with the second optical waveguide. The multiple second light sources are arranged in a one-dimensional array or a two-dimensional array on the substrate. The first optical waveguide and the second optical waveguide include optical fibers in a fiber array having multiple optical fibers.

In some implementations, the multiple first light sources include micro-light-emitting-diodes (micro-LED) or vertical-cavity surface-emitting lasers (VCSEL).

In some implementations, the multiple first light sources further include microcavity structures or nanocavity structures configured to enhance a spontaneous emission rate of the multiple first light sources.

In some implementations, the optical link further includes: one or more first optical elements configured to guide optical signals transmitted by the multiple first light sources to the first optical waveguide; and one or more second optical elements configured to guide optical signals from the first optical waveguide to the one or more first photodetectors.

In some implementations, the optical emitter is co-packaged with a first processor chip or a first memory, and where the optical receiver is co-packaged with a second processor chip or a second memory.

In some implementations, each of the first processor chip and the second processor chip includes one or more of a graphics processing unit (GPU) chip, a central processing unit (CPU) chip, or a neural processing unit (NPU) chip.

In some implementations, the multiple first light sources include one or more first primary light sources and one or more first redundant light sources, and the processor is configured to control the multiple first light sources such that at least one of the one or more first primary light sources transmits optical signals, and at least one of the one or more first redundant light sources does not transmit optical signals.

In some implementations, the processor is further configured to: determine that a primary light source of the one or more first primary light sources has malfunctioned; and in response to determining that the primary light source of the one or more first primary light sources has malfunctioned, control the multiple first light sources such that the primary light source stops transmitting optical signals, and one of the one or more first redundant light sources transmits optical signals.

In some implementations, determining that the primary light source of the one or more first primary light sources has malfunctioned includes: determining that a total power transmitted by the one or more first primary light sources is below a threshold value; and in response to determining that the total power is below the threshold value, determining whether the primary light source has malfunctioned.

In some implementations, optical signals emitted by the optical emitter are encoded by a non-return-to-zero (NRZ) coding scheme.

In some implementations, optical signals emitted by the optical emitter are encoded by a pulse-amplitude-modulation (PAM) coding scheme having more than two levels, and where a specific level of the PAM coding scheme is represented by a number of the multiple first light sources that emit the optical signals.

In some implementations, the processor is further configured to control the number of the multiple first light sources to emit the optical signals based on the specific level of the PAM coding scheme associated with data.

Another aspect of the present disclosure features an optical device, including: an optical emitter having multiple first light sources optically coupled with a first optical waveguide, where the multiple first light sources include one or more first primary light sources and one or more first redundant light sources; and a processor configured to control the multiple first light sources such that at least one of the one or more first primary light sources transmits optical signals, and at least one of the one or more first redundant light sources does not transmit optical signals.

In some implementations, where the multiple first light sources are arranged in a one-dimensional array or a two-dimensional array on a substrate.

In some implementations, the optical emitter further includes multiple second light sources optically coupled with a second optical waveguide. The multiple second light sources include one or more second primary light sources and one or more second redundant light sources. The multiple second light sources are arranged in a one-dimensional array or a two-dimensional array on the substrate. The processor is further configured to control the multiple second light sources such that at least one of the one or more second primary light sources transmits optical signals, and at least one of the one or more second light sources does not transmit optical signals.

In some implementations, the multiple first light sources and the multiple second light sources include micro-light-emitting-diodes (micro-LEDs) or vertical-cavity surface-emitting lasers (VCSELs).

In some implementations, the first optical waveguide and the second optical waveguide include optical fibers in a fiber array having multiple optical fibers.

In some implementations, the processor is further configured to: determine that a primary light source of the one or more first primary light sources has malfunctioned; and in response to determining that the primary light source of the one or more first primary light sources has malfunctioned, control the multiple first light sources such that the primary light source stops transmitting optical signals, and one of the one or more first redundant light sources transmits optical signals.

In some implementations, determining that the primary light source of the one or more first primary light sources has malfunctioned includes: determining that a total power transmitted by the one or more first primary light sources is below a threshold value; and in response to determining that the total power is below the threshold value, determining whether the primary light source has malfunctioned.

In some implementations, the optical device further includes one or more optical elements configured to guide optical signals transmitted by the multiple first light sources to the first optical waveguide.

In some implementations, optical signals emitted by the optical emitter are encoded by a non-return-to-zero (NRZ) coding scheme.

In some implementations, optical signals emitted by the optical emitter are encoded by a pulse-amplitude-modulation (PAM) coding scheme having more than two levels, and where a specific level of the PAM coding scheme is controlled by a number of the multiple first light sources that emit light.

Another aspect of the present disclosure features an optical link including the optical device according to any implementation of the present disclosure; and an optical receiver including one or more first photodetectors optically coupled with the first optical waveguide.

In some implementations, the one or more first photodetectors are arranged in a one-dimensional array or a two-dimensional array on a substrate.

In some implementations, the optical emitter is co-packaged with a first processor chip or a first memory, and where the optical receiver is co-packaged with a second processor chip or a second memory.

In some implementations, a number of the multiple first light sources optically coupled with the first optical waveguide is different from a number of the one or more first photodetectors optically coupled with the first optical waveguide.

Another aspect of the present disclosure features an optical device, including: an optical emitter having multiple first light sources optically coupled with a first optical waveguide; and a processor configured to control, based on a pulse-amplitude-modulation (PAM) coding scheme having more than two levels, which one or more of the multiple first light sources to emit optical signals, where a specific level of the PAM coding scheme is represented by a number of one or more first light sources of the multiple first light sources that emit the optical signals.

In some implementations, the multiple first light sources are arranged in a one-dimensional array or a two-dimensional array on a substrate.

In some implementations, the optical emitter further includes multiple second light sources optically coupled with a second optical waveguide. The multiple second light sources are arranged in a one-dimensional array or a two-dimensional array on the substrate. The processor is further configured to control, based on the PAM coding scheme, which one or more second light sources of the multiple second light sources to emit optical signals.

In some implementations, the multiple first light sources and the multiple second light sources include micro-light-emitting-diodes (micro-LEDs) or vertical-cavity surface-emitting lasers (VCSELs).

In some implementations, the first optical waveguide and the second optical waveguide include optical fibers in a fiber array having multiple optical fibers.

In some implementations, the multiple first light sources include one or more first redundant light sources. The processor is further configured to: determine that one of the multiple first light sources has malfunctioned; and in response to determining that one of the multiple first light sources has malfunctioned, control the multiple first light sources such that one of the one or more first redundant light sources transmits optical signals.

In some implementations, determining that one of the multiple first light sources has malfunctioned includes: determining that a power transmitted by a subset of the multiple first light sources is below a threshold value; and in response to determining that the power is below the threshold value, determining that one of the multiple first light sources has malfunctioned.

In some implementations, the optical device further includes one or more optical elements configured to guide optical signals transmitted by the multiple first light sources to the first optical waveguide.

In some implementations, the multiple first light sources further include microcavity structures or nanocavity structures configured to enhance a spontaneous emission rate of the multiple first light sources.

Another aspect of the present disclosure features an optical link including: the optical device according to any implementation of the present disclosure; and an optical receiver including one or more first photodetectors optically coupled with the first optical waveguide.

In some implementations, the one or more first photodetectors are arranged in a one-dimensional array or a two-dimensional array on a substrate.

In some implementations, the optical emitter is packaged with a first processor or a first memory, and where the optical receiver is packaged with a second processor or a second memory.

In some implementations, a number of the multiple first light sources optically coupled with the first optical waveguide is different from a number of the one or more first photodetectors optically coupled with the first optical waveguide.

Another aspect of the present disclosure features a method for forming an optical transceiver having an optical emitter chip, an optical receiver chip, and a circuitry chip. The method includes: hybrid-bonding a first hybrid-bond interface of the circuitry chip to a second hybrid-bond interface of the optical receiver chip; forming a third hybrid-bond interface on the optical receiver chip; hybrid-bonding a fourth hybrid-bond interface of the optical emitter chip to the third hybrid-bond interface of the optical receiver chip; and forming one or more openings in the optical emitter chip to provide an optical access to one or more photodetectors of the optical receiver chip.

In some implementations, the method further includes: forming one or more first optical elements over one or more emitters of the optical emitter chip, and forming one or more second optical elements in the one or more openings.

In some implementations, the method further includes: filling the one or more openings; and forming one or more first optical elements over one or more emitters of the optical emitter chip, and forming one or more second optical elements over the filled one or more openings.

In some implementations, the one or more first optical elements and the one or more second optical elements include micro lens or metalens.

In some implementations, the method further includes: bonding an optical element layer having the one or more first optical elements and the one or more second optical elements to a carrier wafer.

In some implementations, the method further includes thinning the circuitry chip.

In some implementations, the method further includes: after thinning the circuitry chip, forming a plurality of through-silicon-vias to provide electrical coupling to circuitry in the circuitry chip.

In some implementations, the method further includes: forming a plurality of backside bumps over the circuitry chip to provide electrical coupling to the circuitry in the circuitry chip.

In some implementations, the method further includes: after forming the plurality of backside bumps, removing the carrier wafer from the optical element layer.

In some implementations, the method further includes: bonding the plurality of backside bumps to a substrate.

In some implementations, hybrid-bonding the fourth hybrid-bond interface of the optical emitter chip to the third hybrid-bond interface of the optical receiver chip includes a wafer-to-wafer bond.

In some implementations, hybrid-bonding the fourth hybrid-bond interface of the optical emitter chip to the third hybrid-bond interface of the optical receiver chip includes a chip-to-wafer bond.

Another aspect of the present disclosure features a method for aligning an optical module having an optical fiber array and an optical device. The method includes: obtaining, by an image sensor, an image representing an optical alignment between the optical fiber array and the optical device; determining, by one or more processors, a misalignment between the optical fiber array and the optical device; determining, by the one or more processors, that the misalignment between the optical fiber array and the optical device fails to satisfy a threshold; and in response to determining that the misalignment between the optical fiber array and the optical device fails to satisfy the threshold, providing, by the one or more processors, one or more output electrical signals to control a movement of a stage holding the optical module or the optical device.

In some implementations, the method further includes: determining, by the one or more processors, that the misalignment between the optical fiber array and the optical device satisfies the threshold; and in response to determining that the misalignment between the optical fiber array and the optical device satisfies the threshold, providing, by the one or more processors, one or more output electrical signals to control a sealing between the optical module and the optical device.

In some implementations, determining the misalignment between the optical fiber array and the optical device includes: determining, by the one or more processor, one or more properties associated with the image.

In some implementations, determining the one or more properties associated with the image includes: determining, by the one or more processors, the one or more properties using an image analysis software or a machine-learned model.

In some implementations, the image includes a group of photodetectors and light, from an optical fiber of the optical fiber array, focused on the optical device. The one or more properties include a relative distance between one photodetector in the group of photodetectors and the light focused on the optical device.

In some implementations, the image includes an alignment mark and light, from an optical fiber of the optical fiber array, focused on the optical device, and the one or more properties include a relative distance between the alignment mark and the light focused on the optical device.

In some implementations, the optical device includes an optical transmitter, an optical receiver, or an optical transceiver.

In some implementations, the movement includes a linear movement or an angular movement.

In some implementations, the optical module further includes a first collimating lens, a second collimating lens, and a beam splitter arranged between the first collimating lens and the second collimating lens.

In some implementations, the optical device includes a plurality of photodetectors, and the method further includes: deactivating, by the optical device, one or more photodetectors of the plurality of photodetectors based on the misalignment between the optical fiber array and the optical device.

### BRIEF DESCRIPTION OF THE DRAWINGS

The foregoing aspects and many of the advantages of this application will become more readily appreciated as the same becomes better understood by reference to the following detailed description, when taken in conjunction with the accompanying drawings:

FIGS. 1A-1G illustrate example systems having an optical link.

FIGS. 2A-2D illustrate examples of an optical link.

FIGS. 3A-3H illustrate example photodetectors having a silicon absorption region.

FIGS. 4A-4G illustrate example photodetectors having a germanium absorption region.

FIGS. 5A-5B illustrate an example optical receiving chip having a two-dimensional array of photodetectors.

FIG. 6 illustrates an example photodetector.

FIG. 7 illustrates an example optical link.

FIGS. 8A and 8B illustrate examples of an optical transmitter.

FIGS. 9A and 9B illustrate examples of an optical transmitter.

FIGS. 10A-10K illustrate examples of a method for manufacturing an optical transceiver.

FIGS. 11A-11F illustrate examples of a method for manufacturing an optical transceiver.

FIGS. 12A-12B illustrate examples of a method for manufacturing an optical transceiver.

FIGS. 13A-13B illustrate examples of a method for manufacturing an optical transceiver.

FIGS. 14A-14F illustrate examples of a method for manufacturing metal bumps on an optical transceiver.

FIGS. 15A-15B illustrate examples of an equivalent circuit of an optical receiver.

FIGS. 16A-16B illustrate examples of an equivalent circuit of an optical receiver.

FIG. 17 illustrates an example photodetector.

FIG. 18 illustrates an example optical receiving chip having a two-dimensional array of photodetectors.

FIGS. 19A and 19B illustrate examples of a data transfer between two computing system via an optical link.

FIG. 20 illustrates an example of an alignment system for an optical link.

FIGS. 21A-21B illustrate example optical alignments between a fiber array and an optical transceiver as captured by an image sensor.

FIG. 22 illustrates an example flowchart of a process for an optical alignment.

FIG. 23 illustrates an example of an optical receiver.

Like reference numbers and designations in the various drawings indicate like elements.

### DETAILED DESCRIPTION

An optical photodetector may be used to detect optical signals and convert the optical signals to electrical signals that may be further processed by another circuitry. Optical photodetectors may be used in various applications, including consumer electronics products, proximity sensing, image sensors, data communications, direct or indirect time-of-flight (ToF) ranging or imaging, and many other suitable applications.

In some cases, certain applications require high-speed, or high-bandwidth, optical photodetectors (e.g., on the order of GHz). The overall bandwidth of a system may be further increased by integrating multiple optical photodetectors on a same chip to yield multiple channels, e.g., a 1 Tbps system can be achieved by sending 10 Gbps data over 100 channels in parallel. As an example, artificial intelligence (AI) models such as large language models (LLMs) may contain billions or trillions of parameters. As the number of parameters increases, the computational demands for both training and inference grow exponentially, requiring significant resources to manage the storage, movement, and processing of these parameters across distributed hardware systems. Data communications have become critical in upkeeping the overall efficiency and scalability of AI model computations. This dependence on communication makes bandwidth, bandwidth density, latency, and power consumption for data transmission critical factors in the overall efficiency and scalability of AI model computations. Bandwidth limitations together with the fixed real-estate of the chips constraint the overall bandwidth density, creating a bottleneck as the data transfer rate struggles to keep pace with the compute speed. Latency adds another dimension to the problem, as in distributed computing, parameters and gradients must be synchronized across devices or nodes. The growing energy demand for powering data transmission also becomes a significant constraint, as moving data can consume substantial power if the amount of data and the frequency of data transfers become significant. Lastly, as data rate continues to scale, electrical interconnects also become a bottleneck due to limited transmission distance. Transitioning the communications fabrics from the electrical domain to the optical domain using photonic integrated circuits is a promising direction, but it is critical that these optical-based solutions need to withstand the tests such as manufacturability, operability, scalability, and reliability.

Implementations of the present disclosure provide optical interconnects (or optical links, which may be used interchangeably throughout the present disclosure) with a high channel-count that transmit optical data in parallel. Such optical interconnects can be beneficial in a parallel-computing architecture due to their ability to improve limitations associated with traditional electrical interconnects such as bandwidth limitation, short transmission distances, high latency, and other technical issues at a low cost.

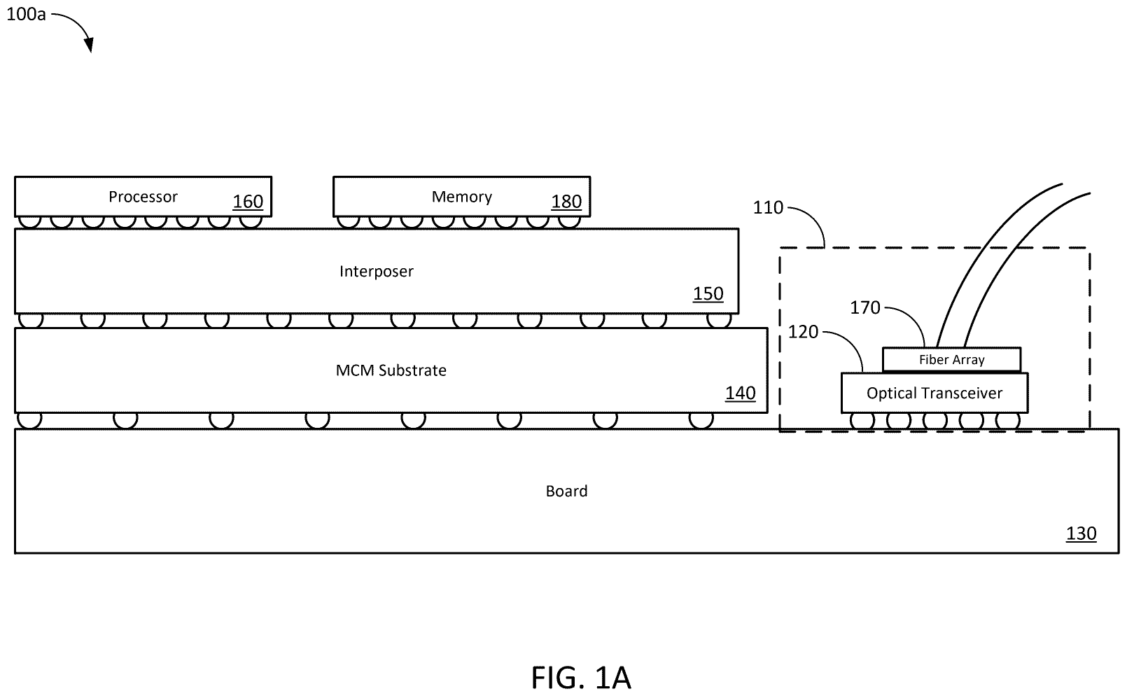

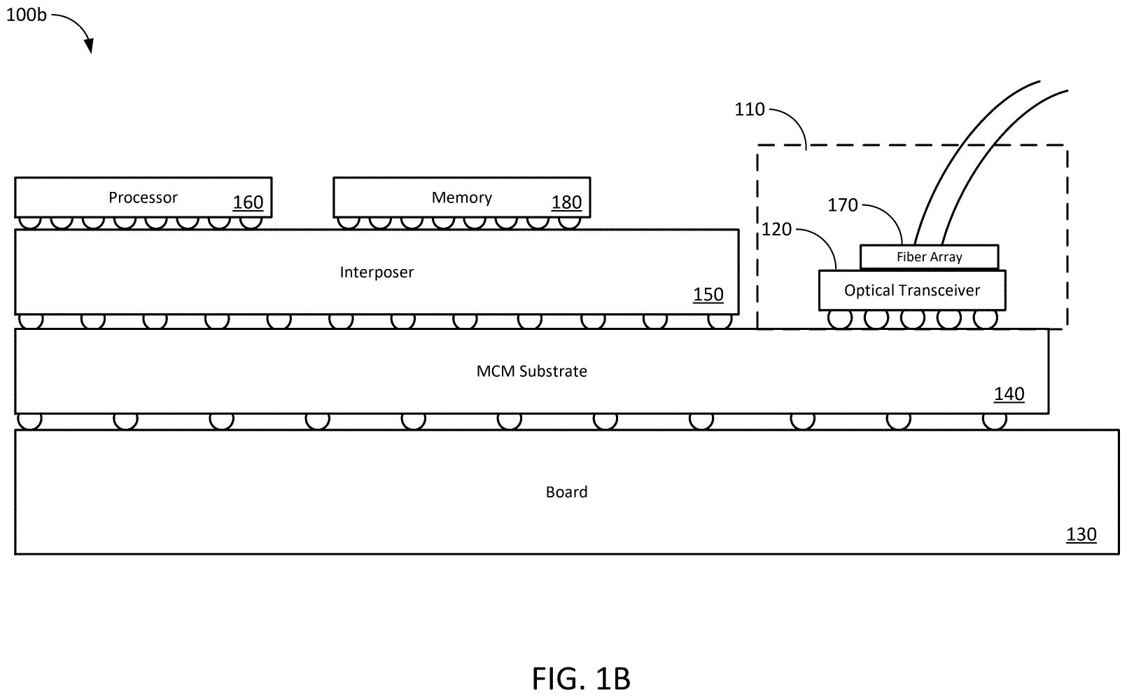

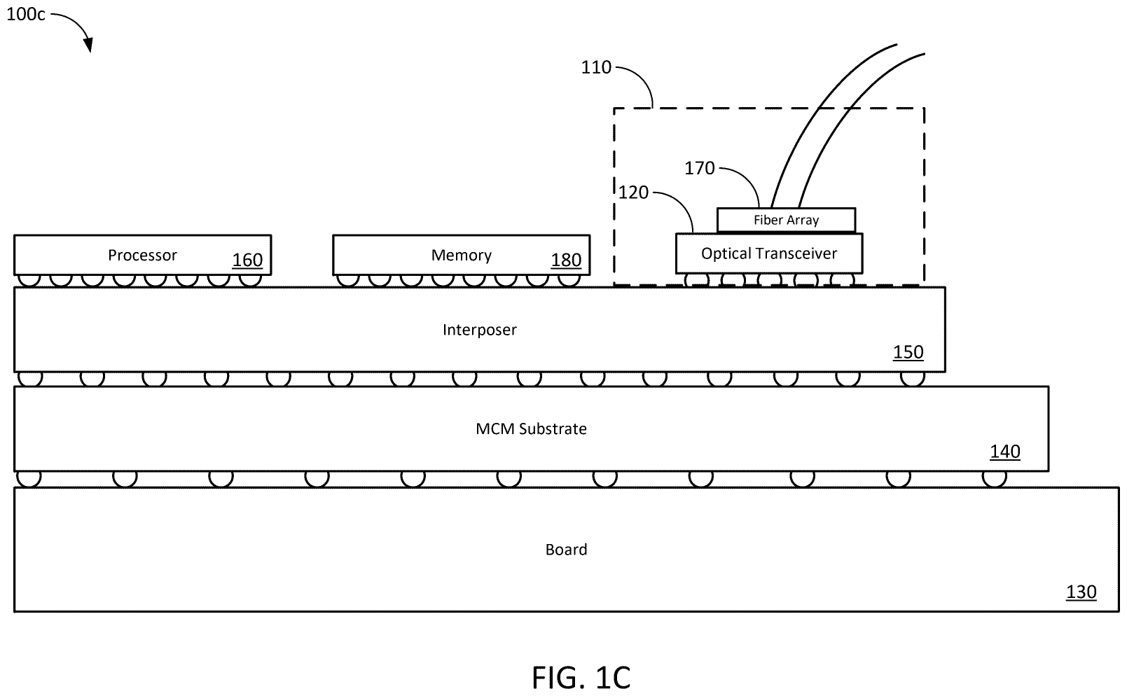

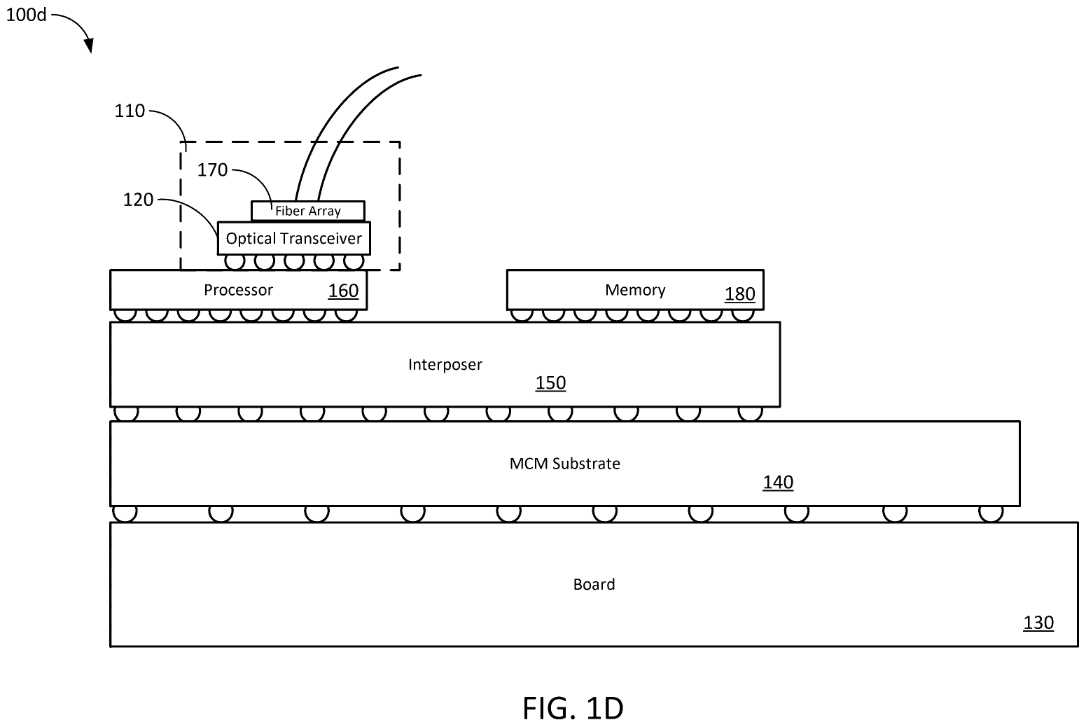

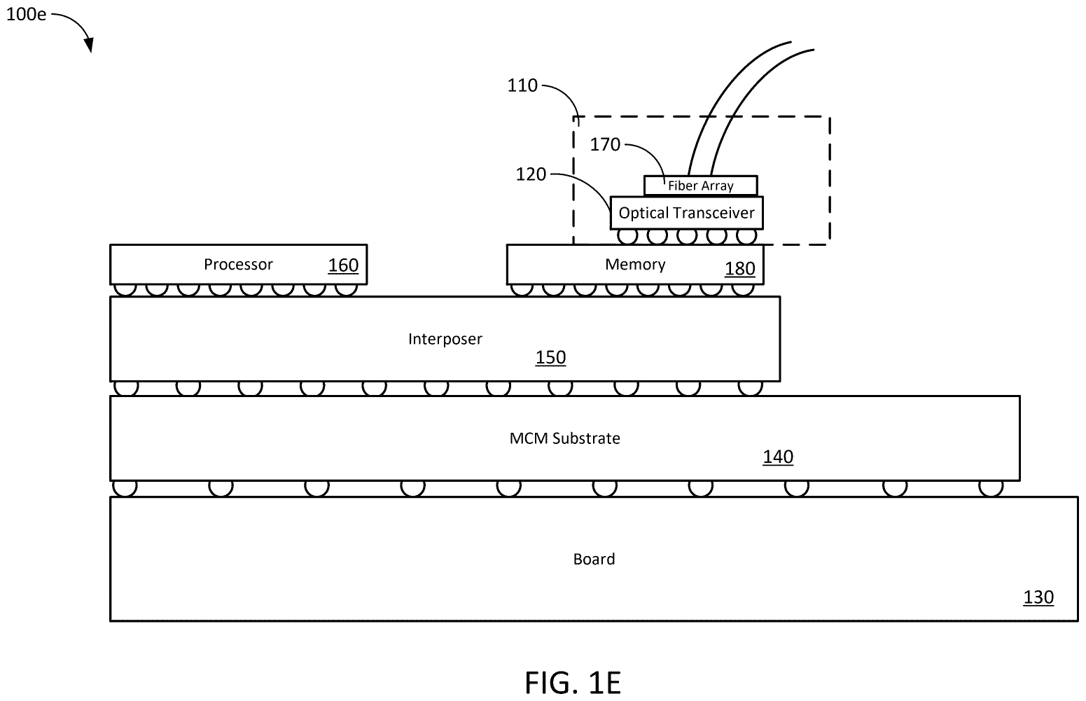

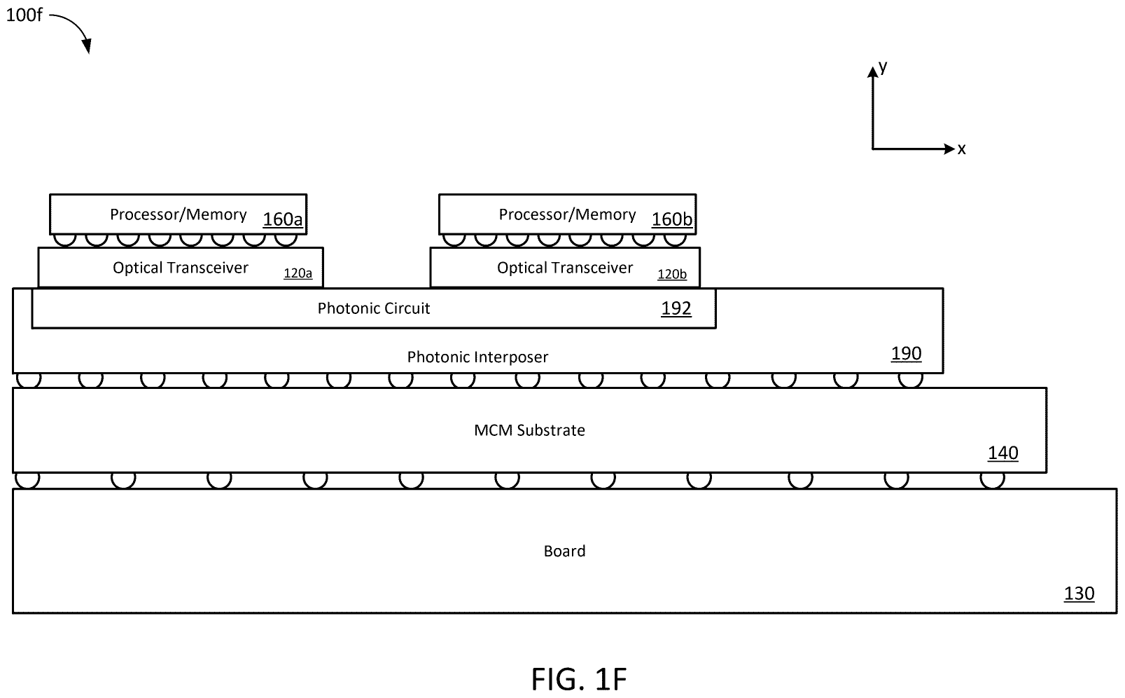

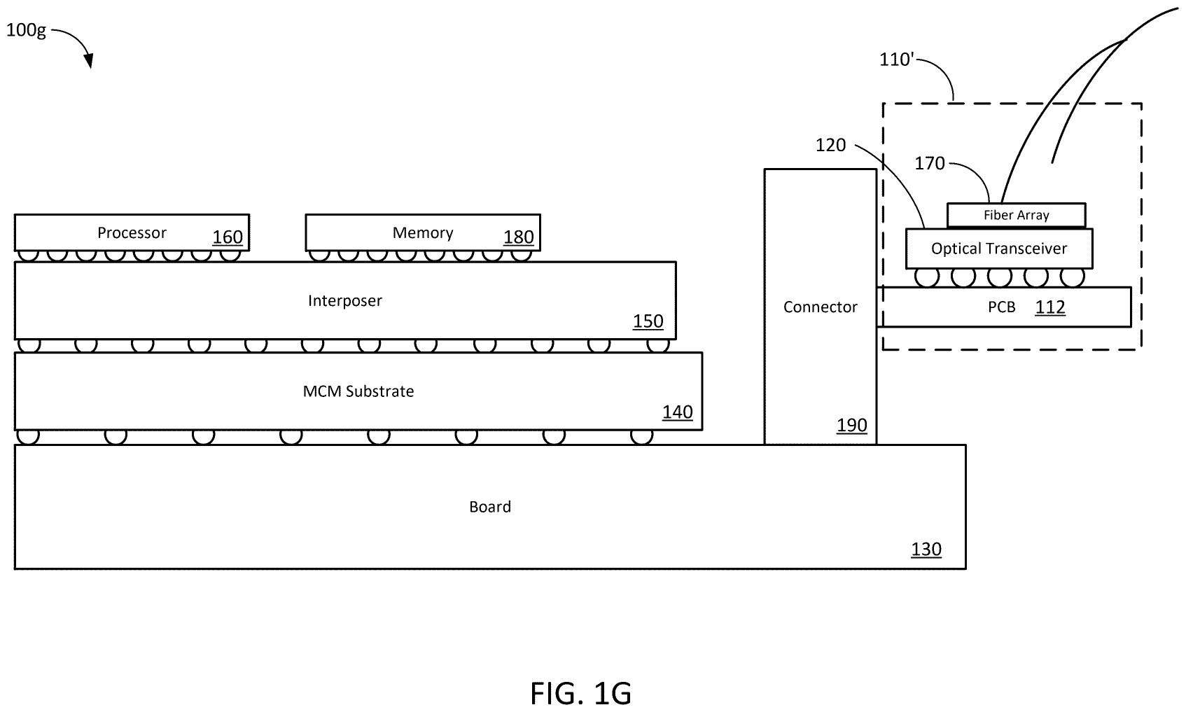

FIG. 1A shows an example of a computing system 100a. In some implementations, the computing system 100a includes an optical link 110, a board 130, a multi-chip module (MCM) substrate 140, an interposer 150, a processor 160, and a memory 180. The computing system 100a may be implemented in a high-performance computing or networking environment such as a data center infrastructure for parallel computing and/or artificial intelligence (AI) applications (e.g., computations for large language model trainings and/or inferences). In some implementations, the board 130 is a circuit board such as a server blade. The MCM substrate 140 can be packaged (e.g., bonded) on the board 130, and can be an electronic assembly that integrates multiple integrated circuits (ICs), and/or semiconductor dies, and/or discrete components onto a single substrate. The interposer 150 can be packaged (e.g., bonded) on the MCM substrate 140, and can be a specialized substrate (e.g., a silicon interposer) used in semiconductor packaging (e.g., 2.5D or 3D IC packaging) to facilitate the connection and integration of multiple chips or dies within a single package. The processor 160 can be packaged (e.g., bonded) on the interposer 150, and can include one or more of a graphics processing unit (GPU) chip, a central processing unit (CPU) chip, and/or a neural processing unit (NPU) chip. The memory 180 can be packaged (e.g., bonded) on the interposer 150, and can include a random-access memory chip such as a synchronous dynamic random-access memory (SDRAM) chip, a low-power double data rate (LPDDR) SDRAM, a high bandwidth memory (HBM) chip, etc. The processor 160 can be configured to access (read and/or write) data in the memory 180 via the interposer 150. The processor 160 can be also configured to access data in another memory not on the board 130 via the optical link 110. One or other processors that are not on the board 130 may access data in the memory 180 via the optical link 110. In some implementations, one or more processors are integrated on the interposer 150, and one or more memories are integrated on the interposer 150. Note that any suitable packaging technology can be implemented in the present disclosure, including, but not limited to, wire bonding such as ball bonding or wedge bonding, flip-chip bonding such as micro-bump bonding, solid-state bonding, direct copper bonding (DBC), and hybrid bonding.

In some implementations, the optical link 110 includes an optical transceiver 120 and a fiber array unit 170, and is configured to transmit and receive data between the processor 160, the memory 180, and other processors/memory elements. The optical link 110 may be used for chip-to-chip, module-to-module, package-to-package, board-to-board, or any other suitable type of data communications. The fiber array unit 170 can be configured to receive or transmit optical signals to an external chip, module, package, board, device or system. The optical transceiver 120 can be configured to: i) convert received optical signals into electrical signals and transmit the electrical signals to components in an integrated system such as the system 100a; and ii) covert received electrical signals from the components in the integrated system into optical signals and transmit the optical signals to the fiber array unit 170.

Referring to FIG. 1A, in some implementations, the optical link 110 may be packaged (e.g., bonded) on the board 130. Referring to FIG. 1B, in some other implementations, the optical link 110 may be packaged (e.g., bonded) on the MCM substrate 140 of a computing system 100b. Referring to FIG. 1C, in some other implementations, the optical link 110 may be packaged (e.g., bonded) on the interposer 150 of a computing system 100c. Referring to FIG. 1D, in some other implementations, the optical link 110 may be packaged (e.g., bonded) on the processor 160 of a computing system 100d. Referring to FIG. 1E, in some other implementations, the optical link 110 may be packaged (e.g., bonded) on the memory 180 of a computing system 100c.

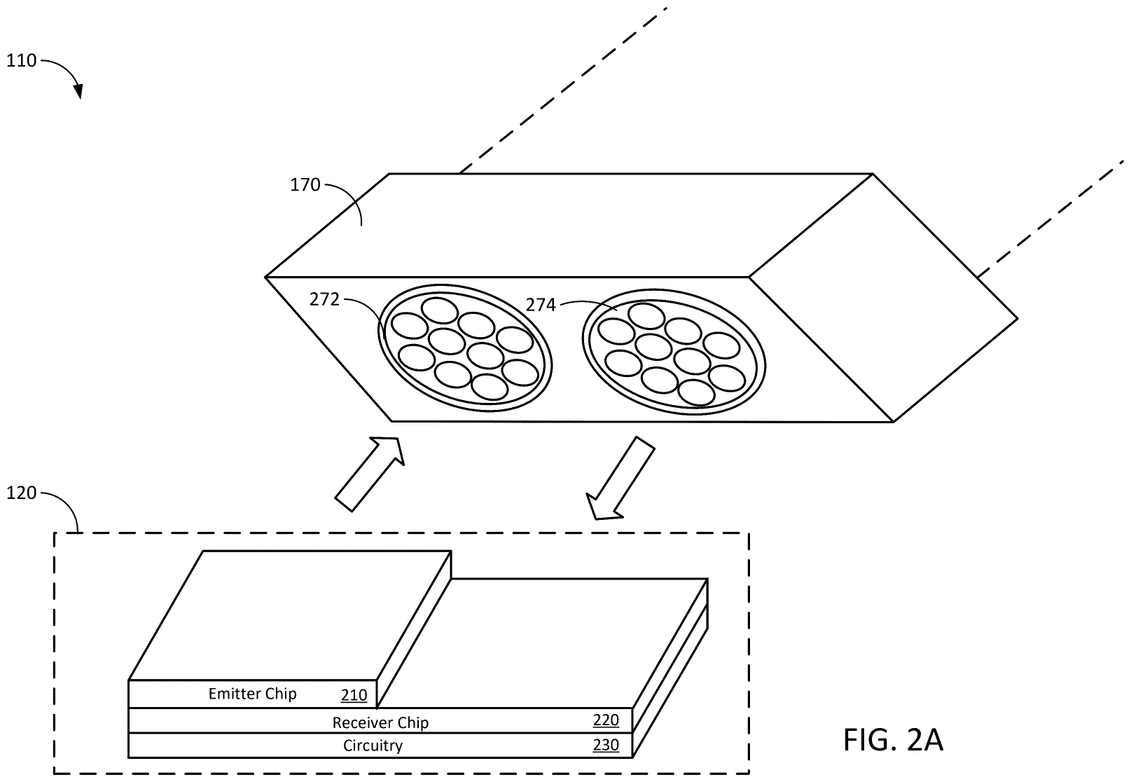

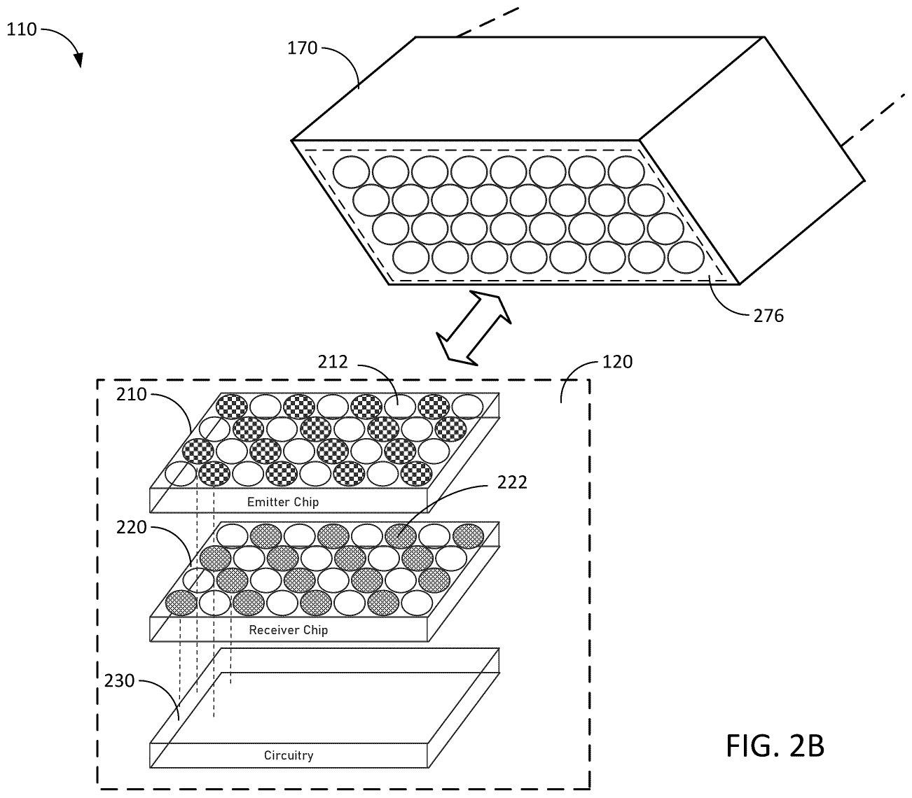

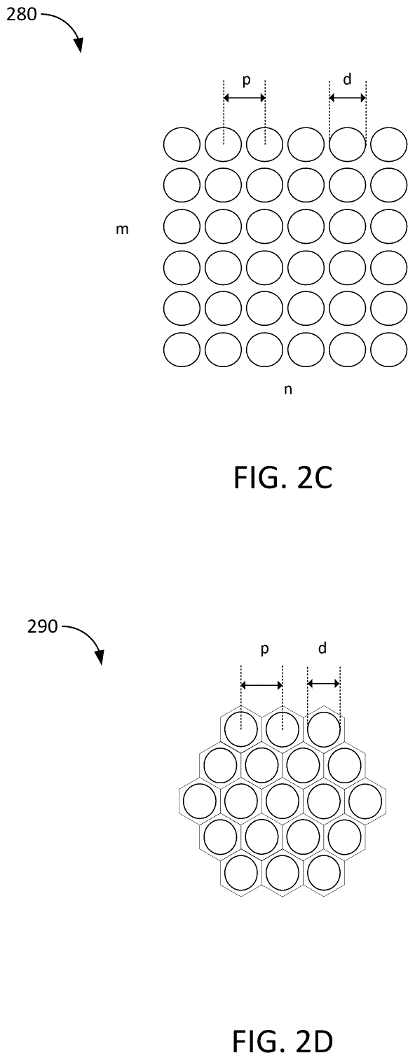

FIG. 1F shows an example of a computing system 100f for communicating optical signals on a photonic interposer 190. The photonic interposer 190 can be configured to communicate optical signals between processor and memory, and/or between processor and processor, and/or between memory and memory. In some implementations, the photonic interposer 190 may have a silicon substrate. In some other implementations, the photonic interposer 190 may have an oxide cladding. The photonic interposer 190 includes one or more photonic circuits 192, which may include one or more of active optical elements (e.g., optical modulators, optical switches, etc.), passive optical elements (e.g., optical waveguides, optical wavelength multiplexers/demultiplexers, optical couplers, etc.), or circuitry for controlling the active optical elements. In some implementations, e.g., as illustrated in FIG. 1F, the computing system 100f includes a first processor 160a (e.g., a GPU) and a second processor 160b (e.g., another GPU). The first and the second processor/memory 160a and 160b may communicate with each other in the optical domain through the optical transceivers 120a/120b (example optical transceiver 120 described in FIGS. 2A and 2B) and the one or more photonic circuits 192. As an example, if the first processor 160a is programmed to communicate data to the second processor 160b, the first processor 160a transmits electrical signals containing the data, where the optical transceiver 120a converts the electrical signals into optical signals by driving a light source, e.g., a micro-light-emitting-diode (micro-LED) array or a vertical-cavity surface-emitting laser (VCSEL) array. The photonic interposer 190 can include an optical coupler (e.g., an optical grating or a reflector such as a 45-degree mirror) configured to couple the optical signals into the one or more photonic circuits 192 (e.g., from along y-direction to along x-direction). The one or more photonic circuits 192 may include a passive optical waveguide (e.g., a polymer based waveguide) that guides the optical signals to another optical coupler (e.g., as another optical grating or another reflector such as a 45-degree mirror) which is configured to couple the optical signals to the optical transceiver 120b (e.g., from along x-direction to along y-direction). The optical transceiver 120b can include a normal-incidence photodetector array that converts the optical signals into electrical signals for the processor 160b to further process the data. In some implementations, the optical transceivers 120a/120b may be discrete optical transceivers that are packaged with the photonic interposer 190. In some other implementations, the optical transceivers 120a/120b may be integrated as parts of the photonic interposer 190 through monolithic or heterogenous process integration, which may provide a planar surface for the case of packaging processor and/or memory 160a, 160b, and other components not shown in FIG. 1F.

FIG. 1G shows an example of a computing system 100g for communicating optical signals via a pluggable optical interconnect. Here, the optical link 110′ can be implemented as a standalone optical module, where the optical transceiver 120 can be packaged with a circuit board such as a printed circuit board (PCB) 112. The optical link 110′ can be coupled to the board 130 via a connector 190 (e.g., a QSFP (Quad Small Form-factor Pluggable) connector).

FIG. 2A illustrates an example optical link 110 having an optical transceiver 120 and a fiber array unit 170. The optical link 110 of FIG. 2A can be implemented as the optical link 110 in the system 100a of FIG. 1A, the system 100b of FIG. 1B, the system 100c of FIG. 1C, the system 110d of FIG. 1D, or the system 110e of FIG. 1E, or the optical link 100′ in the system 100g of FIG. 1G.

In some implementations, the optical transceiver 120 includes an optical-emitter chip 210 having multiple light sources configured to emit first optical signals in parallel to the fiber array unit 170. The optical transceiver 120 further includes an optical-receiver chip 220 having multiple photodetectors configured to detect second optical signals in parallel from the fiber array unit 170. The optical transceiver 120 further includes a circuitry chip 230 having circuitry configured to control the optical-emitter chip 210 and the optical-receiver chip 220. In some implementations, e.g., as shown in FIG. 2A, the optical-receiver chip 220 is stacked between the optical-emitter chip 210 and the circuitry chip 230 to reduce overall package space, and/or to reduce power consumptions, and/or to improve signal quality. Such a stacking may be fabricated through die-to-die bonding, die-to-wafer bonding, and/or wafer-to-wafer bonding.

In some implementations, an isolation structure may be formed in the wafer or in the module to reduce an optical cross-talk between the optical-emitter chip 210 and the optical-receiver chip 220. As one example, when the optical-emitter chip 210 is die-to-wafer bonded to the optical-receiver chip 220, a partial recess may be formed in the optical-receiver chip 220, such that the optical-emitter chip 210 may be partially or completely embedded in the optical-receiver chip 220 for better surface planarization and/or packaging. As another example, e.g., as illustrated in FIG. 2A, the optical-emitter chip can be integrated on one part of the optical-receiver chip 220, with a remaining part of the optical-receiver chip 220 exposed to receive optical signals from the fiber-array unit 170. As another example, when the optical-emitter chip 210 is wafer-to-wafer bonded to the optical-receiver chip 220, a complete recess may be formed in the optical-emitter chip 210, such that an incoming light from the fiber array unit 170 may directly reach the optical-receiver chip 220 without the penetration through the optical-emitter chip 210, reducing the losses due to absorption and/or scattering during the penetration through the optical-emitter chip 210.

In some implementations, the fiber-array unit 170 includes a first fiber array 272 and a second fiber array 274, where the first fiber array 272 is optically coupled to the multiple light sources of the optical-emitter chip 210, and the second fiber array 274 is optically coupled to the multiple photodetectors of the optical-receiver chip 220 to achieve a high channel-count (e.g., 1000+ channels) that transmit optical data in parallel. In some implementations, each of the first fiber array 272 and the second fiber array 274 include multiple multi-mode fibers (e.g., polymer optical fibers or glass optical fibers). In some other implementations, each of the first fiber array 272 and the second fiber array 274 include multiple single-mode fibers (e.g., polymer optical fibers or glass optical fibers). In some implementations, e.g., as shown in FIG. 2A, the first fiber array 272 and the second fiber array 274 are separated in the fiber-array unit, for example, can be enclosed in separated housings or bundles, e.g., to avoid optical crosstalk.

In some implementations, each of the multiple light sources may include a micro-light-emitting-diode (micro-LED) or a vertical-cavity surface-emitting laser (VCSEL). The light sources may be arranged as a one-dimensional or a two-dimensional array. A wavelength of the optical signals emitted by the multiple light sources may be in a visible wavelength range (e.g., wavelength range 380 nm to 780 nm, or a similar wavelength range as defined by a particular application), in a near-infrared wavelength range (NIR, e.g., wavelength range from 780 nm to 1000 nm, or a similar wavelength range as defined by a particular application), or in a short-wave-infrared wavelength range (SWIR, e.g., wavelength range from 1000 nm to 3000 nm, or a similar wavelength range as defined by a particular application). In some implementations, one or more microlens (e.g., silicon microlens, oxide microlens, nitride microlens, polymer microlens, etc.) or micro-metalens (e.g., silicon micro-metalens, oxide micro-metalens, nitride micro-metalens, polymer micro-metalens, etc.) may be formed over one or more light sources such as the micro-LEDs or the VCSELs to shape the optical beams from the one or more light sources.

In some implementations, subsets of the multiple emitters may be configured to emit optical signals having different wavelengths to implement a wavelength division multiplexing (WDM) scheme. For example, if three adjacent emitters in a micro-LED array or a VCSEL array are configured to emit three wavelengths, and if the three emitted optical beams have a combined beam size and a numerical aperture (e.g., after passing through the microlens or the micro-metalens) that can be received by a multimode fiber, the multimode fiber can carry three wavelength channels in parallel to further increase the overall bandwidth.

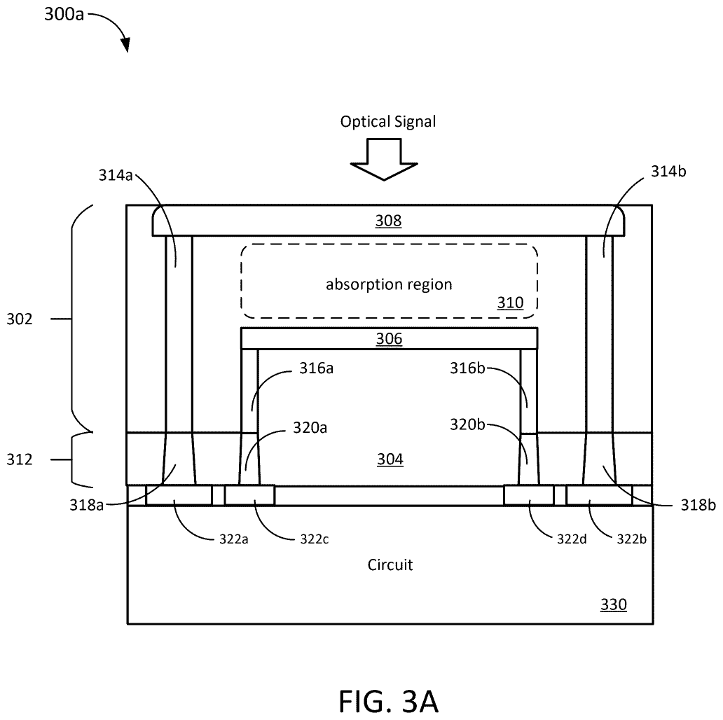

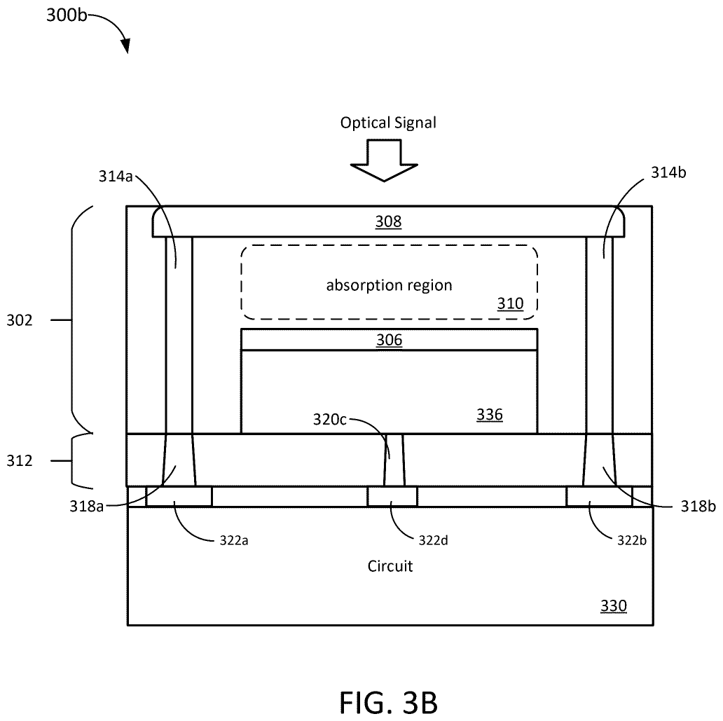

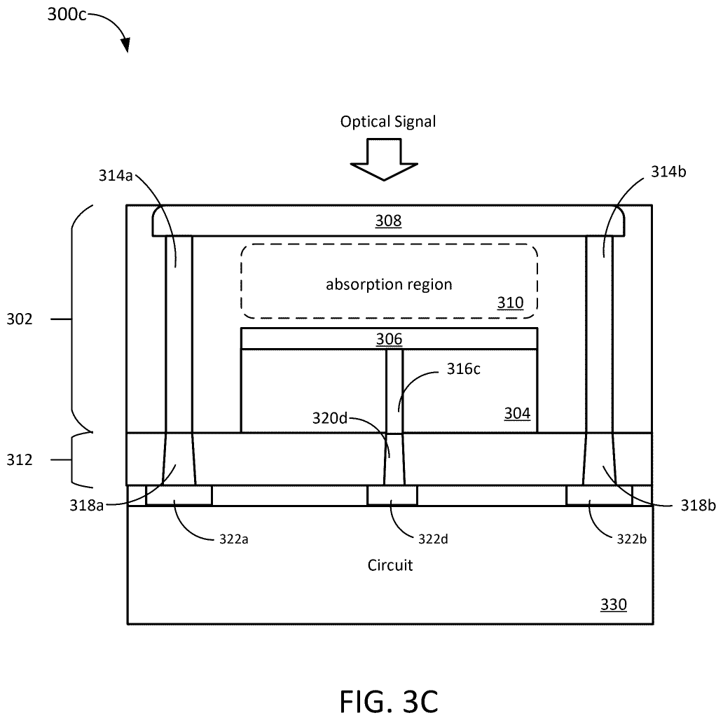

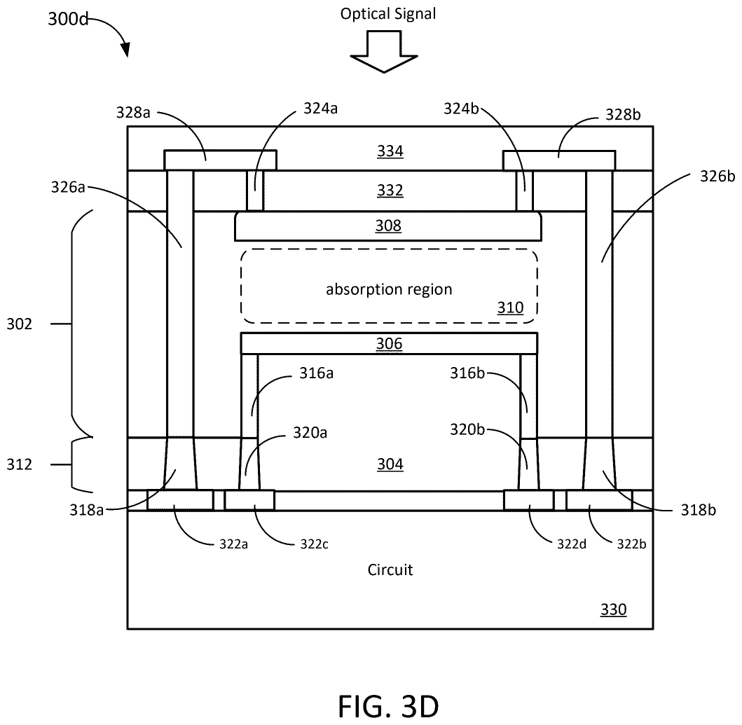

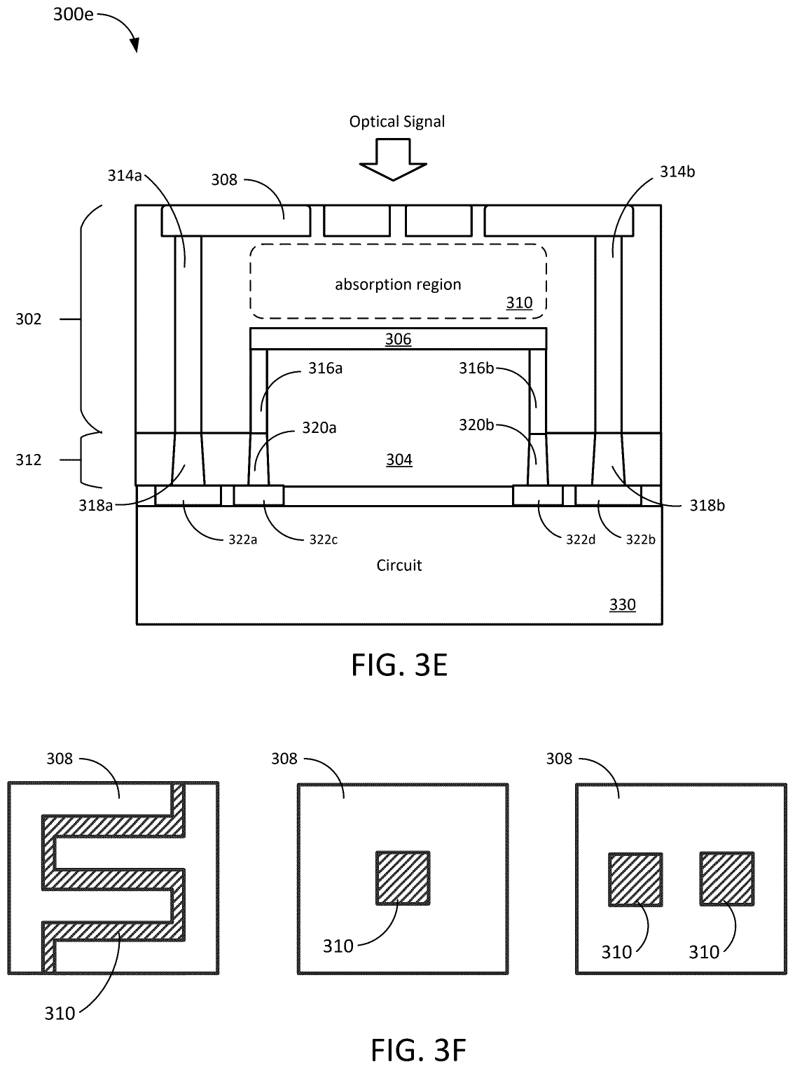

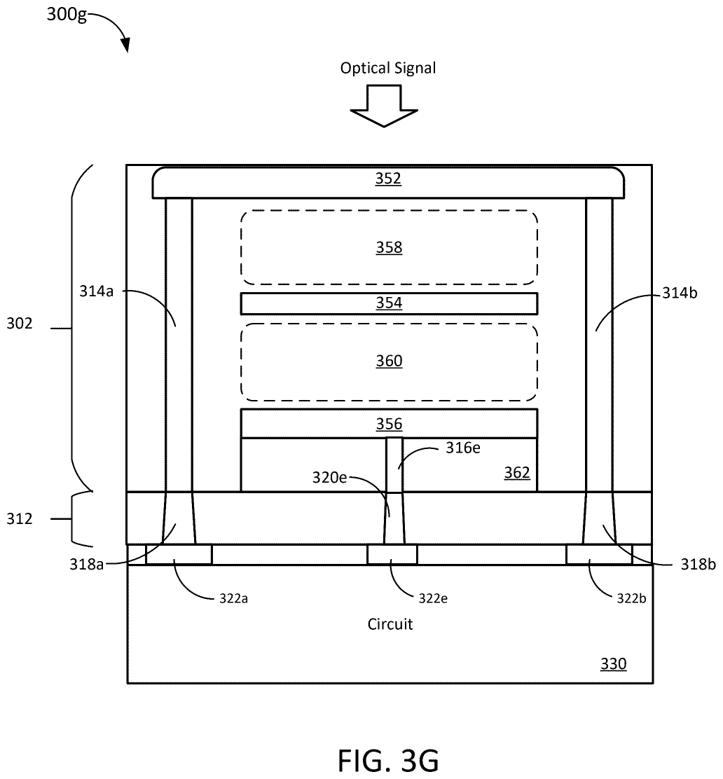

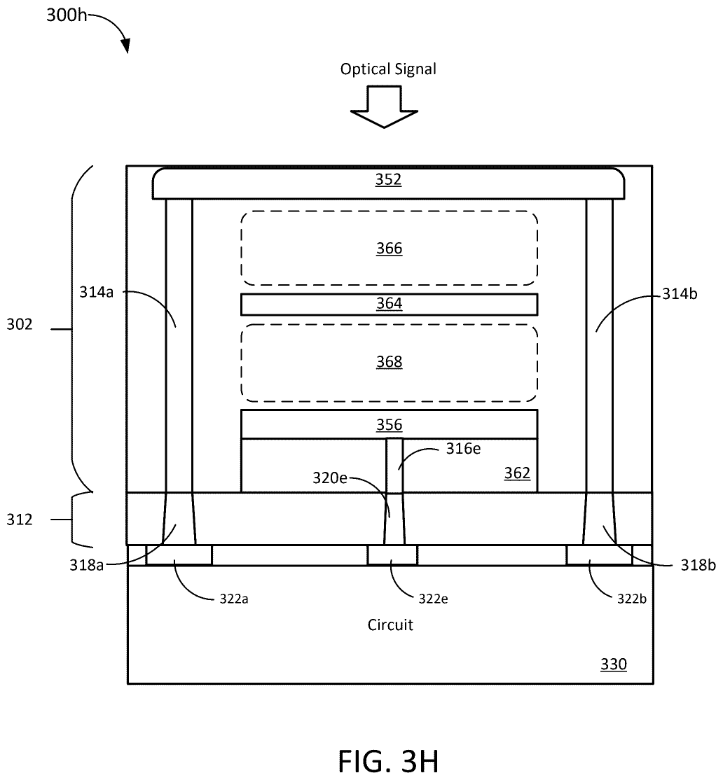

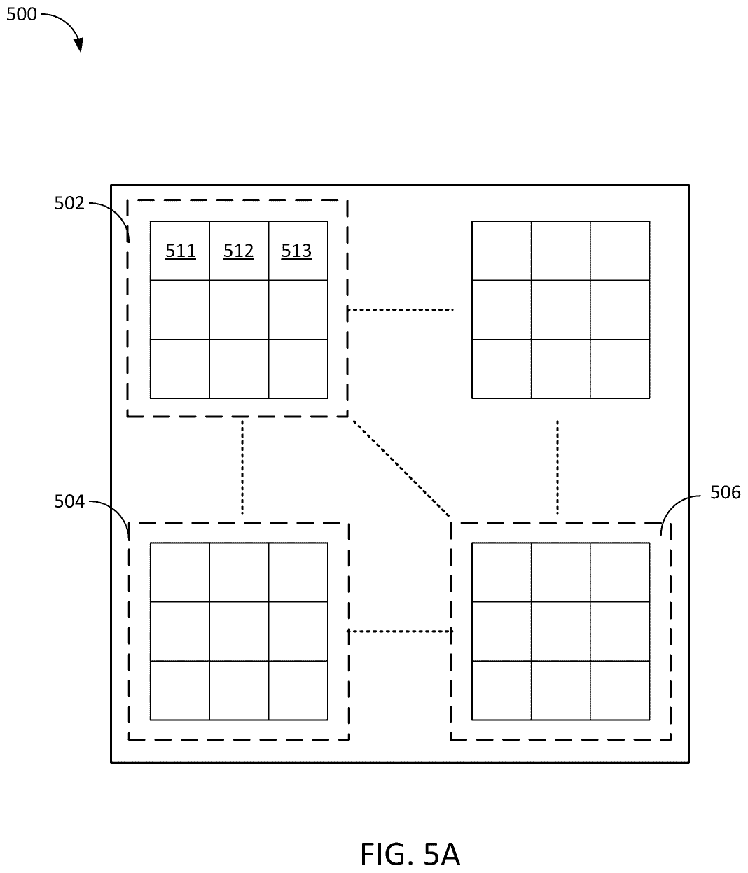

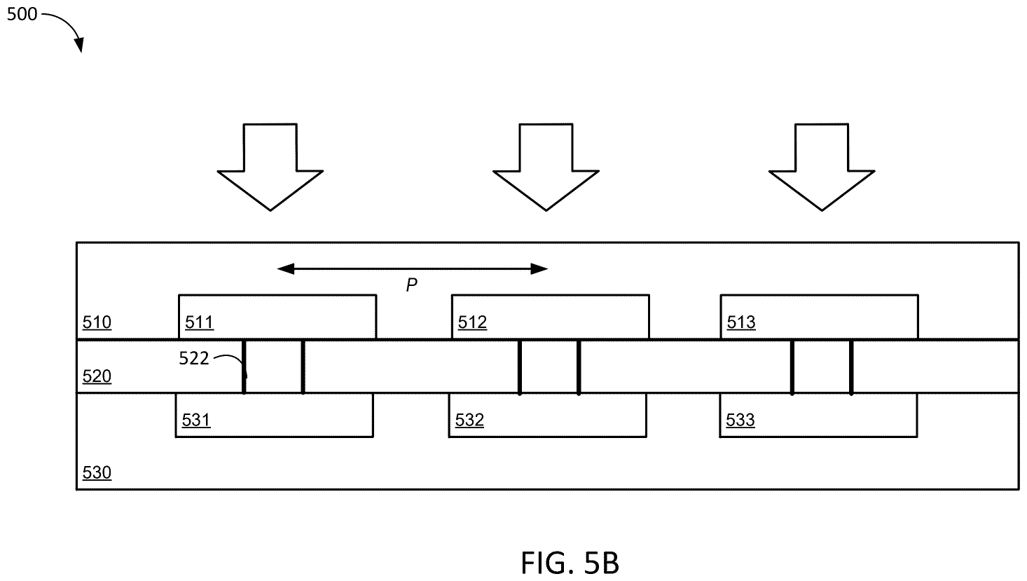

In some implementations, the multiple photodetectors can be photodiodes (PD) or avalanche photodiodes (APD) (e.g., the photodetectors described in reference to FIGS. 3A-3F, 4A-4C, and 6). The photodetectors may be arranged as a one-dimensional or a two-dimensional array (e.g., the photodetector array in reference to FIG. 5A). In some implementations, one or more microlens (e.g., silicon microlens, oxide microlens, nitride microlens, polymer microlens, etc.) or micro-metalens (e.g., silicon micro-metalens, oxide micro-metalens, nitride micro-metalens, polymer micro-metalens, etc.) may be formed over the multiple photodetectors to shape the optical beams from the fiber array.

In some implementations, a subset of multiple emitters may be grouped together to form a source of a channel to increase the overall transmitting power for a channel. In some implementations, a subset of multiple photodetectors may be grouped together to form a receiver of a channel to increase the overall sensitivity for a channel. In some implementations, a subset of multiple fibers may be grouped together to form a waveguide of a channel to increase the overall optical coupling efficiency or the overall alignment tolerance for a channel.

FIG. 2B illustrates another example optical link 110, where the optical-receiver chip 220 is stacked between the optical-emitter chip 210 and the circuitry chip 230. The optical link 110 of FIG. 2B can be implemented as the optical link 110 in the system 100a of FIG. 1A, the system 100b of FIG. 1B, the system 100c of FIG. 1C, the system 110d of FIG. 1D, or the system 110e of FIG. 1E, or the optical link 100′ in the system 100g of FIG. 1G. Here, the optical-emitter chip 210 includes openings 212 (e.g., formed through etching process) having a predetermined arrangement (e.g., interdigitated rows, checkered pattern, or any other suitable patterns). The openings 212 of the optical-emitter chip 210 expose corresponding photodetectors 222 of the optical-receiver chip 220, which enable a single fiber array 276 to receive and transmit optical signals in parallel with different fibers in the fiber array 276.

FIG. 2C illustrates an example fiber array 280 (e.g., any of the fiber array 272, 274, or 276 as described above) having m-by-n fibers, where m and n are integers. Each fiber has a diameter d and two fibers are separated by a pitch p. In some implementations, the fiber array 280 is arranged as a rectangular grid (e.g., m and n are different). In some implementations, the fiber array 280 is arranged as a square grid (e.g., m and n are the same). In some implementations, the fibers in the fiber array 280 may be single-mode fibers. In some other implementations, the fibers in the fiber array 280 may be multimode fibers. In some other implementations, the fibers in the fiber array 280 may be a combination of single-mode fibers and multimode fibers.

FIG. 2D illustrates an example fiber array 290 (e.g., any of the fiber array 272, 274, or 276 as described above) having k fibers, where k is an integer. The fiber array 290 is arranged in a hexagonal pattern, where each fiber has a diameter d and two fibers are separated by a pitch p. In some implementations, the fibers in the fiber array 290 may be single-mode fibers. In some other implementations, the fibers in the fiber array 290 may be multimode fibers. In some other implementations, the fibers in the fiber array 290 may be a combination of single-mode fibers and multimode fibers.

FIG. 3A (shown as the back-side-incident cross-section view) shows an example photodetector 300a having a silicon absorption region, which can be used to detect an optical signal in the visible or the NIR wavelength range. The photodetector 300a may be operated as a PD or an APD under different voltage biases. The photodetector 300a includes a silicon layer 302. The silicon layer 302 includes an n-doped region 306 at least partially surrounding surfaces of a trench 304. In some implementations, the doping concentration of the n-doped region 306 is highly-doped (e.g., in the range of >10¹⁹ cm⁻³). The silicon layer 302 can further include a p-doped region 308 near or at least partially overlapping with the surface of the silicon layer 302. In some implementations, the doping concentration of the p-doped region 308 is highly-doped (e.g., in the range of >10¹⁹ cm⁻³). In some implementations, a thickness of the p-doped region 308 is less than the absorption length associated with a wavelength of the detected optical signals. As an example, for blue light, the absorption length is about a few hundreds of nanometers in Si and the thickness of the p-doped region 308 can be about a few tens of nanometers.

In some implementations, the silicon layer 302 further includes an absorption region 310 formed between the n-doped region 306 and the p-doped region 308. In some implementations, the doping concentration of the absorption region 310 is intrinsic (e.g., undoped or with a background doping) or lightly-doped (e.g., in the range of <10¹⁷ cm⁻³). In the present disclosure, a p-doped region includes one or more p-type dopants such as boron, and an n-doped region includes one or more n-type dopants such as phosphorus.

In some implementations, the silicon layer 302 further includes a trench 304 filled with a dielectric material (e.g., oxide). By forming the trench 304 (e.g., through etching), the thickness of the absorption region 310 can be reduced to a thickness that is thick enough to efficiently convert the optical signal into an electrical signal (e.g., the thickness is greater than the absorption length associated with the wavelength of the detected optical signals), while thin enough to sufficiently sustain the optical or electrical bandwidth for operating the photodetector 300a. As an example, a thickness of the absorption region can be smaller than 500 nm.

In some implementations, the photodetector 300a further includes a cladding layer 312 formed using a dielectric material (e.g., oxide) and conductive regions 318a, 318b, 320a, 320b (e.g., metal). Conductive regions 318a, 318b, 320a, 320b in the cladding layer are connected to conductive regions 314a, 314b, 316a, 316b (e.g., metal or doped semiconductor) in the silicon layer 302 for providing the photocarriers generated by the absorption region 310 to an external circuitry. The photodetector 300a may be bonded to a circuit chip 330 (e.g., circuit chip 230) using hybrid-bonding, where electrical connections may be formed through conductive regions 322a, 322b, 322c, and 322d (e.g., metal).

In some implementations, one or more additional dielectric or polymer or semiconductor layers (not shown) may be formed over the silicon layer 302 to function as an anti-reflection coating or a wavelength filter for the optical signal.

FIG. 3B (shown as the back-side-incident cross-section view) shows another example photodetector 300b having a silicon absorption region. The photodetector 300b is similar to the photodetector 300a of FIG. 3A, with the difference that the trench is filled with a semiconductor layer 336. The semiconductor layer 336 can be silicon, germanium, or silicon-germanium compound. In some implementations, the semiconductor layer 336 can be highly-doped (e.g., in the range of >10¹⁹ cm⁻³). The photodetector 300b can further include conductive regions 318a, 318b, 320c (e.g., metal) in the cladding layer 312 that are connected to conductive regions 314a, 314b, and the semiconductor layer 336 for providing the photocarriers generated by the absorption region 310 to an external circuitry. In some implementations, one or more additional dielectric or polymer or semiconductor layers (not shown) may be formed over the silicon layer 302 to function as an anti-reflection coating or a wavelength filter for the optical signal.

FIG. 3C (shown as the back-side-incident cross-section view) shows another example photodetector 300c having a silicon absorption region 310. The photodetector 300c is similar to the photodetector 300a of FIG. 3A, with the difference that the conductive regions 316a and 316b are replaced with a conductive region 316c (e.g., a via) formed by etching through the dielectric material in the trench 304 and filled with a conductive material (e.g., metal or doped semiconductor), and the conductive regions 320a and 320b are replaced with a conductive region 320d (e.g., metal) that connects to the conductive region 316c (e.g., metal or doped semiconductor). The conductive region 316c can be formed in any suitable position in the trench 304, e.g., a middle of the trench 304 as shown in FIG. 2C. In some implementations, one or more additional dielectric or polymer or semiconductor layers (not shown) may be formed over the silicon layer 302 to function as an anti-reflection coating or a wavelength filter for the optical signal.

FIG. 3D (shown as the back-side-incident cross-section view) shows another example photodetector 300d having a silicon absorption region. The photodetector 300d is similar to the photodetector 300a/300b/300c, with the difference that the electrical coupling between the p-doped region 308 and the circuit 330 are routed through one or more backside conductive regions (e.g., vias) 324a and 324b, one or more backside conductive regions 328a and 328b, and one or more through-silicon vias 326a and 326b. The photodetector 300d can include a first dielectric layer 332 formed on the silicon layer 302, and a second dielectric layer 334 formed on the first dielectric layer 332. In some implementations, a combination of the first dielectric layer 332, the second dielectric layer 334, and/or one or more additional layers (not shown) can function as an anti-reflection coating or a wavelength filter for the optical signal. In some implementations, the backside conductive regions 328a and 328b can function as an optical aperture, where the backside conductive regions 328a and 328b can block a portion of the optical signal from entering into the photodetector 300d. In some implementation, the backside conductive regions 324a and 324b, 328a and 328b, and the through-silicon vias 326a and 326b, can prevent inter-pixel optical crosstalk, as well as improving design flexibility on where the conductive regions 322a and 322b can be placed.

FIG. 3E (shown as the back-side-incident cross-section view) shows another example photodetector 300c having a silicon absorption region. The photodetector 300c is similar to the photodetector 300a/300b/300c/300d, with the difference that the p-doped region 308 is patterned to expose the absorption region 310. FIG. 3F shows three example top views of the photodetector 300e, where the patterns can be designed based on the electric field distribution in the absorption region 310. In some cases, the highly doped p-doped region 308 can absorb a portion of the optical signal and therefore degrade the overall photodetector quantum efficiency and/or operation bandwidth. The patterns shown in FIG. 3F can be configured to allow more optical signal to enter the absorption region 310 and therefore may improve the overall photodetector quantum efficiency and/or operation bandwidth. In some implementations, one or more additional dielectric or polymer or semiconductor layers (not shown) may be formed over the silicon layer 302 to function as an anti-reflection coating or a wavelength filter for the optical signal.

FIG. 3G (shown as the back-side-incident cross-section view) shows an example photodetector 300g having a silicon absorption region, which can be used to detect and amplify an optical signal in the visible or the NIR wavelength range. The photodetector 300g may be operated as a PD or an APD under different voltage biases. The photodetector 300g includes a silicon layer 302. The silicon layer 302 can include a first p-doped region 352. In some implementations, the doping concentration of the first p-doped region 352 is highly-doped (e.g., in the range of >10¹⁹ cm⁻³). The silicon layer 302 can further include a second p-doped region 354. In some implementations, the doping concentration of the second p-doped region 354 is moderately-doped (e.g., in the range <10¹⁸ cm⁻³). The silicon layer 302 can further include a first n-doped region 356. In some implementations, the doping concentration of the first n-doped region 356 is highly-doped (e.g., in the range of >10¹⁹ cm⁻³).

In some implementations, the silicon layer 302 further includes a low-field region 358 (e.g., an absorption region) formed between the first p-doped region 352 and the second p-doped region 354. The silicon layer 302 can further include a high-field region 360 (e.g., an amplification region) formed between the second p-doped region 354 and the first n-doped region 356. In some implementations, the doping concentration of the low-field region 358 and/or the high-field region 360 is intrinsic (e.g., undoped or with a background doping) or lightly-doped (e.g., in the range of <10¹⁷ cm⁻³).

In some implementations, when the photodetector 300g is biased close to a breakdown voltage, the photodetector 300g is operated as an APD, where a lower electric field (e.g., a field that does not cause avalanche breakdown) is formed in the low-field region 358 and a higher electric field (e.g., a field that causes avalanche breakdown) is formed in the high-field region 360. During operation, light that enters the photodetector 300g can be at least partially or entirely absorbed in the low-field region 358, where the holes generated by the light absorbed in the low-field region 358 can be drifted to and collected by the first p-doped region 352. The electrons generated by the light absorbed in the low-field region 358 can be drifted to and amplified by the high-field region 360. Moreover, any light that has not been absorbed by the low-field region 358 may be absorbed by the high-field region 360, and the generated photocarriers may be amplified by the high-field region 360. The amplified electrons can be drifted and collected by the first n-doped region 356. The amplified holes can be drifted and collected by the first p-doped region 352. Advantageously, the high-field region 360 can be defined by the separation between the second p-doped region 354 and the first n-doped region 356. The high-field region 360 can be designed to be thin to reduce the breakdown voltage, where power for operating the photodetector 300g can be reduced accordingly.

In some implementations, the silicon layer 302 may include a trench 362 filled with a dielectric material (e.g., oxide) or other suitable materials (e.g., germanium). By forming the trench 362 (e.g., through etching), the thickness of the silicon 302 can be increased to improve its reliability. In some implementation, a thickness of the first p-doped region 352, the second p-doped region 354, the first n-doped region 356, the low-field region 358, and the high-field region 360 together can be smaller than 500 nm, 1 μm, 1.5 μm, 2 μm, or any other appropriate thinness for an operation wavelength.

In some implementations, the photodetector 300g further includes a cladding layer 312 formed using a dielectric material (e.g., oxide) and conductive regions 318a, 318b, 320c (e.g., metal). Conductive regions 318a, 318b, 320e in the cladding layer 312 can be connected to conductive regions 314a, 314b, 316e (e.g., metal or doped semiconductor) in the silicon layer 302 for providing the photocarriers absorbed and/or amplified in the silicon region 302 to an external circuitry. The photodetector 300g may be bonded to a circuit chip 330 (e.g., circuit chip 230) using hybrid-bonding, where electrical connections may be formed through conductive regions 322a, 322b, 322c (e.g., metal). The conductive regions 322a, 322b, 322e can be isolated by a dielectric material (e.g., oxide).

In some implementations, one or more additional dielectric or polymer or semiconductor layers (not shown) may be formed over the silicon layer 302 to function as an anti-reflection coating or a wavelength filter for the optical signal.

FIG. 3H (shown as the back-side-incident cross-section view) shows an example photodetector 300h having a silicon absorption region, which can be used to detect and amplify an optical signal in the visible or the NIR wavelength range. The photodetector 300h may be operated as a PD or an APD under different voltage biases. The photodetector 300h includes a silicon layer 302. Similar to the photodetector 300g described in reference to FIG. 3G, the silicon layer 302 can include a first p-doped region 352 and a first n-doped region 356. The photodetector 300h can include a second n-doped region 364. In some implementations, the doping concentration of the second n-doped region 364 is moderately-doped (e.g., in the range of <10¹⁸ cm⁻³).

In some implementations, the silicon layer 302 further includes a low-field region 368 (e.g., an absorption region) formed between the first n-doped region 356 and the second n-doped region 364. The silicon layer 302 can further include a high-field region 366 (e.g., an amplification region) formed between the first p-doped region 352 and the second n-doped region 364. In some implementations, the doping concentration of the low-field region 368 and/or the high-field region 366 is intrinsic (e.g., undoped or with a background doping) or lightly-doped (e.g., in the range of <10¹⁷ cm⁻³).

In some implementations, when the photodetector 300h is biased close to a breakdown voltage, the photodetector 300h is operated as an APD, where a lower electric field (e.g., a field that does not cause avalanche breakdown) is formed in the low-field region 368 and a higher electric field (e.g., a field that causes avalanche breakdown) is formed in the high-field region 366. During operation, light that enters the photodetector 300h is at least partially or entirely absorbed in the high-field region 366. The holes generated by the light absorbed in the high-field region 366 are amplified by the high-field region 366, and drifted to and collected by the first p-doped region 352. The electrons generated by the light absorbed in the high-field region 366 are amplified by the high-field region 366 and drifted to the first n-doped region 356. Moreover, any light that has not been absorbed by the high-field region 366 may be absorbed by the low-field region 368, and the generated photocarriers are drifted and collected by the first n-doped region 356. The holes generated in the low-field region 368 are drifted and collected by the first p-doped region 352. Advantageously, the high-field region 366 is defined by the separation between the first p-doped region 352 and the second n-doped region 364. The high-field region 366 can be designed to be thin to reduce the breakdown voltage, where power for operating the photodetector 300h can be reduced accordingly.

In some implementations, one or more additional dielectric or polymer or semiconductor layers (not shown) may be formed over the silicon layer 302 to function as an anti-reflection coating or a wavelength filter for the optical signal.

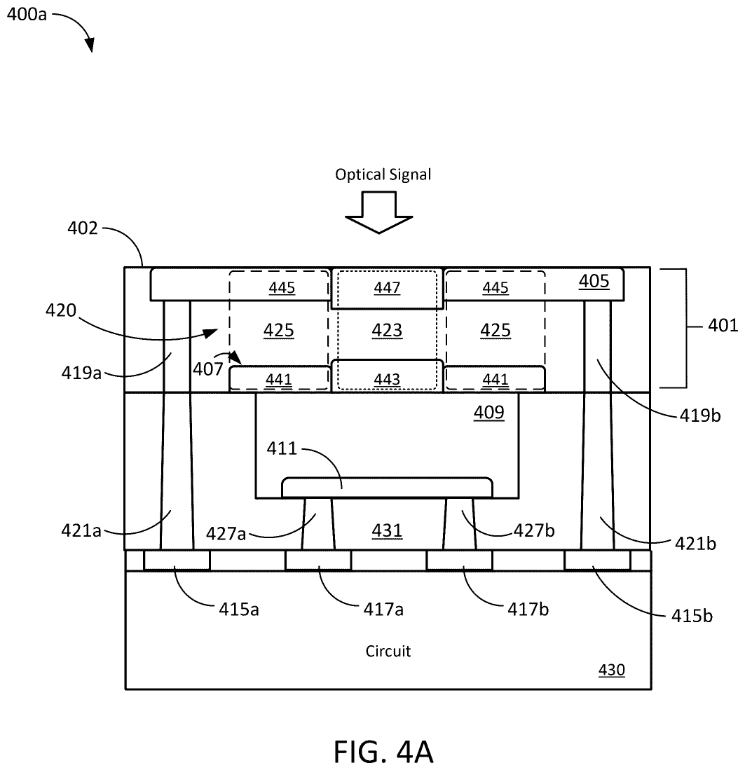

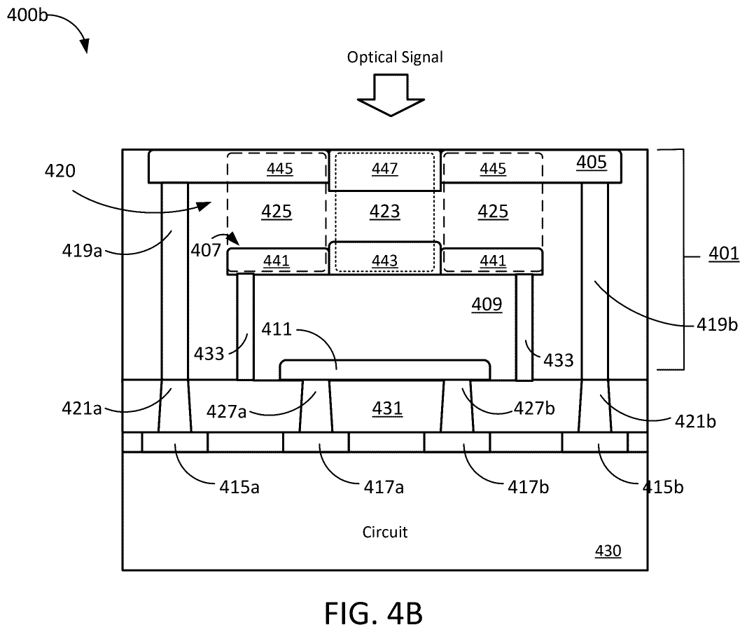

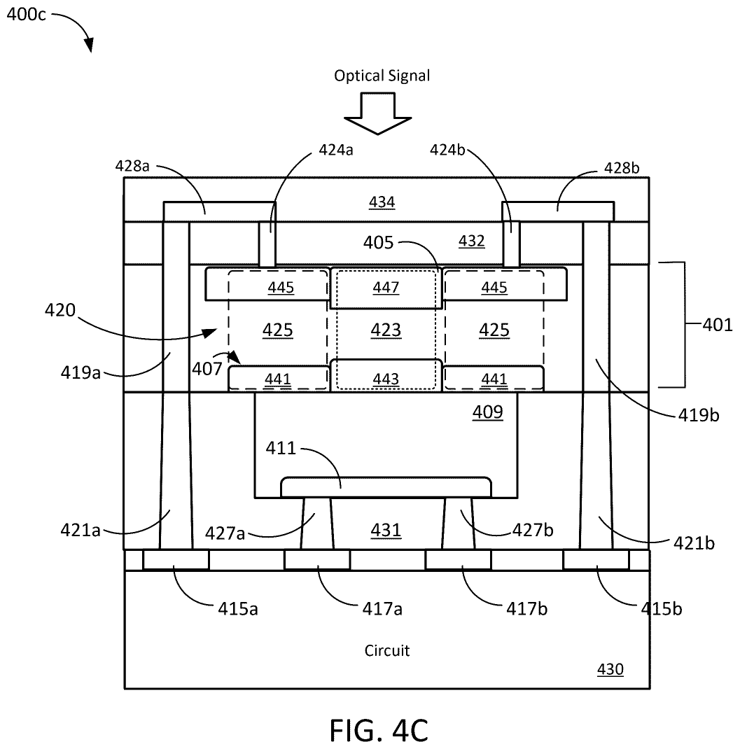

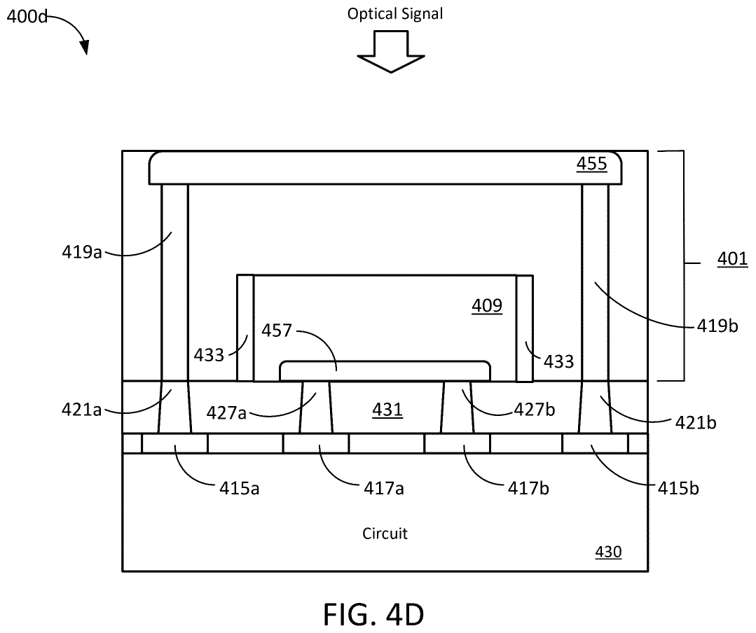

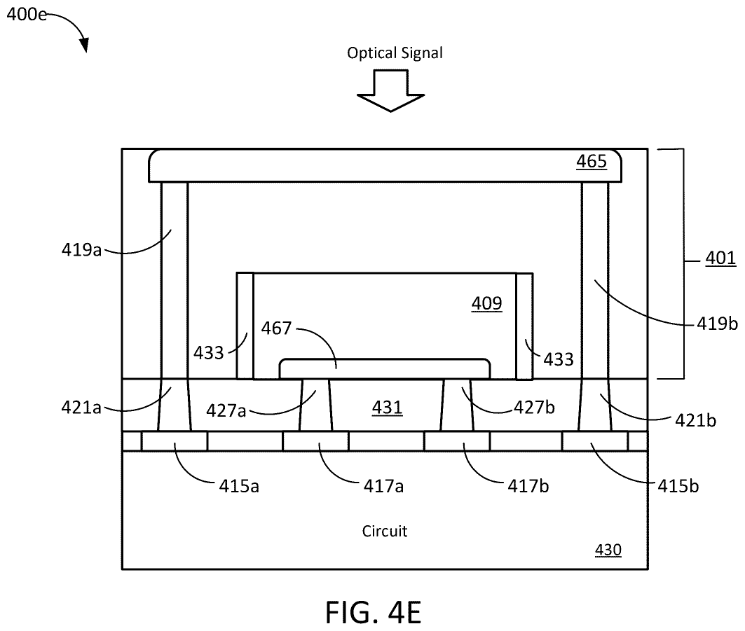

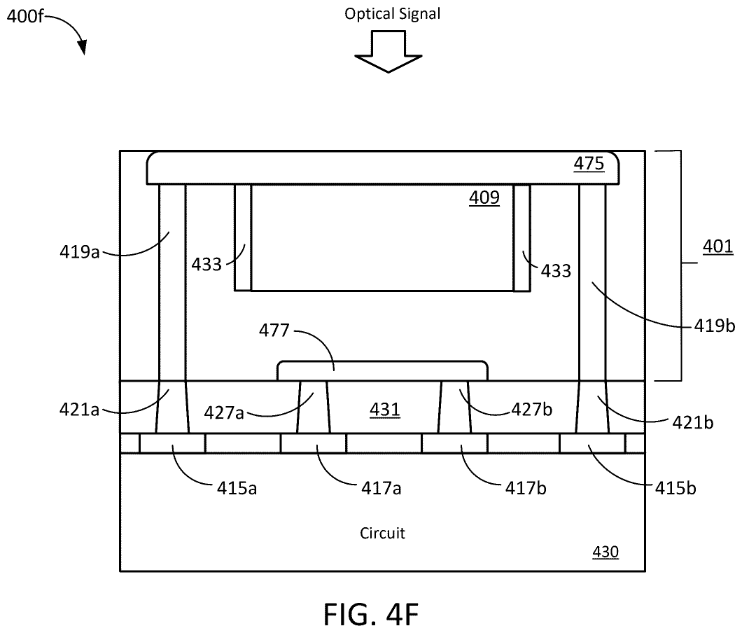

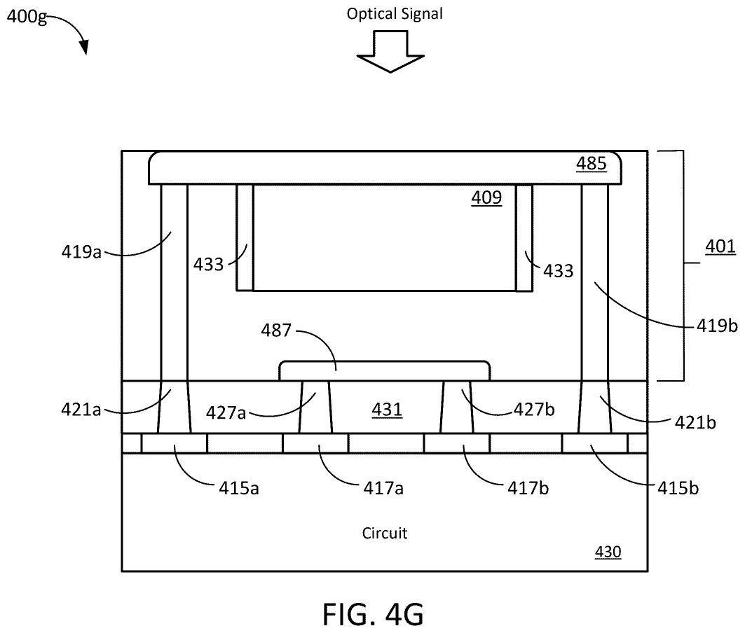

FIGS. 4A and 4B show example photodetectors 400a and 400b having a germanium absorption region, which can be used to detect an optical signal in the visible or the NIR or the SWIR wavelength range. The photodetector 400a/400b may be operated as a PD or an APD under different voltage biases. Referring to FIG. 4A, the photodetector 400a includes a silicon substrate 401 and a germanium (Ge) absorption region 409, where the absorption region 409 is configured to receive an optical signal and generate photo-carriers in response to receiving the optical signal. The absorption region 409 is supported by the substrate 401 (FIGS. 4A and 4B show a back-side-incident cross-section view, where the backside of the silicon substrate 401 is shown as the top surface). Referring to FIG. 4A, in some embodiments, the absorption region 409 is formed over the silicon substrate 401 as a mesa. Referring to FIG. 4B, in some embodiments, the absorption region 409 is embedded in a trench formed in the silicon substrate 401.

The photodetector 400a can further include an n-doped buried-dopant region 405 formed in the silicon substrate 401. In some implementations, the backside surface 402 of the silicon substrate 401 may be in contact or embedded in the n-doped buried-dopant region 405 if the silicon substrate 401 is additionally used as an absorption region at certain wavelengths, e.g., in the visible or the NIR wavelength range. The photodetector 400a can further include an amplification region 420 formed in the silicon substrate 401, where under the linear or Geiger mode operation of APD with an appropriate reverse bias voltage, the amplification region 420 can be configured to collect at least a portion of the photo-carriers and to amplify the portion of the photo-carriers. The n-doped buried-dopant region 405 can be configured to collect at least a portion of the amplified photo-carriers from the amplification region 420. In some implementations, the amplification region 420 may be intrinsic (e.g., undoped or with a background doping) or lightly doped (e.g., in the range of <10¹⁷ cm⁻³). In some implementation, when the multiplication factor of the amplified photo-carriers from the amplification region 420 is around unity, the photodetector 400a may be operated as a PD instead of an APD.

In some implementations, the photodetector 400a further includes a p-doped interface-dopant region 407 formed in the silicon substrate 401. In some implementations, at least one of the p.doped interface-dopant region 407 or the n-doped buried-dopant region 405 includes one or more first regions (e.g., first buried-dopant regions 447 or first interface-dopant regions 443) and one or more second regions (e.g., second buried-dopant regions 445 or second interface-dopant regions 441) surrounding the one or more first regions, where a property of the one or more first regions is different from a property of the second regions so as to form, under a reverse bias voltage (e.g., a voltage far below the break-down voltage for linear-mode operation of PD, a voltage below the break-down voltage for linear-mode operation of APD, or a voltage above the breakdown voltage for Geiger-mode operation of APD). For example, in the one or more punch-through regions 423 and one or more blocking regions 425, the electric field associated with the one or more punch-through region 423 is stronger than the electric field associated with the one or more blocking regions 425 at a reverse bias.

In some implementations, the property includes peak doping concentration or depth. For example, a peak doping concentration of the one or more first regions 447 of the buried-dopant region 405 is greater than a peak doping concentration of the one or more second regions 445 of the buried-dopant region 405. For another example, a depth of the one or more first regions 447 of the buried-dopant region 405 is deeper (with respect to the absorption region 409) than a depth of the one or more second regions 445 of the buried-dopant region 405 (in other words, the one or more first regions 447 of the buried-dopant region 405 is closer to the absorption region 409 than the one or more second regions 445). For another example, a peak doping concentration of the one or more first regions 443 of the interface-dopant region 407 is lower than the than a peak doping concentration of the one or more second regions 441 of the interface-dopant region 407. For another example, a depth of the one or more first regions 443 of the interface-dopant region 407 is deeper (with respect to the absorption region 409) than a depth of the one or more second regions 441 of the interface-dopant region 407 (in other words, a top surface of the one or more first regions 443 of the interface-dopant region 407 is farther from the absorption region 409) than a top surface of the one or more second regions 441 of the interface-dopant region 407. In some implementation, the doping in the one or more first regions 447 of the buried-dopant region 405 and one or more first regions 443 of the interface-dopant region 407 may be absent at the same time, while the doping in the one or more second regions 445 of the buried-dopant region 405 and one or more second regions 441 of the interface-dopant region 407 may be present at the same time.

By controlling one or more properties (e.g., dopant level, dopant depth, etc.) of the p-doped interface-dopant region 407 and the n-doped buried-dopant region 405, one or more blocking regions 425 can be formed around one or more punch-through regions 423. In some cases, the punch-through region(s) 423 has a first punch-through/break-down voltage lower than a second punch-through/break-down voltage associated with the one or more blocking regions 425, such that carrier collection/carrier amplification begins to occur in the punch-through region(s) 423 before the one or more blocking regions 425. Accordingly, the one or more punch-through regions 423 can collect at least a portion of the photo-carriers from the absorption region 409 and amplify the collected photo-carriers under the first punch-through/break-down voltage. As a result, the occurrence of punch-through/breakdown can be confined in the punch-through regions 423 instead of the whole amplification region 420. These punch-through regions 423 and the blocking regions 425 as field-controlled regions with different punch-through/breakdown voltages can help to avoid premature breakdown in avalanche photodiode (APD), which improves sensitivity and/or reduces amplification of dark current.

In some implementations, the first interface-dopant regions 443 may be formed in silicon and/or in germanium near the silicon-germanium interface. In some other implementations, the portion of the first interface-dopant regions 443 formed in silicon may be at a distance (e.g., a few hundreds of nanometers) away from the silicon-germanium interface. In some other implementations, the portion of the first interface-dopant regions 443 formed in germanium may be at the silicon-germanium interface, or at a distance (e.g., a few tens of nanometers) away from the silicon-germanium interface.

In some implementations, the photodetector 400a further includes a cladding layer 431 formed surrounding or over the absorption region 409. In some implementations, the photodetector 400a further includes one or more first contacts 415a/415b formed on the cladding layer 431 and electrically coupled to the n-doped buried-dopant region 405. In some implementations, a circuitry chip 430 (e.g., circuit chip 230) may be coupled to the photodetector 400a via one or more first contacts 415a/415b and/or the one or more second contacts 417a/417b.

In some implementations, the photodetector 400a further includes one or more first conductive regions 419a/419b formed in the substrate 401 and electrically coupled to the n-doped buried-dopant region 405. In some implementations, the one or more first conductive regions 419a/419b can be formed using a highly n-doped semiconductor to be a conductive material. In some other implementations, the one or more first conductive regions 419a/419b can be formed using metal to be a conductive material. In some implementations, the photodetector 400a further includes one or more second conductive regions 421a/421b formed in the cladding layer 431, where each one of the one or more second conductive regions 421a/421b is electrically coupled to (i) a respective one of the one or more first contacts 415a/415b, and (ii) a respective one of the one or more first conductive regions 419a/419b.

In some implementations, the absorption region 409 includes a highly p-doped region 411 configured to collect holes, where the buried-dopant region 405 is configured to collect electrons. In some implementations, the photodetector 400a further includes one or more second contacts 417a/417b over the cladding layer 431. In some implementations, the photodetector 400a further includes one or more third conductive regions 427a/427b formed in the cladding layer 431 for electrical connection between the highly p-doped contact region 411 and the respective one or more second contacts 417a/417b. In some implementations, the second conductive regions 421a/421b and the third conductive regions 427a/427b may be vias filled with metal (e.g., tungsten).

In some implementations, the germanium absorption region 409 is p-doped with a gradient doping profile (e.g., step-like or gradual increase/decrease). In some implementations, the concentration of the gradient doping profile is radially deceased from the p-doped region 411. In some implementations, the concentration of the gradient doping profile is radially increased from the interface between the germanium absorption region 409 and the silicon substrate 401.

In some implementations, similar to the photodetector 300e as described in reference to FIGS. 3E and 3F, the buried-dopant region 405 can be patterned to expose the germanium absorption region 409 to allow more optical signals or light to enter the germanium absorption region 409 and therefore can improve the overall photodetector quantum efficiency and/or operation bandwidth.

In some implementations, one or more additional dielectric or polymer or semiconductor layers (not shown) may be formed over the silicon substrate 401 to function as an anti-reflection coating or a wavelength filter for the optical signal.

Referring to FIG. 4B, in some implementations, the germanium absorption region 409 is embedded in the silicon substrate 401 (e.g., a trench filled with a germanium region). In some implementations, the sidewall-dopant regions 433 in silicon and/or germanium are highly p-doped for further facilitating the carriers entering the amplification region 420 through the one or more first interface-dopant regions 443. In some implementations, one or more additional dielectric or polymer or semiconductor layers (not shown) may be formed over the silicon substrate 401 to function as an anti-reflection coating or a wavelength filter for the optical signal.

FIG. 4C shows another example photodetector 400c having a germanium absorption region. The photodetector 400c is similar to the photodetector 400a/400b, with the difference that the electrical coupling between the n-doped buried-dopant region 405 and the circuit 430 are routed through one or more backside conductive regions 424a and 424b, one or more backside conductive regions 428a and 428b, and the first conductive regions 419a and 419b. The photodetector 400c includes a first dielectric layer 432 formed on the silicon layer 401, and a second dielectric layer 434 formed on the first dielectric layer 432. In some implementations, a combination of the first dielectric layer 432, the second dielectric layer 434, and/or one or more additional layers (not shown) can function as an anti-reflection coating or a wavelength filter for the optical signal. In some implementations, the backside conductive regions 428a and 428b can function as an optical aperture, where the backside conductive regions 428a and 428b can block a portion of the optical signal from entering into the photodetector 400c. In some implementation, the backside conductive regions 424a and 424b, 428a and 428b, and the first conductive regions 419a/419b when being implemented with metal, can prevent inter-pixel optical crosstalk, as well as improve design flexibility on where the conductive regions 415a and 415b can be placed.

FIGS. 4D-4E illustrate example photodetectors without an interface-dopant region. Referring to FIG. 4D, the photodetector 400d includes an n-doped buried-dopant region 455 in silicon and a highly p-doped region 457 in germanium. During operation, the photodetector 400d may be reverse biased such that photo-generated holes may be collected by the highly p-doped region 457 and photo-generated electrons may be collected by the n-doped buried-dopant region 455. Referring to FIG. 4E, the photodetector 400e includes a p-doped buried-dopant region 465 in silicon and a highly n-doped region 467 in germanium. During operation, the photodetector 400e may be reverse biased such that photo-generated electrons may be collected by the highly n-doped region 467 and photo-generated holes may be collected by the p-doped buried-dopant region 465. In some implementations, one or more additional dielectric or polymer or semiconductor layers (not shown) may be formed over the silicon substrate 401 to function as an anti-reflection coating or a wavelength filter for the optical signal.

In some implementations, an interface-dopant region similar to the interface-dopant region 407 may be formed in the silicon substrate 401 of the photodetector 400d/400c, so that an amplification region may be formed between the germanium region 409 and the buried-dopant region (e.g., the n-doped buried-dopant region 455 or the p-doped buried-dopant region 465) to provide an avalanche gain when operated close to a breakdown voltage.

FIGS. 4A-4E illustrate example photodetectors where an optical signal enters to a silicon region before germanium, which can be used to detect an optical signal in the visible or the NIR or the SWIR wavelength range. FIGS. 4F and 4G illustrate example photodetectors where an optical signal enters to germanium before a silicon region, which can also be used to detect an optical signal in the visible or the NIR or the SWIR wavelength range.

Referring to FIG. 4F, the photodetector 400f includes a highly p-doped 475 in silicon and a highly n-doped region 477 in silicon. The highly p-doped 475 is thin (e.g., several hundred nanometers), so that an optical signal entering the photodetector 400f is mostly absorbed by the germanium region 409. During operation, the photodetector 400f may be reverse biased such that photo-generated electrons may be collected by the highly n-doped region 477 and photo-generated holes may be collected by the highly p-doped buried-dopant region 475. In some implementations, one or more additional dielectric or polymer or semiconductor layers (not shown) may be formed over the silicon substrate 401 to function as an anti-reflection coating or a wavelength filter for the optical signal.

Referring to FIG. 4G, the photodetector 400g includes a highly n-doped 485 in silicon and a highly p-doped region 487 in silicon. The highly n-doped 485 is thin (e.g., several hundred nanometers), so that an optical signal entering the photodetector 400g is mostly absorbed by the germanium region 409. During operation, the photodetector 400g may be reverse biased such that photo-generated electrons may be collected by the highly n-doped region 485 and photo-generated holes may be collected by the highly p-doped buried-dopant region 487. In some implementations, one or more additional dielectric or polymer or semiconductor layers (not shown) may be formed over the silicon substrate 401 to function as an anti-reflection coating or a wavelength filter for the optical signal.

FIG. 5A illustrates the top view of an example optical receiving chip 500 having a two-dimensional (2-D) array of photodetectors. The optical receiving chip 500 can be implemented as the optical-receiver chip 220 of FIG. 2A or 2B. A photodetector in the 2-D array of photodetectors can be same as, or similar to, the photodetector 300a, 300b, 300c, 300d, 300c, 300g, 300h, 400a, 400b, 400c, 400d, 400c, 400f, or 400g, as described in FIGS. 3A-3H and 4A-4G.

In some implementations, each of multiple photodetectors (e.g., photodetector 511, 512, 513, etc.) can be arranged to receive an optical signal from a corresponding fiber or fiber group. In some other implementations, each of multiple photodetectors can include multiple subsets of photodetectors (e.g., subsets 502, 504, and 506), where the photodetectors in each subset can be electrically binned together to detect an optical signal from a corresponding light source of the multiple light sources. As an example, if (i) a beam diameter from a multimode fiber (or a collective beam diameter from a multimode fiber group) incident on the optical receiver chip 500 is 70 μm, and (ii) if each photodetector is a 10 μm×10 μm square, then 7×7 of photodetectors can be electrically binned (e.g., through hardwire or logic control) together to detect an optical signal from the multimode fiber. As another example, if the optical signals from the multimode fiber contain multiple wavelengths (e.g., for WDM), then different wavelength filters (e.g., thin film filters or metalens filters on a 2-D surface) may be added to the surface of the optical receiving chip 500, where photodetectors associated with the same wavelength filter within a subset may be electrically binned together to detect a corresponding wavelength channel from a multimode fiber without implementing a wavelength demultiplexer. In some implementations, normal-incident free-space WDM/DWDM filters may be added between the multimode fiber and the optical receiving chip 500 direct optical signals of different wavelengths to corresponding photodetectors.

FIG. 5B illustrates an example partial cross-section view of the optical receiving chip 500. The example optical receiving chip 500 includes a first substrate 510 and a second substrate 530, which can each be a silicon substrate. The first substrate 510 and the second substrate 530 can be wafer-bonded via a bonding interface 520 (e.g., oxide or any other suitable materials). The first substrate 510 includes multiple photodetectors 511, 512, and 513. Each of the multiple photodetectors 511, 512, and 513 can be a channel that is separated by a fixed or variable pitch P. The second substrate 530 includes multiple corresponding circuitry areas 531, 532, and 533. The multiple photodetectors 511, 512, and 513 and the multiple corresponding circuitry areas 531, 532, and 533 can be electrically coupled through the bonding interface 520 via electrical interconnects 522 that can be isolated by a dielectric material (e.g., oxide) in the bonding interface 520.

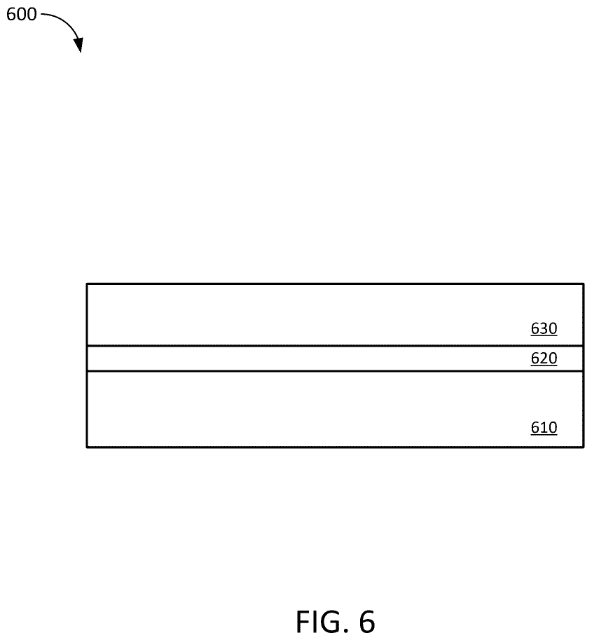

FIG. 6 illustrates an example photodetector 600 for detecting light in the visible and/or NIR wavelength range(s). The photodetector 600 can be same as, or similar to, the photodetector 300a, 300b, 300c, 300d, 300c, 300g, 300h, 400a, 400b, 400c, 400d, 400c, 400f, or 400g, as described in FIGS. 3A-3H and 4A-4G. In some cases, a material such as germanium has an absorption coefficient that is one order to two orders of magnitude higher than that of silicon at the visible and NIR light wavelength spectrum. As such, a thickness of a germanium-based absorption layer can be much thinner than that of a silicon-based absorption layer. By properly engineering the absorption layer and the collection layers for the two carrier types (e.g., electrons and holes), a high-bandwidth photodetector can be implemented.

In some implementations, the photodetector 600 includes a high-conductivity region 610, an absorption region 620, and a high-field region 630. The high-conductivity region 610 can be configured to collect heavier carriers such as holes. In some implementations, the high-conductivity region 610 can be highly p-doped (e.g., higher than 10¹⁸ cm⁻³), and can be formed using germanium, silicon, amorphous silicon, or silicon carbide. In some implementations, a thickness of the high-conductivity region 610 can be smaller than an absorption length (inversely proportional to the absorption coefficient) associated with a wavelength of the optical signal to be received by the absorption region 620 when the light is injected from the side of the high-conductivity region 610. During operation, the high-conductivity region 610 can be biased to create a low RC (resistor-capacitor) time constant, such that the heavier carriers can be collected by one or more electrical contacts (not shown) with a short relaxation time.

The high-field region 630 can be configured to collect lighter carriers such as electrons. In some implementations, the high-field region 630 can be intrinsic (e.g., undoped or with a background doping) or lightly doped (e.g., smaller than 10¹⁷ cm⁻³), and can be formed using silicon. In some implementations, a thickness of the high-field region 630 can be smaller than an absorption length associated with a wavelength of the optical signal to be received by the absorption region 620 when the light is injected from the side of the high-field region 630. During operation, the high-field region 630 can be biased to create a high electric field (e.g., larger than 10 kV/cm), such that the lighter carriers can be collected by one or more electrical contacts (not shown) with a short transit time.

The absorption region 620 can be configured to receive an optical signal and to generate photo-carriers in response to receiving the optical signal. In some implementations, the absorption region 620 can be doped (e.g., between 10¹⁷ cm⁻³ and 10¹⁸ cm⁻³) or intrinsic (e.g., undoped or with a background doping), and can be formed using germanium. In some implementations, a thickness of the absorption region 620 can be around an absorption length associated with a wavelength of the optical signal to be received by the absorption region 620. For example, a thickness of the absorption region 620 can be in a range between 20 nm to 200 nm.

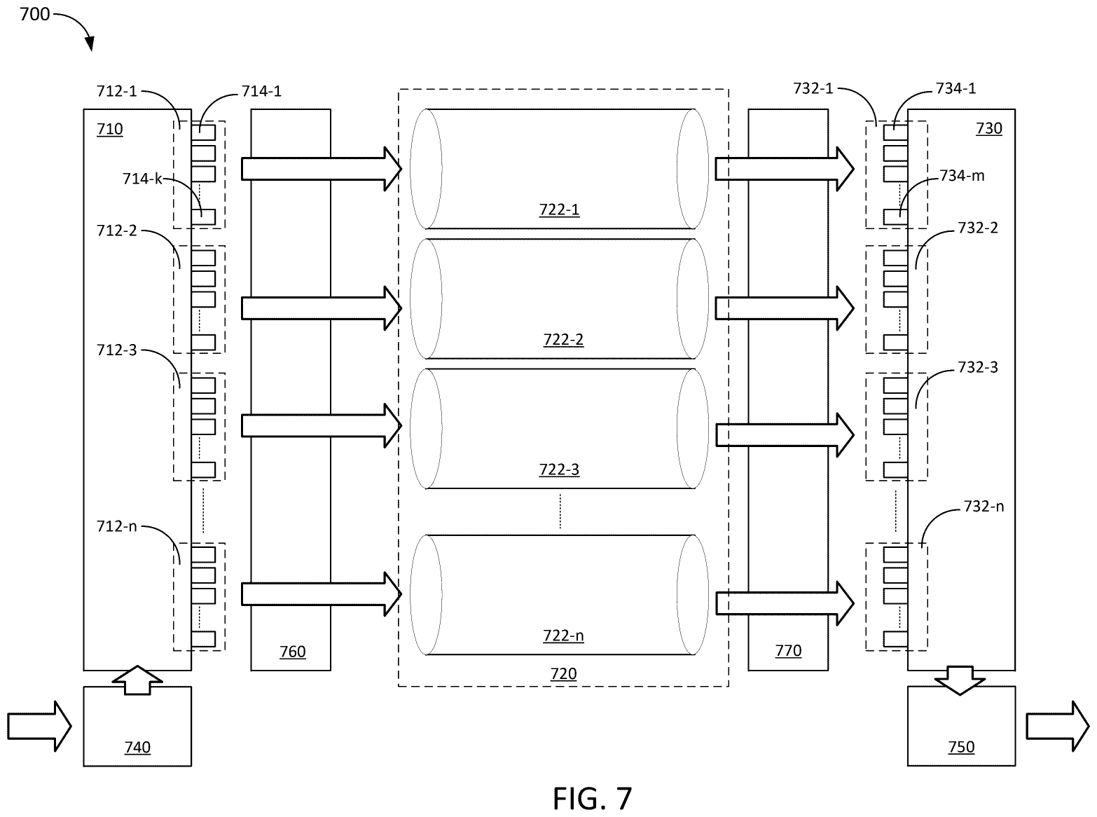

FIG. 7 illustrates an example optical link 700. The optical link 700 can be same as or similar to the optical link 110 as described in FIGS. 1A to 1E or the optical link 110′ of FIG. 1G. A waveguide such as a multimode optical fiber (or a group of multimode fibers) can receive light from multiple sources. Moreover, the size of a light source or a photodetector may be different (e.g. smaller) than that of a waveguide. For example, a multimode optical fiber may have a core diameter of 20 μm. If each of light sources (e.g., micro-LED or VCSEL) arranged in a 2D array has a diameter of 10 μm, multiple light sources (e.g., 1×1, 1×2, 2×2, etc.) can be optically coupled to one end of the multimode optical fiber to send data to the other end of the multimode optical fiber. Similarly, if each of photodetectors arranged in a 2D array has a diameter of 5 μm, multiple photodetectors (e.g., 1×1, 2×2, 4×4, etc.) can be optically coupled to the other end of the multimode optical fiber to receive data. Accordingly, a fiber bundle with multiple multimode optical fibers can be used to provide high-bandwidth communications between light sources in a 2D array and photodetectors in a 2D array, where the dimensions of the light sources, the multimode optical fibers, and/or the photodetectors can be different. As described in more details below, such link offers technical advantages such as design flexibility, reliability, and/or advanced modulation schemes.

In some implementations, the optical link 700 includes an optical emitter 710, a waveguide bundle 720, an optical receiver 730, a first processor 740, and a second processor 750. The waveguide bundle 720 includes multiple waveguides 722-1 to 722-n, where n≥2 (e.g., multimode optical fibers in a fiber-array unit 170). The optical emitter 710 (e.g., optical-emitter chip 210) includes multiple light sources that are arranged in light source groups 712-1 to 712-n. The multiple light sources may be micro-LEDs, VCSELs, LEDs, etc. As an example, the light source group 712-1 includes multiple first light sources 714-1 to 714-k (k≥2). The multiple first light sources 714-1 to 714-k are optically coupled with the first optical waveguide 722-1. In some implementations, the multiple first light sources 714-1 to 714-k may be arranged in a 2D array on a first substrate (e.g., silicon substrate). In some other implementations, the multiple first light sources 714-1 to 714-k may be arranged in a 1D array on the first substrate. In some implementations, the multiple first light sources 714-1 to 714-k may include microcavity structures or nanocavity structures configured to enhance a spontaneous emission rate (e.g., Purcell effect) of the multiple first light sources 714-1 to 714-k.

The optical receiver 730 (e.g., optical receiver chip 220 or optical receiving chip 500) includes multiple photodetectors that are arranged in photodetector groups 732-1 to 732-n. The multiple photodetectors may be a Si or GeSi photodetector described in reference to any of FIGS. 3A-3F and 4A-4G. As an example, the photodetector group 732-1 includes multiple first photodetectors 734-1 to 734-m (m≥2, where m and k may be different numbers). The multiple first photodetectors 734-1 to 734-m are optically coupled with the first optical waveguide 722-1 to receive optical signals emitted from the light source group 712-1. In some implementations, the multiple first photodetectors 734-1 to 734-m may be arranged in a 2D array on a second substrate (e.g., silicon substrate). In some other implementations, the multiple first photodetectors 734-1 to 734-m may be arranged in a 1D array on the second substrate. In some implementations, the multiple first photodetectors 734-1 to 734-m may be binned to operate as a single large photodetector or several medium photodetectors (e.g., as described in reference to FIG. 5A).

The first processor 740 can include one or more combinations of circuitry, firmware, software, memory, and/or processing hardware/software components, and can be configured to control the optical emitter 710. In some implementations, the first processor 740 may receive electrical signals from a data source (e.g., a CPU, a network-interface card, a GPU, etc.), process data in the electrical signals (e.g., serialize, deserialize, etc.), and drive the optical emitter 710 to output optical signals that represent the data in the electrical signals. For example, the first processor 740 may receive electrical signals modulated at a data rate of 50 Gbps over the non-return-to-zero (NRZ) encoding scheme. The first processor 740 may drive one light source group (e.g., 712-1) at a data rate of 50 Gbps over the non-return-to-zero (NRZ) encoding scheme to output optical signals that represent the data in the electrical signals. Alternatively, the first processor 740 may drive two light source groups (e.g., 712-1 and 712-2) at a data rate of 25 Gbps over the non-return-to-zero (NRZ) encoding scheme to output optical signals that represent the data in the electrical signals. Alternatively, the first processor 740 may drive five light source groups (e.g., 712-1 to 712-5) at a data rate of 10 Gbps over the non-return-to-zero (NRZ) encoding scheme to output optical signals that represent the data in the electrical signals. Alternatively, the first processor 740 may drive one light source group (e.g., 712-1) at a baud rate of 25 Gbps over the pulse-amplitude-modulation 4-level (PAM4) encoding scheme to output optical signals that represent the data in the electrical signals. Depending on the performance parameters (e.g., bandwidth) of the light sources, the first processor 740 may be configured to control the optical emitter 710 accordingly.

In some implementations, the first processor 740 may be configured to control the light sources in a light source group such that at least one light source transmits optical signals, and at least one redundant light source does not transmit optical signals. Referring to FIGS. 8A and 8B as an example, the first light source group 712-1 includes four light sources 714-1 to 714-4, where the light sources 714-1 to 714-3 are designated as primary light sources, and the light source 714-4 is designated as a redundant light source. Referring to FIG. 8A, the first processor 740 is configured to control the first light source group 712-1 such that the light sources 714-1 to 714-3 emit optical signals during operations, and the light sources 714-4 does not emit optical signals during operations. If one of the light sources 714-1 to 714-3 malfunctions during operations (e.g., the micro-LED fails to emit an optical signal due to device or circuit failure), the first processor 740 may determine that a primary light source has malfunctioned. In some implementations, the first processor 740 may determine the malfunction by determining that a total power transmitted by the primary light sources 714-1 to 714-3 is below a threshold value. If so, the first processor 740 may perform diagnosis tests (e.g., monitoring the optical power emitted by each of the primary light sources 714-1 to 714-3, etc.) to determine which of the primary light sources 714-1 to 714-3 has malfunctioned.

Referring to FIG. 8B, in response to determining that a primary light source has malfunctioned, the first processor 740 may control the multiple light sources 714-1 to 714-4 such that the malfunctioned primary light source (e.g., 714-1) stops transmitting optical signals, and the redundant light source (e.g., 714-4) starts to transmit optical signals. The first processor 740 may further control the other light source groups 712-2 to 712-n in a same manner. Accordingly, redundancy in an optical link may be achieved. Note that in different implementations, more or fewer light sources may be designated as primary or redundant in a light source group depending on the encoding schemes and/or redundancy requirements.

In some implementations, the optical signals emitted by the optical emitter 710 are encoded by a non-return-to-zero (NRZ) coding scheme. For example, the optical signals emitted by the light sources 714-1 to 714-3 can be coupled to the first optical waveguide 722-1 as one optical signal encoded by the NRZ coding (0 or 1) to improve the signal-to-noise ratio.

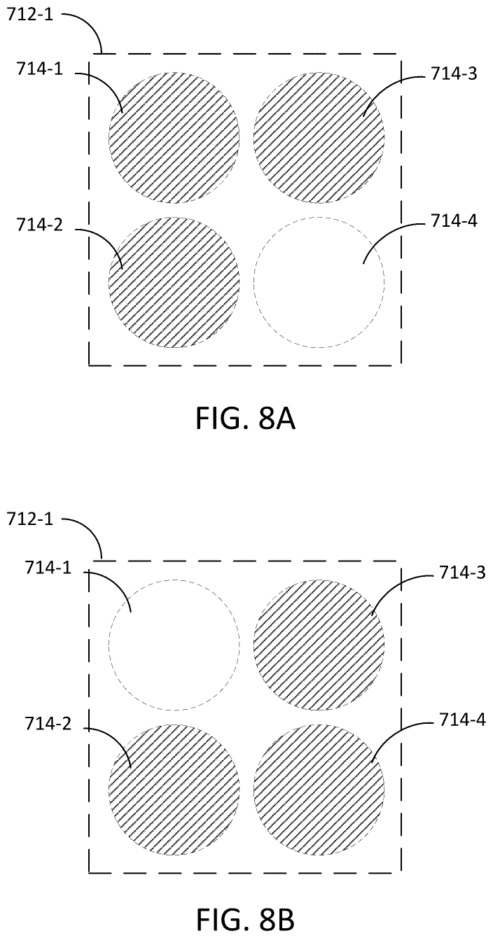

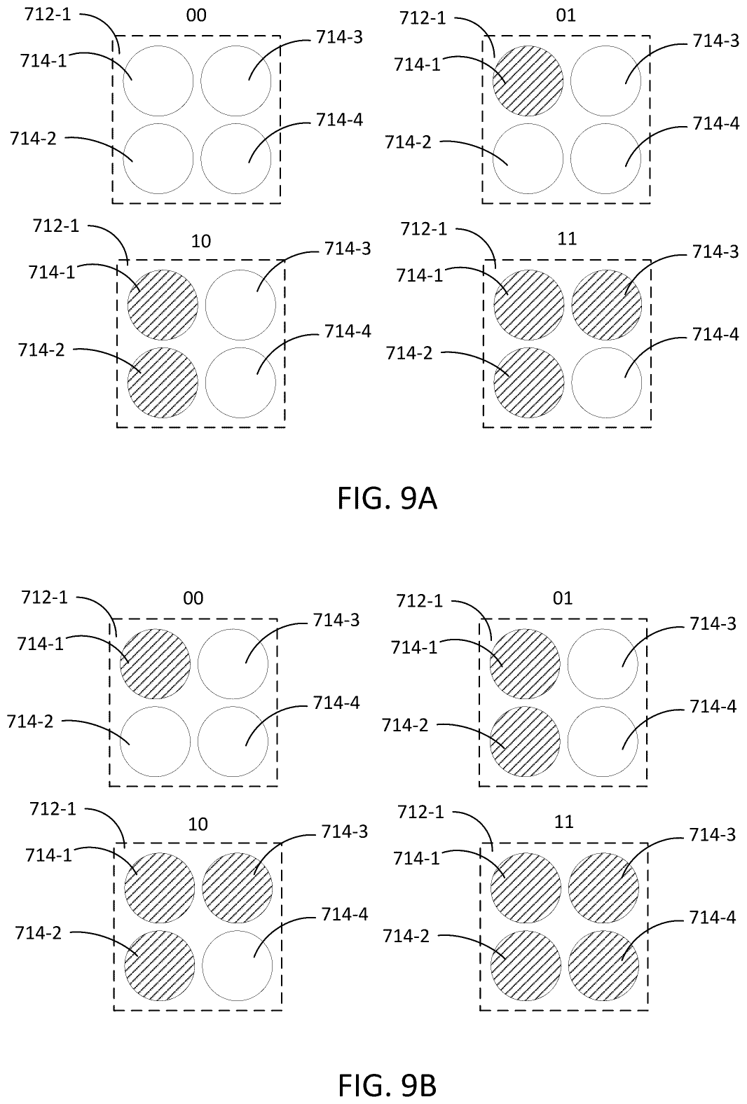

In some implementations, the optical signals emitted by the optical emitter 710 are encoded by a pulse-amplitude-modulation (PAM) coding, where a specific level of the PAM coding is represented by a number of multiple light sources that emit the optical signals. Referring to FIG. 9A as an example, the optical signals emitted by the light sources 714-1 to 714-3 can be coupled to the first optical waveguide 722-1 as one optical signal encoded by the PAM4 coding (00, 01, 10, or 11) to increase the bit rate of the data transmitted. When the transmitted symbol is 00, no light source is turned on to transmit optical signals. When the transmitted symbol is 01, the light source 714-1 is turned on to transmit optical signals, with the other two light sources 714-2, 714-3 being off. When the transmitted symbol is 10, the light sources 714-1 and 714-2 are turned on to transmit optical signals, with the other light source 714-3 being off. When the transmitted symbol is 11, the light sources 714-1 to 714-3 are turned on to transmit optical signals. Accordingly, a light source group can be used to implement PAM4 coding without the need to vary the amplitude of each of the light sources, which can simplify driver circuitry. In some implementations, the light sources 714-1 to 714-4 can be coupled together to the first optical waveguide 722-1, where the light sources 714-1 to 714-3 can be used as primary light sources for PAM4 coding, and the light source 714-4 can be used as a redundant light source.

Note that PAM4 is just an example coding scheme. Other suitable PAM coding schemes can used. For example, if PAM8 is used as the coding scheme, nine light sources in a light source group can be used such that seven light sources can be used as primary light sources (from 000 to 111), and two light sources can be used as redundant light sources.

FIG. 9B illustrates another example where the optical signals emitted by the optical emitter 710 are encoded by a pulse-amplitude-modulation (PAM) coding, where a specific level of the PAM coding is represented by a number of multiple light sources that emit the optical signals. Here, the optical signals emitted by the light sources 714-1 to 714-4 can be coupled to the first optical waveguide 722-1 as one optical signal encoded by the PAM4 coding (00, 01, 10, or 11). When the transmitted symbol is 00, the light source 714-1 is turned on to transmit optical signals, with the other light sources 714-2, 714-3, 714-4 being off. When the transmitted symbol is 01, the light sources 714-1 and 714-2 are turned on to transmit optical signals, with the other light sources 714-3, 714-4 being off. When the transmitted symbol is 10, the light sources 714-1 to 714-3 are turned on to transmit optical signals, with the other light source 714-4 being off. When the transmitted symbol is 11, the light sources 714-1 to 714-4 are turned on to transmit optical signals. Accordingly, a light source group can be used to implement PAM4 coding without the need to vary the amplitude of each of the light sources.

Referring back to FIG. 7, the second processor 750 is configured to receive the detected electrical signals outputted from the optical receiver 730, process the electrical signals (e.g., serialize, error check, digitize, etc.) to retrieve the data, and provide the data for further processing. In some implementations, the optical emitter 710 and the first processor 740 may be co-packaged with a computing system (e.g., as a part of the optical transceiver 120 described in reference to FIGS. 1A-1F). Similarly, the optical receiver 730 and the second processor 750 may be co-packaged with the same or a separate computing system.

In some implementations, the optical link 700 may include one or more optical elements 760 configured to couple the optical signals emitted by the optical emitter 710 to the waveguide bundle 720. In some implementations, the optical link 700 may include one or more optical elements 770 configured to couple the optical signals from the waveguide bundle 720 to the optical receiver 730. The optical element(s) 760 and 770 may include one or more of active optical elements (e.g., optical switches, optical routers, etc.), passive optical elements (e.g., optical waveguides, optical couplers, optical gratings such as in-coupling gratings, out-coupling gratings, focusing lens, collimating lens, wavelength filters, 45-degree mirrors, anti-reflection coating, etc.), and can be designed, for example in case of optical elements 760, such that the characteristics (e.g., numerical aperture, size, etc.) of the optical beam incident on the waveguide of the waveguide bundle 720 are compatible with the operating characteristics (e.g., numerical aperture, size, etc.) of the optical beam guided in the waveguide of the waveguide bundle 720.

In some implementation, one or multiple waveguides of the waveguide bundle 720 are used to transmit and receive the optical teams that represent a clocking signal. This can reduce the complexity of the second processor 750 since CDR (clock data recovery) circuitry may be largely simplified or even removed.

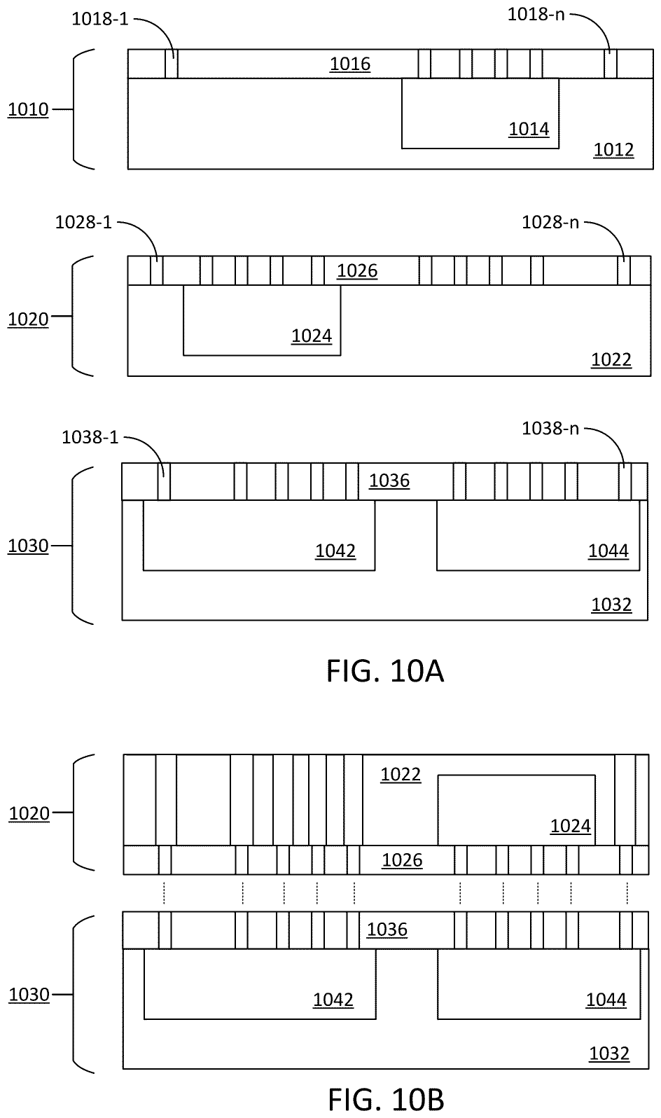

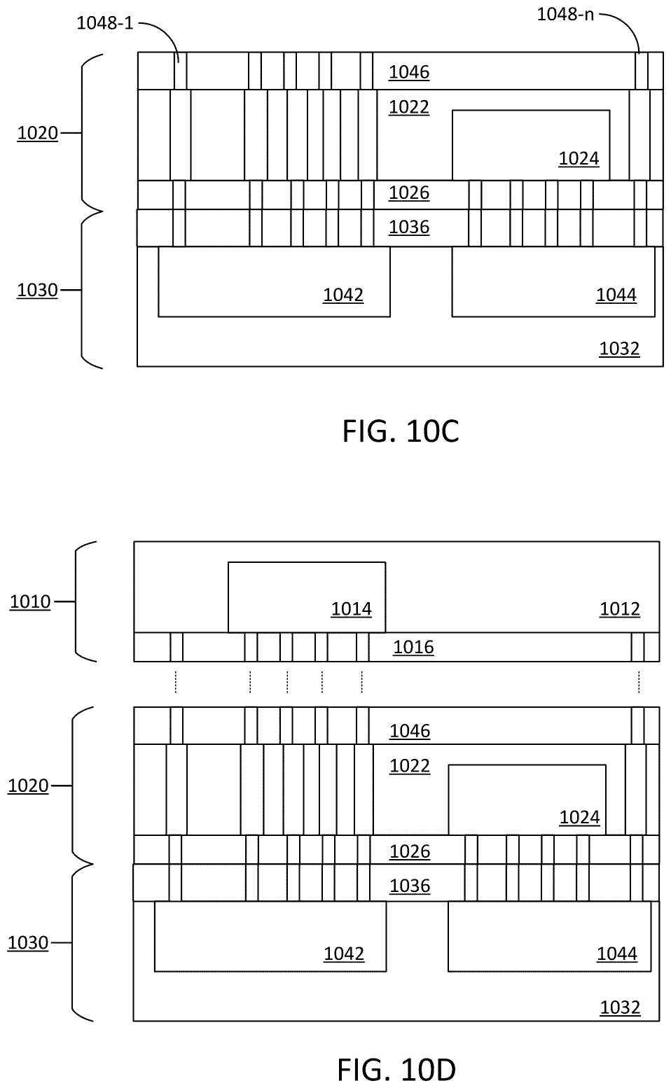

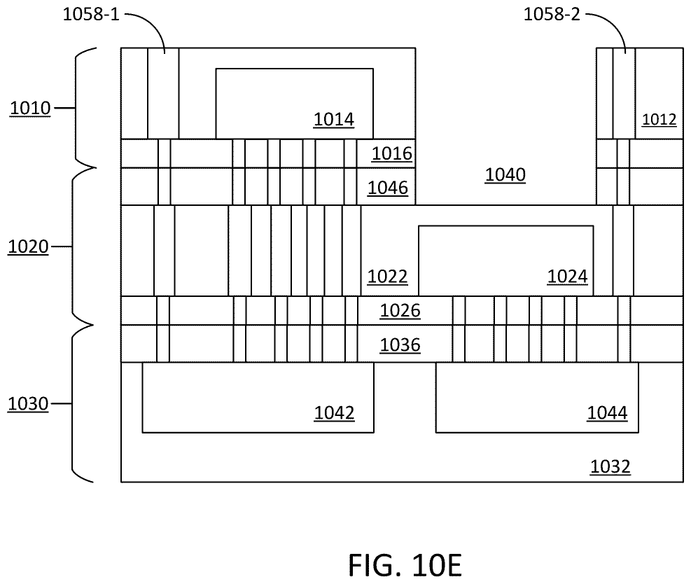

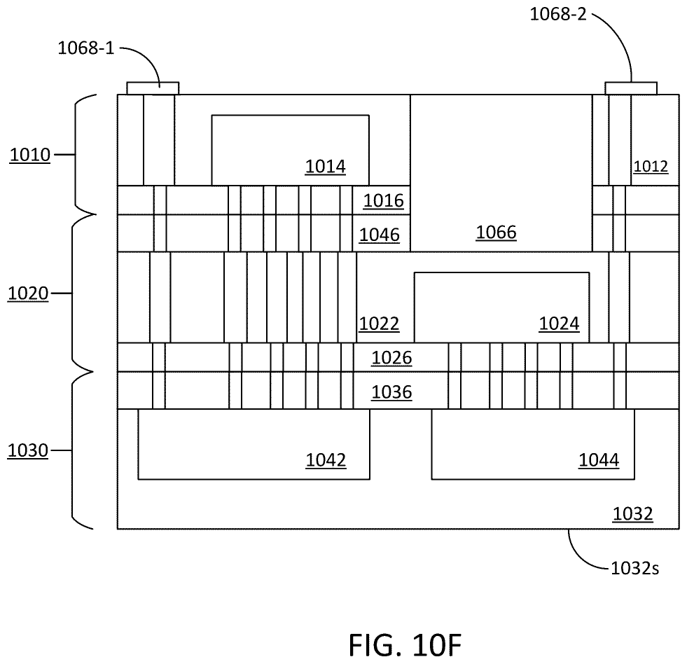

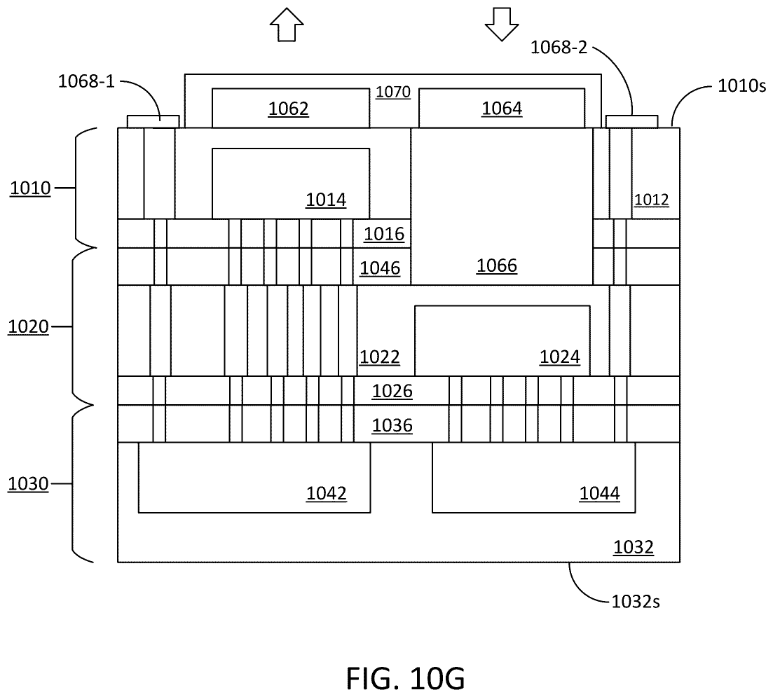

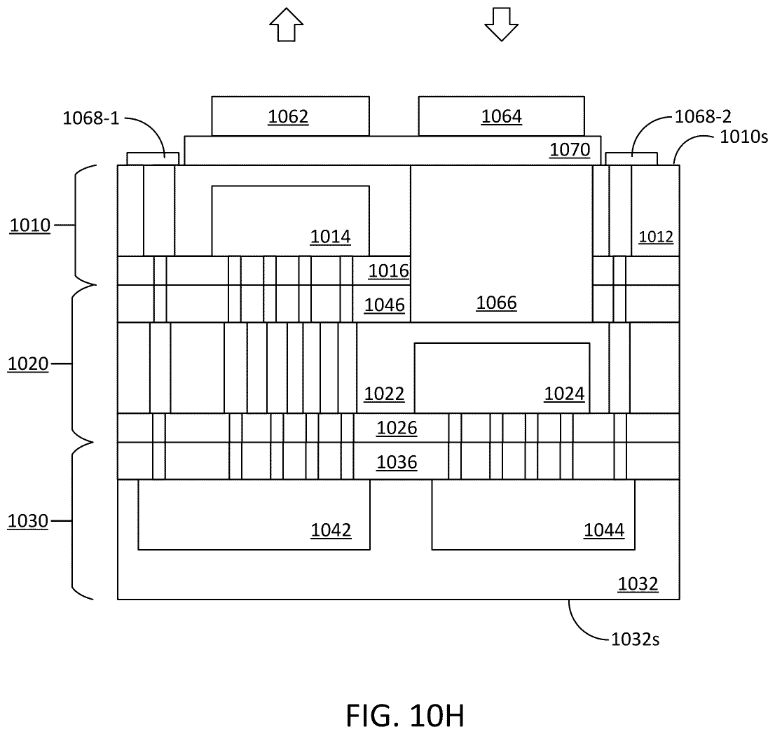

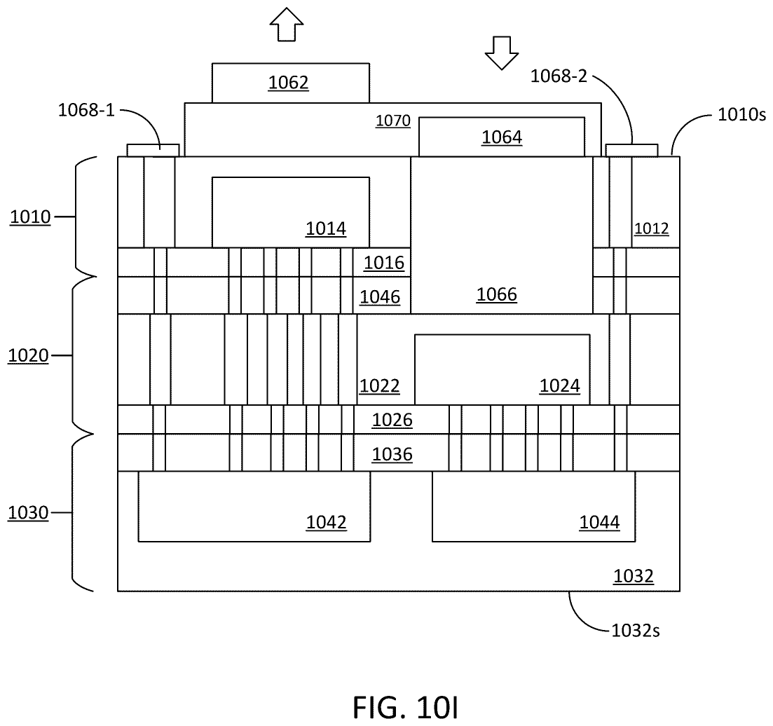

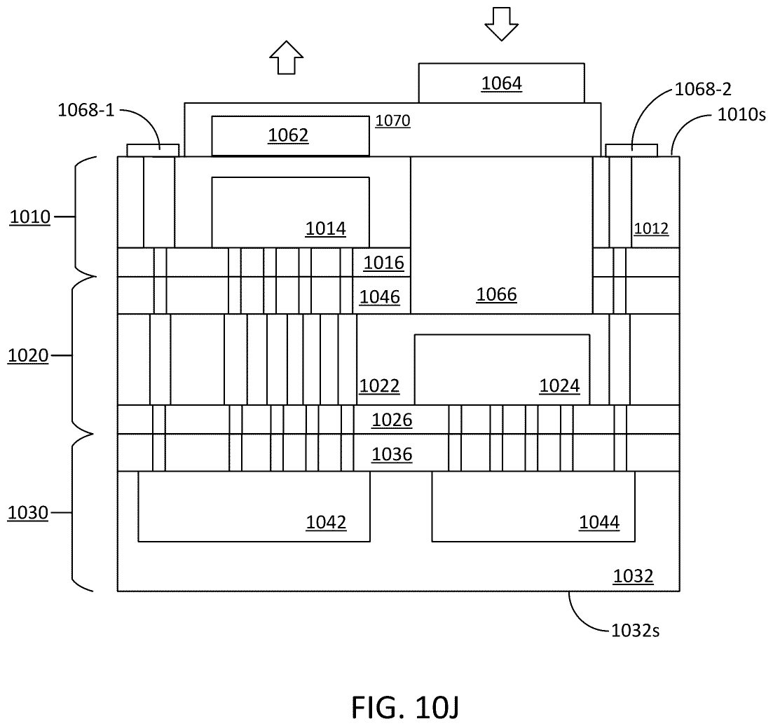

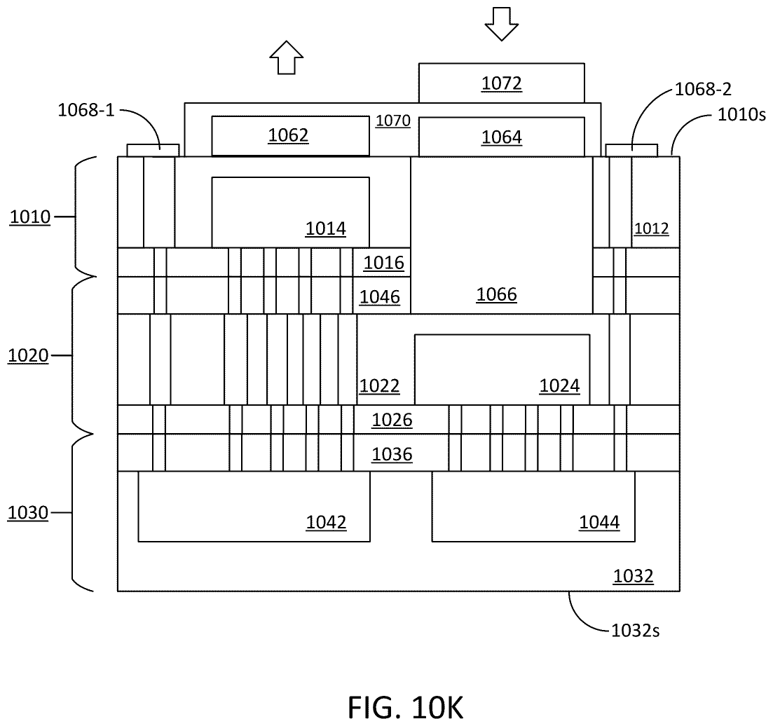

FIGS. 10A-10K describe a method for manufacturing an optical transceiver (e.g., the optical transceiver 120) by bonding an optical emitter chip 1010 (e.g., the optical-emitter chip 210), an optical receiver chip 1020 (e.g., the optical receiver chip 220 or the optical receiving chip 500), and a circuitry chip 1030 (e.g., the circuitry chip 230). Such manufacturing method can be performed on wafer-level or chip-level.

Referring to FIG. 10A, the optical emitter chip 1010 includes a substrate 1012 (e.g., silicon or glass or III-V material layers such as GaN or sapphire), one or more emitters 1014 (e.g., micro-LED, VCSEL, LED, etc.), and a hybrid-bond interface 1016. The hybrid-bond interface 1016 can include a dielectric layer (e.g., oxide) and electrical interconnects 1018-1 to 1018-n formed in the dielectric layer, where n is an integer. The optical receiver chip 1020 includes a substrate 1022 (e.g., silicon), one or more photodetectors 1024 (e.g., the silicon photodetectors described in reference to FIGS. 3A-3F, or the GeSi photodetectors described in reference to FIGS. 4A-4G), and a hybrid-bond interface 1026 that can include a dielectric layer and electrical interconnects 1028-1 to 1028-n formed in the dielectric layer. The circuitry chip 1030 includes a substrate 1032 (e.g., silicon), emitter circuitry 1042 (e.g., driver circuitry, clock circuitry, serializer, de-serializer, etc.), receiver circuitry 1044 (e.g., readout circuitry, TIA (transimpedance amplifier), serializer, de-serializer, etc.), and a hybrid-bond interface 1036 that can include a dielectric layer and electrical interconnects 1038-1 to 1038-n formed in the dielectric layer.

Referring to FIG. 10B, the circuitry chip 1030 can be hybrid-bonded to the optical receiver chip 1020 by bonding the hybrid-bond interfaces 1026 and 1036, with the electrical interconnects 1028-1 to 1028-n respectively bonded with (or connected to) the electrical interconnects 1038-1 to 1038-n. Referring to FIG. 10C, a hybrid-bond interface 1046 may be then formed on the other surface of the substrate 1022. The hybrid-bond interface 1046 includes electrical interconnects 1048-1 to 1048-n formed to provide electrical access to the emitter circuitry 1042 and the receiver circuitry 1044. Referring to FIG. 10D, the optical emitter chip 1010 may then be hybrid-bonded to the optical receiver chip 1020 by bonding the hybrid-bond interfaces 1016 and 1046, with the electrical interconnects 1018-1 to 1018-n respectively bonded with (or connected to) the electrical interconnects 1048-1 to 1048-n.

Referring to FIG. 10E, one or more openings 1040 may be formed (e.g., by etching) to provide optical access to the one or more photodetectors 1024. Although FIG. 10E shows that the etch stops at the substrate 1022, in some other implementations, the depth of the etched one or more openings 1040 may be controlled (e.g., etch stop at the hybrid-bond interface 1016, the hybrid-bond interface 1046, or the substrate 1022, etc.) based on design requirements. In addition, electrical interconnects 1058-1 to 1058-2 may also be formed to provide electrical access to the emitter circuitry 1042 and the receiver circuitry 1044. In some implementations, referring to FIG. 10F, the one or more openings 1040 may then be filled by oxide or other material(s) such as organic materials (e.g., polymers) 1066 that does not block the optical signal for planarization. Electrical contacts 1068-1 to 1068-2 (e.g., metal pads) may also be formed to provide electrical access to the emitter circuitry 1042 and the receiver circuitry 1044.

FIGS. 10G-10K describe examples of forming one or more optical elements 1062 (e.g., microlens or metalens) over the one or more emitters 1014, and forming one or more optical elements 1064 (e.g., microlens or metalens) over the one or more photodetectors 1024 to control light (e.g., focal length, spot size, numerical aperture, etc.) existing and entering the optical transceiver. A microlens can be, for example, a polymer or silicon (or any other suitable material or compound) structure with a curved (e.g., convex) profile that is formed by reflow or etching. A metalens can be, for example, a meta-surface formed by a plurality of subwavelength unit-cells (e.g., formed using silicon, oxide, Si:H, TiO₂, Ta₂O₅, Si₃N₄ or any other suitable material or combination of materials), where the shape and/or size of each unit-cell is determined locally based on the desired performance of the metalens. In some implementations, a number of microlenses or metalenses may correspond to a number of array elements in the one or more optical elements 1062 and the one or more photodetectors 1024. In some implementations, a number of microlens or metalens may correspond to a number of channels on the transmitter and receiver sides that are supported by the optical emitter chip 1010.

As an example, referring to FIG. 10G, the one or more optical elements 1062 (e.g., metalens) and the one or more optical elements 1064 (e.g., metalens) may be formed on a surface 1010s over the one or more emitters 1014 and the one or more photodetectors 1024. In some implementations, one or more properties (e.g., unit-cell patterns, unit-cell heights, unit-cell pitches, and/or focal length, etc.) of the one or more optical elements 1062 and the one or more optical elements 1064 may be different. In some implementations, a planarization layer 1070 may be formed over the one or more optical elements 1062 and the one or more optical elements 1064.

As another example, referring to FIG. 10H, a planarization layer 1070 may be formed on the surface 1010s over the one or more emitters 1014 and the one or more photodetectors 1024. The one or more optical elements 1062 (e.g., microlens) and the one or more optical elements 1064 (e.g., microlens) may then be formed on the planarization layer 1070. In some implementations, one or more properties (e.g., radius of curvature, lens diameter, lens height, and/or focal length, etc.) of the one or more optical elements 1062 and the one or more optical elements 1064 may be different.

As another example, referring to FIG. 10I, the one or more optical elements 1064 (e.g., metalens) may be formed on the surface 1010s over the one or more photodetectors 1024. A planarization layer 1070 may then be formed over the one or more optical elements 1064. The one or more optical elements 1062 (e.g., microlens) may then be formed on the planarization layer 1070 and over the one or more emitters 1014.

As another example, referring to FIG. 10J, the one or more optical elements 1062 (e.g., metalens) may be formed on the surface 1010s over the one or more emitters 1014. A planarization layer 1070 may then be formed over the one or more optical elements 1062. The one or more optical elements 1064 (e.g., microlens) may then be formed on the planarization layer 1070 and over the one or more photodetectors 1024.

As another example, referring to FIG. 10K, the one or more optical elements 1062 (e.g., metalens) and the one or more optical elements 1064 (e.g., metalens) may be formed on the surface 1010s over the one or more emitters 1014 and the one or more photodetectors 1024, respectively. A planarization layer 1070 may then be formed over the one or more optical elements 1062 and the one or more optical elements 1064. One or more optical elements 1072 (e.g., micro-lens) may then be formed on the planarization layer 1070 and over the one or more photodetectors 1024. This implementation has the technical advantage of further increasing the focal length, as the one or more photodetectors 1024 is further away from the surface 1010s than the one or more emitters 1014.

In some implementations, depending on the manufacturing requirements and/or the performance requirements, one or more other layers (e.g., planarization layers, cladding layers, etc.) may be formed on any one of the optical emitter chip 1010, the optical receiver chip 1020, and/or a circuitry chip 1030.

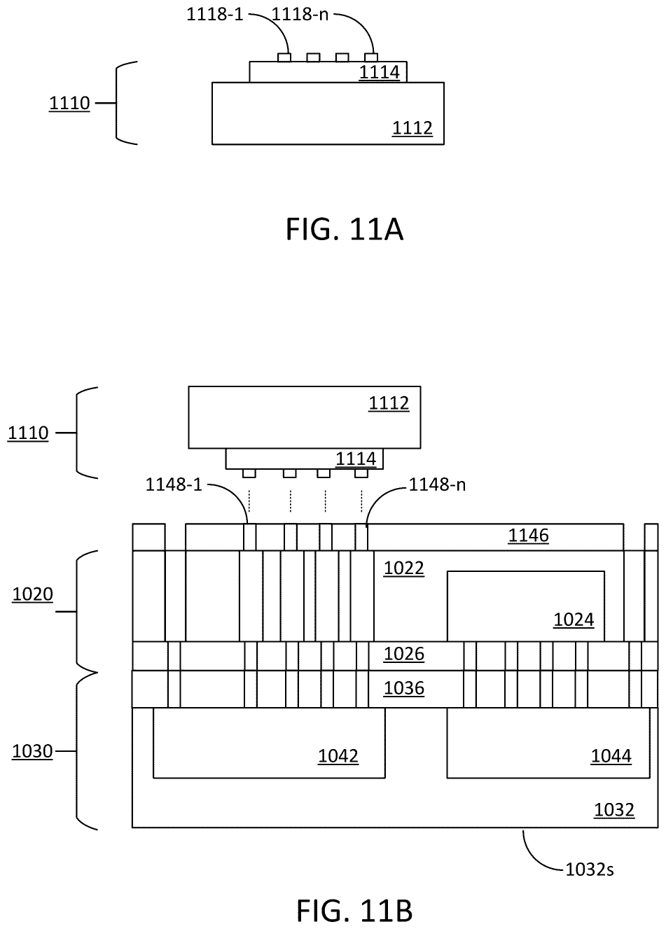

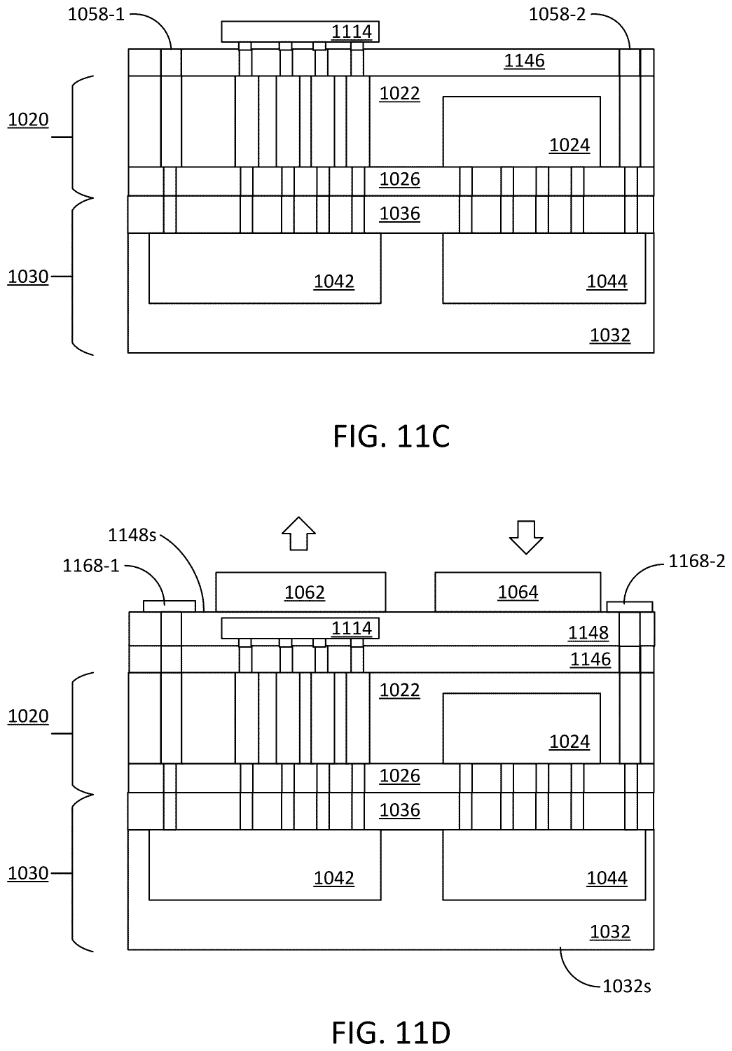

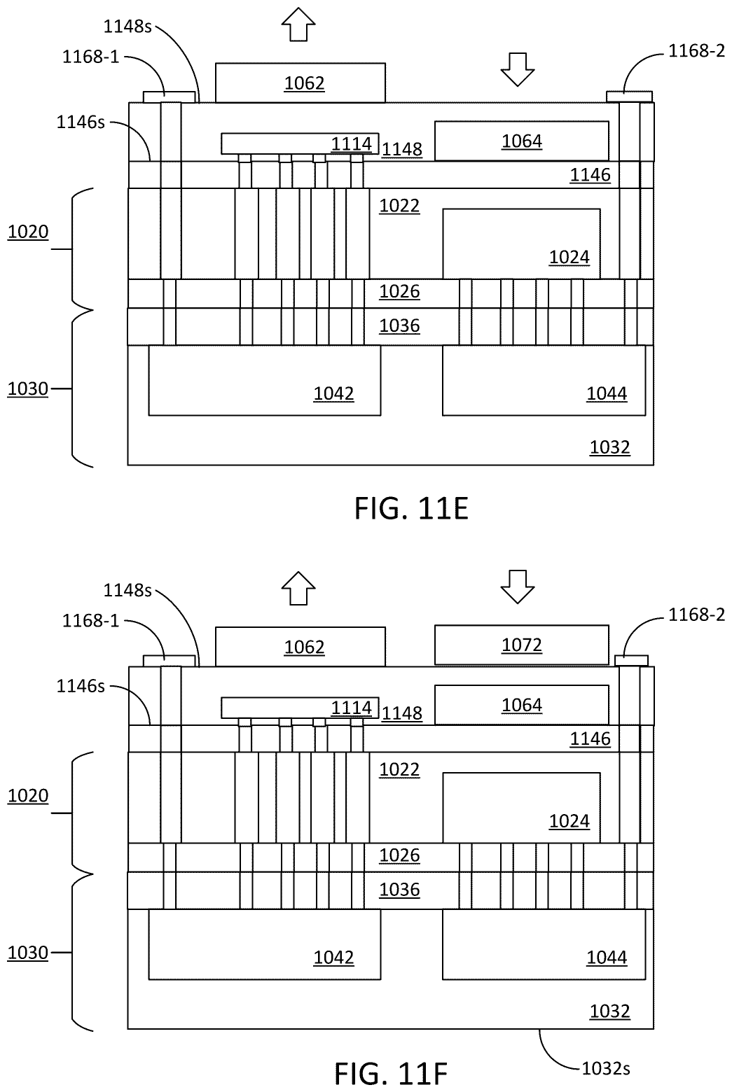

FIGS. 11A-11F describe another method for manufacturing an optical transceiver (e.g., the optical transceiver 120) by bonding an optical receiver chip 1020 (e.g., the optical receiver chip 220 or the optical receiving chip 500) to a circuitry chip 1030 (e.g., the circuitry chip 230) at the wafer level, and then bonding an optical emitter chip 1110 (e.g., the optical-emitter chip 210) using die-to-wafer bonding.

Referring to FIG. 11A, the optical emitter chip 1110 includes a die-level substrate 1112 (e.g., silicon or glass or III-V material layers such as GaN or sapphire), one or more emitters 1114 (e.g., micro-LED, VCSEL, LED, etc.) formed on the substrate 1112, and electrical interconnects 1118-1 to 1118-n, where n is an integer. Referring to FIG. 11B, after the optical receiver chip 1020 has been bonded (e.g., hybrid-bonded) to the circuitry chip 1030 at the wafer-level (described in reference to FIG. 10B), a bonding interface 1146 with electrical interconnects 1148-1 to 1148-n can be formed. The optical emitter chip 1110 can then be bonded to the bonding interface 1146 by flip-chip bond.

Referring to FIG. 11C, the substrate 1112 subsequently can be removed via laser lift-off (LLO) or other de-bonding techniques. In some implementations, electrical interconnects 1058-1 to 1058-2 may also be formed to provide electrical access to the emitter circuitry 1042 and the receiver circuitry 1044 either before or after the LLO or other debonding process.

FIGS. 11D-11G describe examples of forming one or more optical elements 1062 (e.g., microlens or metalens) over the one or more emitters 1114, and forming one or more optical elements 1064 (e.g., microlens or metalens) over the one or more photodetectors 1024 to control light (e.g., focal length, spot size, numerical aperture, etc.) existing and entering the optical transceiver.

As an example, referring to FIG. 11D, a planarization layer 1148 may be formed over the one or more emitters 1114 and the one or more photodetectors 1024. The one or more optical elements 1062 (e.g., microlens) and the one or more optical elements 1064 (e.g., microlens) may then be formed on the surface 1148s of the planarization layer 1148. In some implementations, one or more properties (e.g., radius of curvature, lens diameter, lens height, and/or focal length, etc.) of the one or more optical elements 1062 and the one or more optical elements 1064 may be different.

As another example, referring to FIG. 11E, the one or more optical elements 1064 (e.g., metalens) may be formed on the surface 1146s over the one or more photodetectors 1024. A planarization layer 1148 may then be formed over the one or more optical elements 1064. The one or more optical elements 1062 (e.g., microlens) may then be formed on the planarization layer 1148 and over the one or more emitters 1114.

As another example, referring to FIG. 11F, the one or more optical elements 1064 (e.g., metalens) may be formed on the surface 1146s over the one or more photodetectors 1024. A planarization layer 1148 may then be formed over the one or more optical elements 1064. One or more optical elements 1062 (e.g., microlens) and one or more optical elements 1072 (e.g., microlens) may then be formed on the planarization layer 1148 and over the one or more emitters 1114 and the one or more photodetectors 1024, respectively. This implementation has the technical advantage of further increasing the focal length, as the one or more photodetectors 1024 are further away from the surface 1148s than the one or more emitters 1114.

In some implementations, electrical contacts 1168-1 and 1168-2 (e.g., metal pads and metal interconnects underneath) may also be formed to provide electrical access to the emitter circuitry 1042 and the receiver circuitry 1044.

In some implementations, depending on the manufacturing requirements and/or the performance requirements, one or more other layers (e.g., planarization layers, cladding layers, etc.) may be formed on any one of the emitters 1114, the optical receiver chip 1020, and/or a circuitry chip 1030.

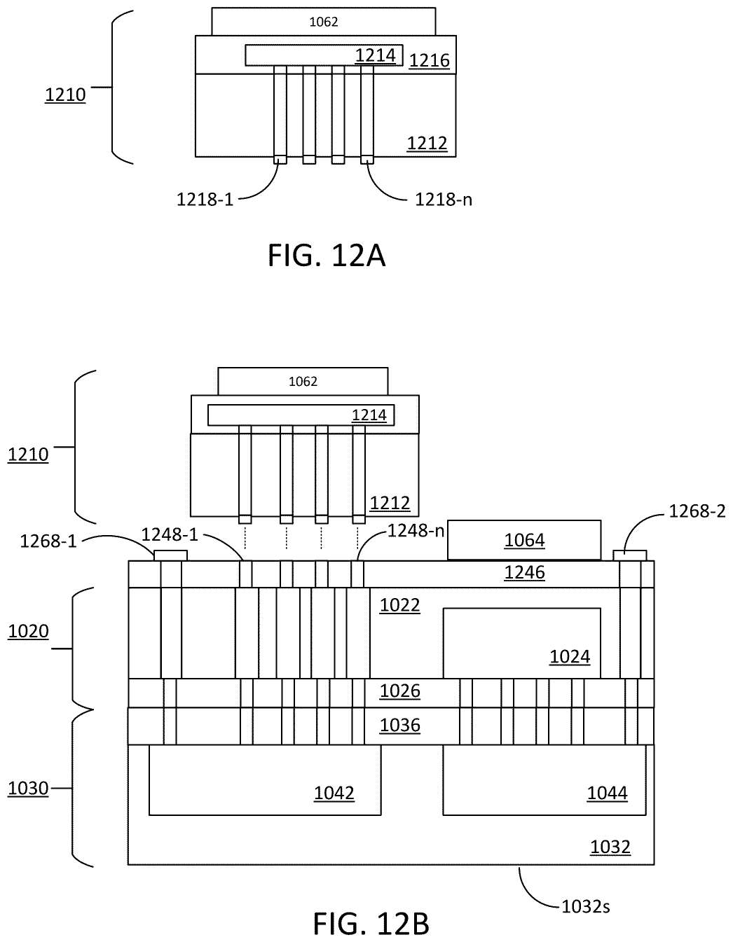

FIGS. 12A-12B describe another method for manufacturing an optical transceiver (e.g., the optical transceiver 120) by bonding an optical receiver chip 1020 (e.g., the optical receiver chip 220 or the optical receiving chip 500) to a circuitry chip 1030 (e.g., the circuitry chip 230) at the wafer level, and then bonding an optical emitter module 1210 (e.g., the optical-emitter chip 210) using module-to-wafer bonding. In some implementations, prior to the bonded wafer being diced, an optical emitter module 1210 (e.g., the optical-emitter chip 210) can then be bonded to form the optical transceiver by module-to-wafer bonding. In some other implementations, after the bonded wafer is diced, the optical emitter module 1210 (e.g., the optical-emitter chip 210) can then be bonded to form the optical transceiver by module-to-module bonding.

Referring to FIG. 12A, the optical emitter module 1210 includes a die-level substrate 1212 (e.g., silicon or glass or III-V material layers such as GaN or sapphire), one or more emitters 1214 (e.g., micro-LED, VCSEL, LED, etc.) bonded on the substrate 1212, and electrical interconnects 1218-1 to 1218-n (e.g., metal bumps), where n is an integer. In some implementation, a planarization layer 1216 may be formed on the substrate 1212 to protect the one or more emitters 1214. The optical emitter module 1210 further includes one or more optical elements 1062 (e.g., micro-lens or metalens) formed over the one or more emitters 1214. A size (e.g., an area) of the one or more optical elements 1062 can be greater than a size of the one or more emitters 1214, such that all of light from the one or more emitters 1214 can penetrate through the one or more optical elements 1062.

Referring to FIG. 12B, after the optical receiver chip 1020 has been bonded (e.g., hybrid-bonded) to the circuitry chip 1030 at the wafer-level (e.g., as described in reference to FIG. 10B), a bonding interface 1246 with electrical interconnects 1248-1 to 1248-n can be formed. The optical emitter module 1210 can then be bonded to the bonding interface 1246. In some implementations, the optical emitter module 1210 can then be bonded to the bonding interface 1246 at the wafer level prior to dicing. In some other implementations, the bonded wafer may be diced and packaged as a module, and the optical emitter module 1210 can then be bonded to the bonding interface 1246 at the module level.

In some implementations, the one or more optical elements 1064 (e.g., microlens or metalens) may be formed over the one or more photodetectors 1024 prior to bonding the optical emitter module 1210 to the bonding interface 1246. In some other implementations, the one or more optical elements 1064 (e.g., microlens or metalens) may be formed over the one or more photodetectors 1024 after bonding the optical emitter module 1210 to the bonding interface 1246.

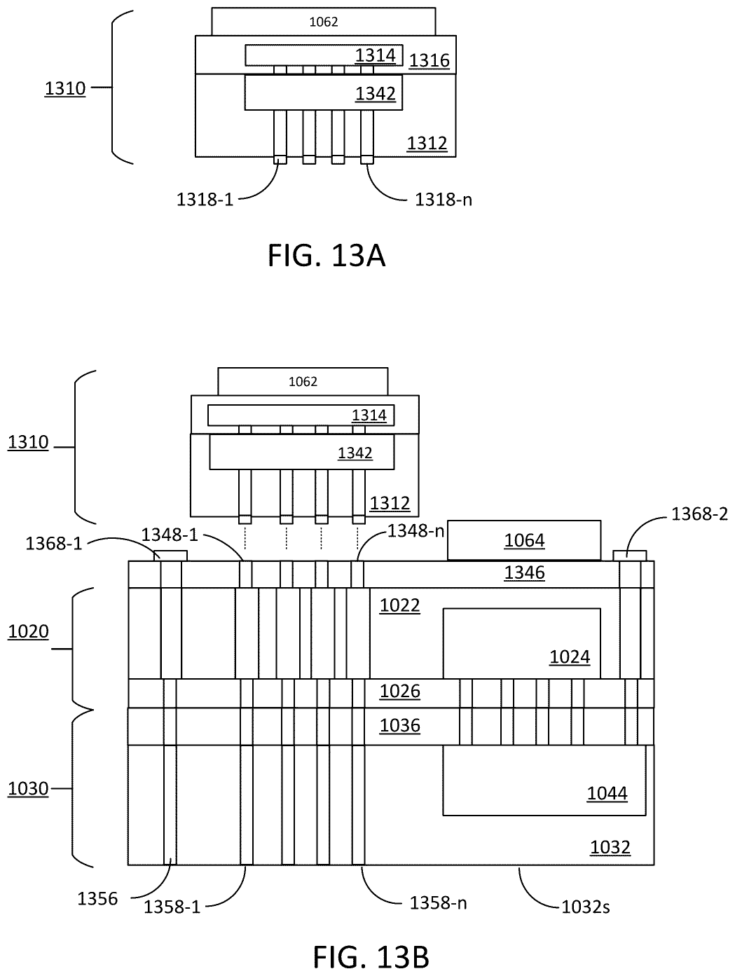

In some implementations, an optical emitter module can include an emitter with driving circuitry packaged with an optical element (e.g., microlens or metalens). FIGS. 13A-13B describe another method for manufacturing an optical transceiver (e.g., the optical transceiver 120) by bonding an optical receiver chip 1020 (e.g., the optical receiver chip 220 or the optical receiving chip 500) to a circuitry chip 1030 (e.g., the circuitry chip 230) at the wafer level. In some implementations, prior to the bonded wafer being diced, an optical emitter module 1310 (e.g., the optical-emitter chip 210) can then be bonded to form the optical transceiver by module-to-wafer bonding. In some other implementations, after the bonded wafer is diced, the optical emitter module 1310 (e.g., the optical-emitter chip 210) can then be bonded to form the optical transceiver by module-to-module bonding.

Referring to FIG. 13A, the optical emitter module 1310 includes a die-level substrate 1312 (e.g., silicon or glass or III-V material layers such as GaN or sapphire), one or more emitters 1314 (e.g., micro-LED, VCSEL, LED, etc.) bonded on the substrate 1312, and electrical interconnects 1318-1 to 1318-n (e.g., metal bumps), where n is an integer. In some implementation, a planarization layer 1316 may be formed on the substrate 1312 to protect the one or more emitters 1314. The optical emitter module 1310 can further include one or more optical elements 1062 (e.g., micro-lens or metalens) formed over the one or more emitters 1314. Different from the optical emitter module 1210, the optical emitter module 1310 further includes an emitter circuitry 1342 (e.g., functionally same or similar to the emitter circuitry 1042) formed in the substrate 1312.

Referring to FIG. 13B, after the optical receiver chip 1020 has been bonded (e.g., hybrid-bonded) to the circuitry chip 1030 at the wafer-level (e.g., as described in reference to FIG. 10B), a bonding interface 1346 with electrical interconnects 1348-1 to 1348-n can be formed. In some implementations, the optical emitter module 1310 can then be bonded to the bonding interface 1346 at the wafer level prior to dicing. In some other implementations, the bonded wafer may be diced and packaged as a module, and the optical emitter module 1310 can then be bonded to the bonding interface 1346 at the module level.

Here, the emitter circuitry 1042 is implemented as the emitter circuitry 1342 formed in the optical emitter module 1310. Through-silicon-vias (TSV) 1356 and 1358-1 to 1358-n can be formed in the substrate 1032 to provide electrical access to the optical emitter module 1310.

In some implementations, the one or more optical elements 1064 (e.g., microlens or metalens) may be formed over the one or more photodetectors 1024 prior to bonding the optical emitter module 1310 to the bonding interface 1246. In some other implementations, the one or more optical elements 1064 (e.g., microlens or metalens) may be formed over the one or more photodetectors 1024 after bonding the optical emitter module 1310 to the bonding interface 1346.

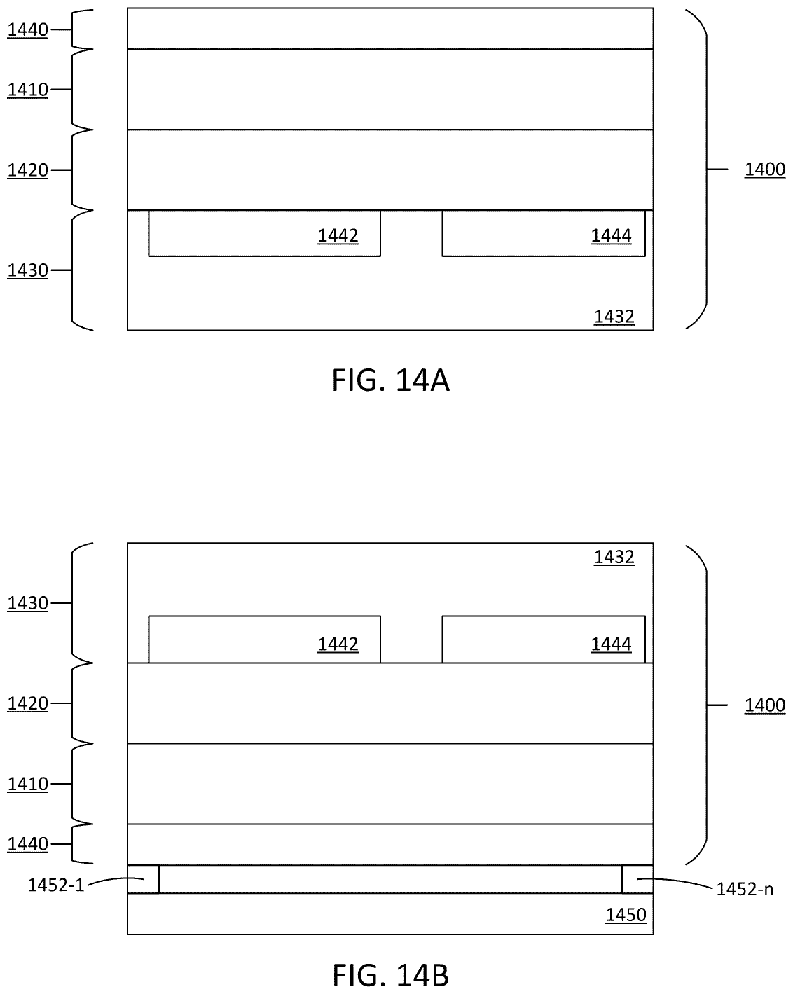

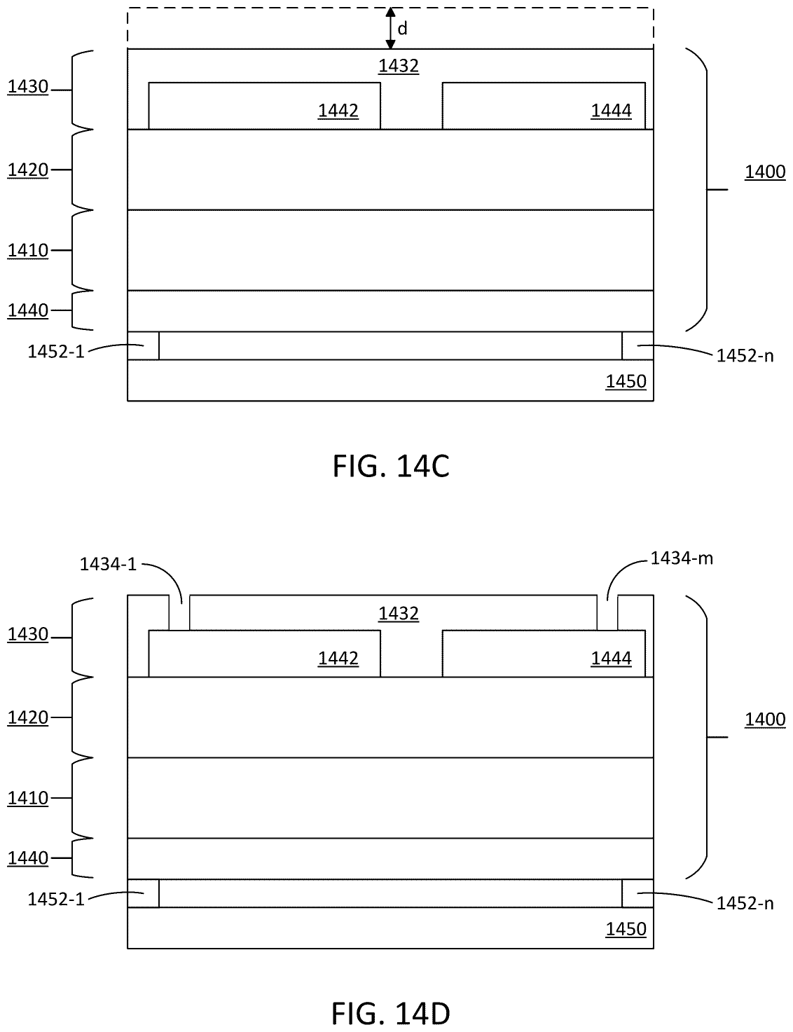

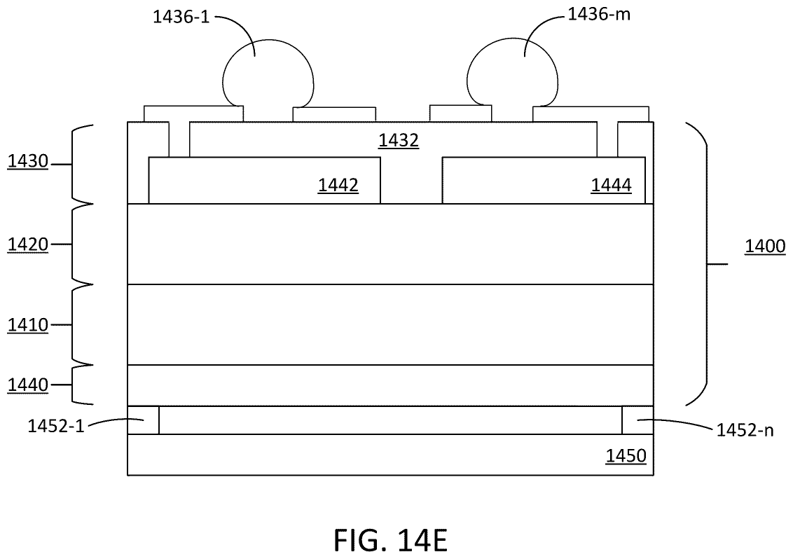

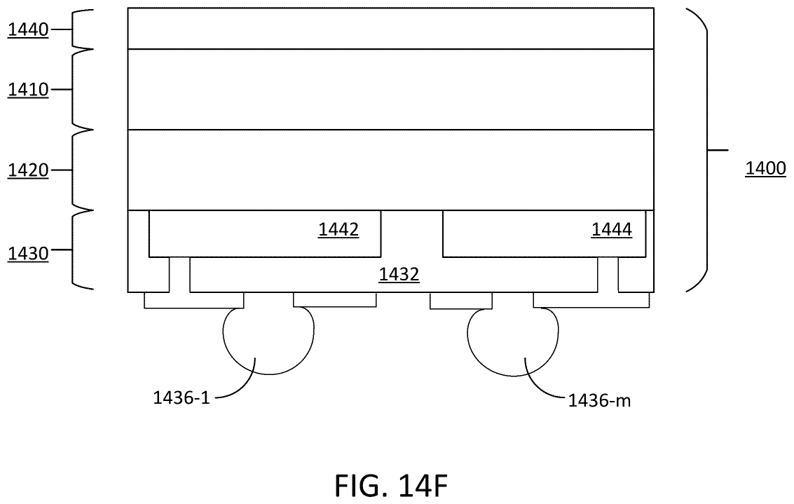

As described in reference to FIGS. 10A-10K, 11A-11F, 12A-12B, and 13A-13B, the emitter circuitry 1042 and the receiver circuitry 1044 can be electrically accessed on the same side as where the optical signals are to be transmitted and received (e.g., through electrical contacts 1068-1/1068-2/1168-1/1168-2/1268-1/1268-2/1368-1/1368-2). In other implementations, circuitry such as the emitter circuitry 1042 and the receiver circuitry 1044 can be electrically accessed from the opposite side where the optical signals are to be transmitted and received (e.g., side 1032s). This configuration has the technical advantage of allowing an optical transceiver to be bonded to a substrate (e.g., the board 130, the MCM substrate 140, the interposer 150, the processor 160, or the memory 180), which can enable more compact packaging and/or more compact electrical connections to the optical transceiver. FIGS. 14A-14F describe a method for manufacturing metal bumps on optical transceivers at wafer-level using wafer-level chip-scale packaging (WLCSP).

Referring to FIG. 14A, an optical transceiver wafer 1400 includes an optical emitter chip layer 1410 (e.g., the optical-emitter chip 1010 or the optical-emitter chip 1110 after LLO or other de-bonding technique, or the optical-emitter module 1210/1310), an optical receiver chip layer 1420 (e.g., the optical receiver chip 1020), a circuitry chip layer 1430 (e.g., the circuitry chip 1020), and an optical element layer 1440 (e.g., one or more optical elements 1062 and/or 1064 and/or 1072) are formed (e.g., formed by any of the methods as described in reference to FIGS. 10A-10K, 11A-11F, 12A-12B, and 13A-13B). The circuitry chip layer 1430 includes a substrate 1432 (e.g., Si substrate), emitter circuitry 1442 (e.g., emitter circuitry 1042 having driver circuitry, clock circuitry, serializer, de-serializer, and/or other circuitry for driving the optical emitter chip 1410), and receiver circuitry 1444 (e.g., receiver circuitry 1044 having readout circuitry, TIA, serializer, de-serializer, and/or other circuitry for driving the optical emitter chip 1420).

Referring to FIG. 14B, the optical element layer 1440 of the optical transceiver wafer 1400 is bonded to a carrier wafer 1450. In some implementations, the carrier wafer 1450 may be a glass wafer or a silicon wafer. In some implementations, if the optical element layer 1440 is not planarized (e.g., if microlens are formed on the surface), the optical transceiver wafer 1400 may be bonded to the carrier wafer 1450 using lithographically defined adhesive dam structures 1452-1 to 1452-n to ensure that the optical elements are not damaged by the bonding process.

Referring to FIG. 14C, in some implementations, the circuitry chip layer 1430 may be thinned (e.g., through polishing, grinding, etc.) by a thickness d. Referring to FIG. 14D, in some implementations, through-silicon-vias (TSV) 1434-1 to 1434-m (m is an integer greater than 1) can then be formed using an etching process (e.g., dry etch), where the TSV 1434-1 to 1434-m provide electrical access to the emitter circuitry 1442 and the receiver circuitry 1444 (e.g., to a specific metal layer of the circuitry). Referring to FIG. 14E, in some implementations, backside bumps (e.g., micro solder balls) 1436-1 to 1436-m can then be formed using a wafer-level bump-formation process (e.g., a redistribution layer (RDL) packaging process), where the backside bumps 1436-1 to 1436-m provide electrical access to the emitter circuitry 1442 and/or the receiver circuitry 1444.

Referring to FIG. 14F, in some implementation, after the backside bump formation, the bonding between the optical transceiver wafer 1400 and the carrier wafer 1450 may be removed (e.g., through heating or through wet-chemistry), and individual optical transceiver with backside bumps may be diced. The backside bumps may then be bonded to a substrate (e.g., the board 130, the MCM substrate 140, the interposer 150, the processor 160, or the memory 180). In some other implementations, after the backside bump formation, the optical transceiver wafer 1400 may be diced, and then the bonding between an individual optical transceiver and the diced carrier substrate may be removed, followed by bonding the backside bumps to a substrate.

For the various implementations of optical transceivers (e.g., example optical transceivers described in FIGS. 10A-10K, 11A-11F, 12A-12B, 13A-13B) described herein, an optical receiver chip is described as being bonded to a circuit chip, and an optical emitter chip is described as being bonded to the optical receiver chip. It should be understood that in some other implementations, an optical transceiver may be formed by bonding an optical emitter chip to a circuit chip, and then bonding an optical receiver chip to the optical emitter chip using processes as described throughout the present disclosure. Moreover, such transceivers may be used in implementing optical links (e.g., example optical links described in FIGS. 2A-2B or FIG. 7) and computing systems (e.g., example computing systems described in FIGS. 1A-1G) described throughout the disclosure.

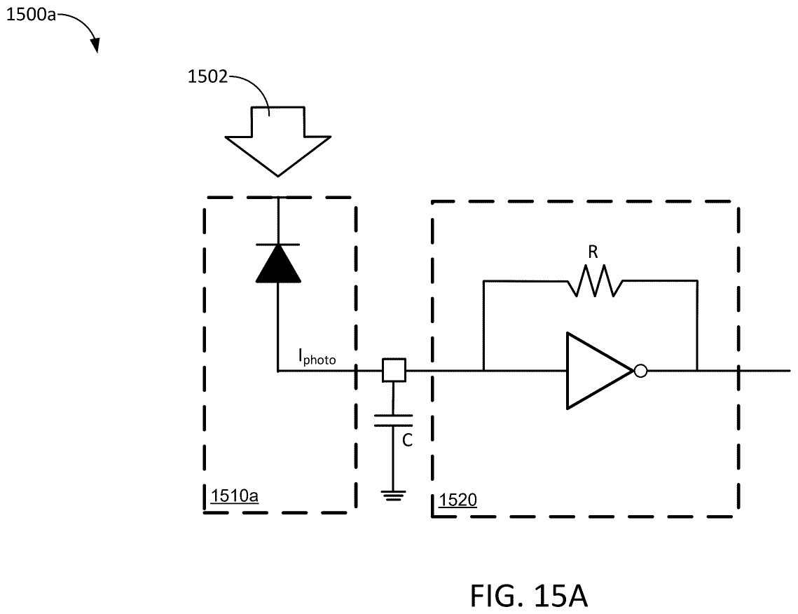

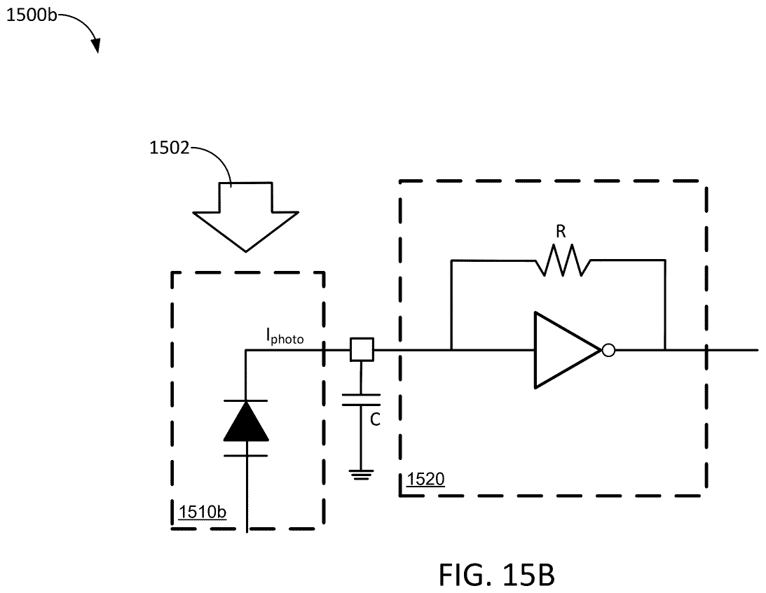

FIG. 15A illustrates an example equivalent circuit 1500a of an optical receiver (e.g., any of the photodetector coupled to a circuitry chip as described in reference to the figures herein). A photodetector (e.g., any of the photodetector described in reference to FIGS. 3A-3H, 4A-4G, 5A-5B, 6, and 17) may be represented by a photodiode 1510a in the equivalent circuit 1500a. Upon receiving an optical signal 1502, the photodiode 1510a generates an electrical current (e.g., 1 A/W, or any suitable responsivity that can be generated with appropriate design and/or operating bias). In some implementations, the equivalent circuit 1500a further includes an amplifier circuitry 1520 (e.g., a transimpedance amplifier (TIA)) configured to convert the input current to a voltage by an amplification factor (e.g., by a factor of 10, 20, etc.). The photodiode 1510a and the amplifier circuitry 1520 may be electrically coupled by wafer-to-wafer bonding (e.g., hybrid-bond). Advantageously for high-speed applications, with wafer-to-wafer bonding, a capacitance of the equivalent circuit 1500a may be on the order of tens of femto-farad, as opposed to wire bonding, where capacitance can be a magnitude or more higher due to longer wire and larger bonding pads.

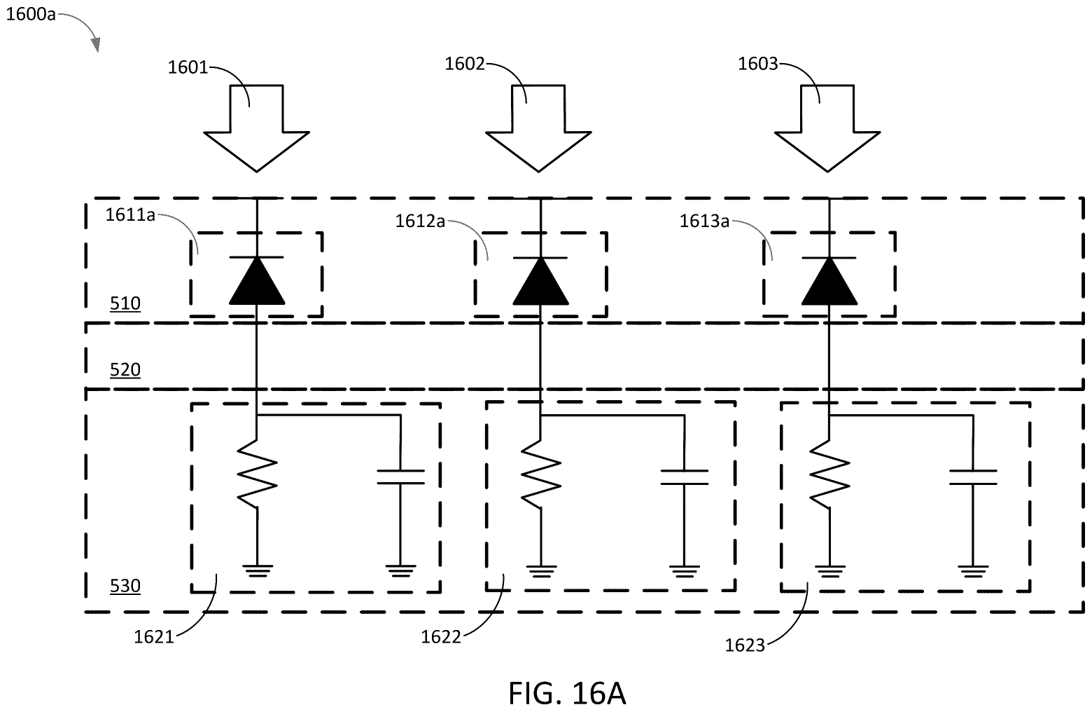

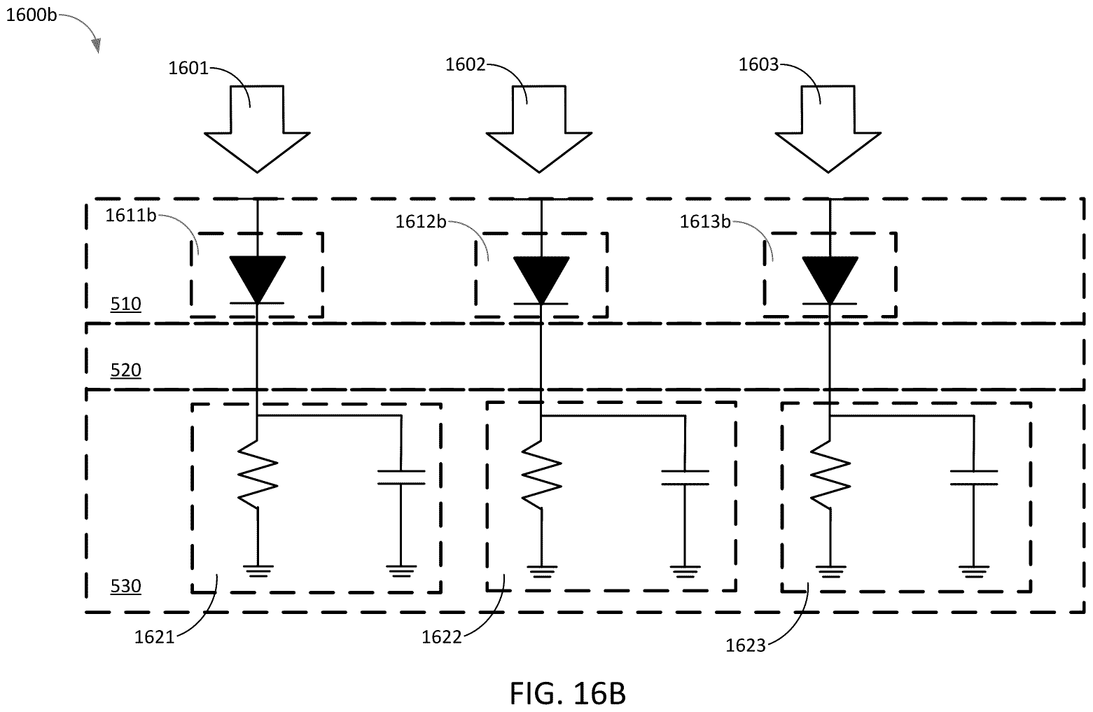

As an example, assuming a photodiode responsivity of 1 A/W and an input optical signal of 100 μW, the photodiode 1510a can generate a photocurrent Iₚₕₒₜₒ of 100 μA in response to detecting the optical signal. Assuming the amplifier circuitry 1520 has an amplification factor of 2000, a voltage swing of around 200 mV may be generated at the output of the amplifier circuitry 1520. In some implementations, if multiple photodetectors are electrically binned to form a subset (e.g., subsets 502, 504, and 506 in reference to FIG. 5A), an amplifier circuitry 1520 may be implemented for each subset. For example, if four photodetectors each having a dimension of 10 μm×10 μm are electrically binned to form one large photodetector on a first wafer, an amplifier circuitry 1520 may be implemented using an area of 20 μm×20 μm on a second wafer to be bonded with the first wafer. In some implementations, an amplifier circuit 1520 such as a TIA may require more area on a chip to implement, and therefore may limit the channel-count scaling for photodetectors that can fit within a chip. For certain applications, an amplifier circuitry (e.g., TIA) may not be required, and the channel number of sensors that can fit within a chip can be further scaled. Referring to FIG. 16A as an example equivalent circuit 1600a for FIG. 5B, each of the photodetectors 511, 512, and 513 may be represented by a photodiode 1611a, 1612a, and 1613a, respectively. Upon receiving an optical signal 1601/1602/1603, the photodiode 1611a/1612a/1613a generates an electrical current (e.g., 1 A/W) to circuitry 1621/1622/1623, respectively. Assuming a photodiode responsivity of 1 A/W, a resistor of 2000 Ohm, and an input optical signal of 100 μW, a voltage swing of around 200 mV (i.e., 100 μA×2000 ohm) may be generated by the circuitry 1621/1622/1623, which may be sufficient for a reliable detection. Since an amplifier circuitry is not required here, the area of circuitry can be designed to match the area of the photodetector (e.g., 10 μm by 10 μm), and the number of channels that can fit within a chip can be further increased accordingly.

FIG. 15A and FIG. 16A illustrate example equivalent circuits where holes are provided as electrical signals to the circuitry (e.g., circuitry 1520, or circuitry 1621/1622/1623). In some other implementations, electrons may be provided as electrical signals to the circuitry, as illustrated by example equivalent circuits in FIG. 15B and FIG. 16B. FIG. 15B illustrates an example equivalent circuit 1500b of an optical receiver (e.g., any of the photodetector coupled to a circuitry chip as described in reference to the figures herein). A photodetector (e.g., any of the photodetector described in reference to FIGS. 3A-3H, 4A-4C, 5A-5B, 6, and 17) may be represented by a photodiode 1510b in the equivalent circuit 1500b. Upon receiving an optical signal 1502, the photodiode 1510b generates an electrical current (e.g., 1 A/W, or any suitable responsivity that can be generated with appropriate design and/or operating bias). In some implementations, the equivalent circuit 1500b further includes an amplifier circuitry 1520 (e.g., a TIA) configured to convert the input current to a voltage by an amplification factor (e.g., by a factor of 10, 20, etc.). The photodiode 1510b and the amplifier circuitry 1520 may be electrically coupled by wafer-to-wafer bonding (e.g., hybrid-bond). Referring to FIG. 16B as an example equivalent circuit 1600b for FIG. 5B, each of the photodetectors 511, 512, and 513 may be represented by a photodiode 1611b, 1612b, and 1613b, respectively. Upon receiving an optical signal 1601/1602/1603, the photodiode 1611b/1612b/1613b generates an electrical current (e.g., 1 A/W) to circuitry 1621/1622/1623, respectively.

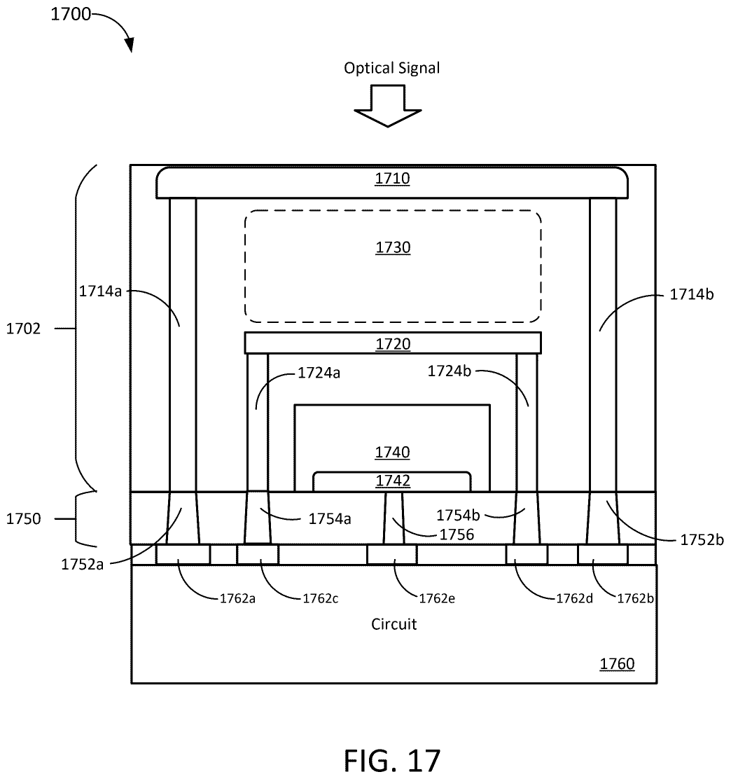

FIG. 17 (shown as the back-side-incident cross-section view) shows an example photodetector 1700 that can be configured to detect an optical signal in the visible, the NIR wavelength range, and the SWIR wavelength range. The photodetector 1700 may be operated as a PD or an APD under different voltage biases. The photodetector 1700 includes a silicon layer 1702. The silicon layer 1702 includes a p-doped region 1710. In some implementations, the doping concentration of the p-doped region 1710 is highly-doped (e.g., in the range of >10¹⁹ cm⁻³). The silicon layer 1702 further includes an n-doped region 1720. In some implementations, the doping concentration of the n-doped region 1720 is highly-doped (e.g., in the range of >10¹⁹ cm⁻³).

In some implementations, the silicon layer 1702 further includes a first absorption region 1730 formed between the p-doped region 1710 and the n-doped region 1720, where the first absorption region 1730 is configured to absorb an optical signal in the visible and/or the NIR wavelength range. In some implementations, the doping concentration of the first absorption region 1730 is intrinsic (e.g., undoped or with a background doping) or lightly-doped (e.g., in the range of <10¹⁷ cm⁻³).

In some implementations, the silicon layer 1702 further includes a second absorption region 1740 (e.g., a trench filled with a second material such as germanium, or silicon-germanium) that can detect an optical signal in the visible, the NIR wavelength range, and/or the SWIR wavelength range. By forming the second absorption region 1740 (e.g., through etching and deposition), the thickness of the silicon layer 1702 can be reduced to a thickness that is thick enough to partially convert the optical signal into an electrical signal in the first absorption region 1730 and the second absorption region 1740, while thin enough to sufficiently sustain the optical or electrical bandwidth for operating the photodetector 1700. As an example, a thickness of the p-doped region 1710, the n-doped region 1720, and the first absorption region 1730 together can be smaller than 500 nm, 1 μm, 1.5 μm, 2 μm, or any other appropriate thinness for an operation wavelength.

In some implementations, the photodetector 1700 further includes a cladding layer 1750 formed using a dielectric material (e.g., oxide) and conductive regions 1752a, 1752b, 1754a, 1754b, and 1756 (e.g., metal). Conductive regions 1752a, 1752b, 1754a, and 1754b in the cladding layer 1750 are connected to conductive regions 1714a, 1714b, 1724a, and 1724b (e.g., metal or doped semiconductor) respectively in the silicon layer 1702 for providing the photocarriers absorbed and/or amplified in the silicon region 1702 to an external circuitry. The photodetector 1700 may be bonded to a circuit chip 1760 (e.g., circuit chip 230) using hybrid-bonding, where electrical connections may be formed through conductive regions 1762a-1762e (e.g., metal).

In some implementations, the second absorption region 1740 may be p-doped. In some implementations, the doping concentration of the second absorption region 1740 may be moderately-doped (e.g., in the range of <10¹⁸ cm⁻³). In some implementations, one or more regions in the second absorption region 1740 may be highly-doped with a p-type dopant (e.g., in the range of >10¹⁹ cm⁻³). For example, the second absorption region 1740 may be formed with germanium, and the germanium region may include a first highly-p-doped region 1742 that is electrically coupled to the conductive region 1756.

In some implementations, during operation of the photodetector 1700, the p-doped region 1710, the n-doped region 1720, and the second absorption region 1740 may be separately biased. As an example, the p-doped region 1710 and the n-doped region 1720 may be operated under a reverse bias close to a breakdown voltage, where an avalanche region (e.g., a region that causes avalanche breakdown) is formed in the first absorption region 1730. When an optical signal enters the photodetector 1700, depending on the wavelength of the optical signal, the optical signal can be at least partially or entirely absorbed in the first absorption region 1730, where the holes generated by the first absorption region 1730 are drifted to and collected by the p-doped region 1710. The electrons generated by the light absorbed in the first absorption region 1730 are amplified by the first absorption region 1730, and the amplified electrons are collected by the n-doped region 1720. Moreover, the n-doped region 1720 and the second absorption region 1740 may be operated under a reverse bias below a breakdown voltage, and any light that has not been absorbed by the first absorption region 1730 may be absorbed by the second absorption region 1740, where the generated holes may be collected by the first highly-p-doped region 1742, and the generated electrons may be drifted to and collected by the n-doped region 1720.

In some implementations, while the p-doped region 1710 and the n-doped region 1720 operate as an APD, the n-doped region 1720 and the second absorption region 1740 may be electrically shorted (e.g., by electrically shorting conductive regions 1762d and 1762c, or 1762c and 1762e, or a combination of thereof). Here, the photodetector 1700 is configured to operate as a silicon APD for detecting visible and NIR light.

In some cases, during a device fabrication process, there may be possible process variations or gradient of devices (e.g., light sources and/or detectors) across a wafer. Such process variations (e.g., thickness variations, doping variations, etching variations, etc.) may affect certain characteristics of the devices such as device timing skews and/or slicer thresholds. Accordingly, it may be beneficial to distribute the clock signals across various regions of an array, such that the distributed clock signals can be used as a localized reference to reduce any variation of device signal characteristics.

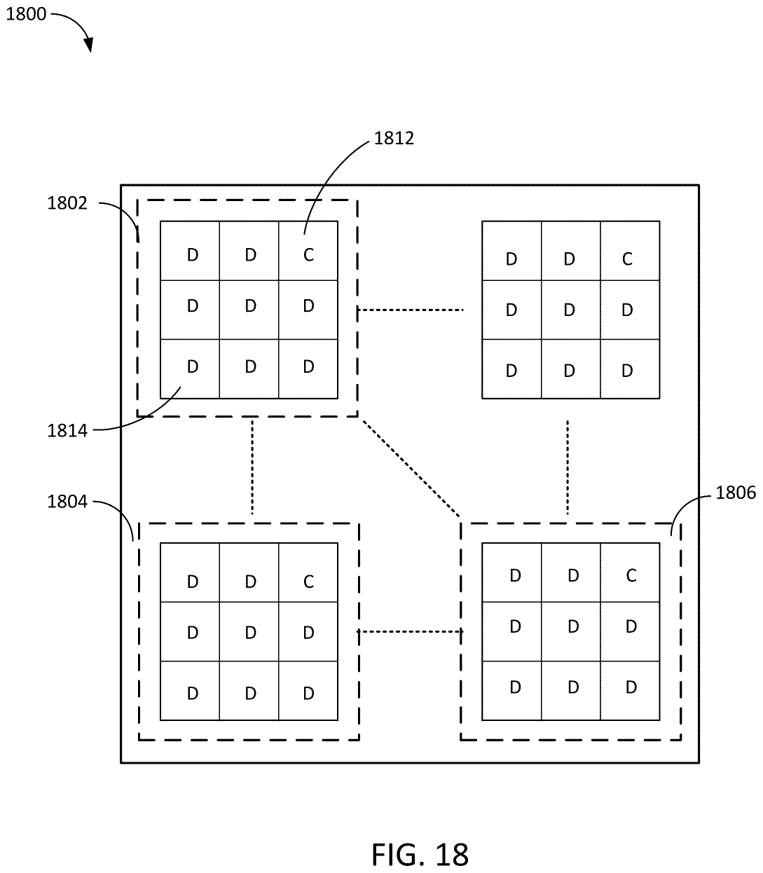

FIG. 18 illustrates an example optical receiving chip 1800 having a two-dimensional array of photodetectors (e.g., any of the photodetectors described throughout this disclosure). The optical receiving chip 1800 can be same as or similar to the optical receiver chip 220 or the optical receiving chip 500, or any other optical receiver chip as described in the present disclosure. The optical receiving chip 1800 is configured to receive optical signals (e.g., data signals and clock signals) from an optical transmitter (e.g., any of the optical transmitters described throughout this disclosure) via a fiber array unit (e.g., any of the fiber array units described throughout this disclosure). In some implementations, the photodetector array of the optical receiving chip 1800 may be logically divided into multiple sub-regions including sub-regions 1802, 1804, and 1806. The division may be based on parameters such as the degree of performance variations based on process variations, the size of the array, etc. Each sub-region may include a photodetector (e.g., photodetector 1812) configured to receive a clock signal and multiple photodetectors (e.g., photodetector 1814) configured to receive data signals. In some implementations, the clock signal locally received in a sub-region may be used to synchronize the data signals received in the same sub-region.

To facilitate compatibility across multiple computing elements or systems, a computing system may be configured to communicate with another computing system through a standard electrical interface. Such electrical interfaces have predefined standards (e.g., transmission rates and encoding schemes). As an example, two computing systems may communicate with each other using the PCIe (Peripheral Component Interconnect Express) interface or the Ethernet interface. Under PCIe 5.0, each lane can transfer data at a rate of 32 Gbps over the non-return-to-zero (NRZ) encoding scheme, whereas under PCIe 6.0, each lane can transfer data at a rate of 64 Gbps over the pulse-amplitude-modulation 4-level (PAM4) encoding scheme. Under 400G Ethernet, each lane can transfer data at a rate of 56 Gbps over the PAM4 encoding scheme. A transfer rate and/or an encoding scheme of an optical interface may be different from that of the electrical interface. Accordingly, it would be technically advantageous to implement an optical transceiver that can adapt to an electrical interface having a different transfer rate and/or an encoding scheme.

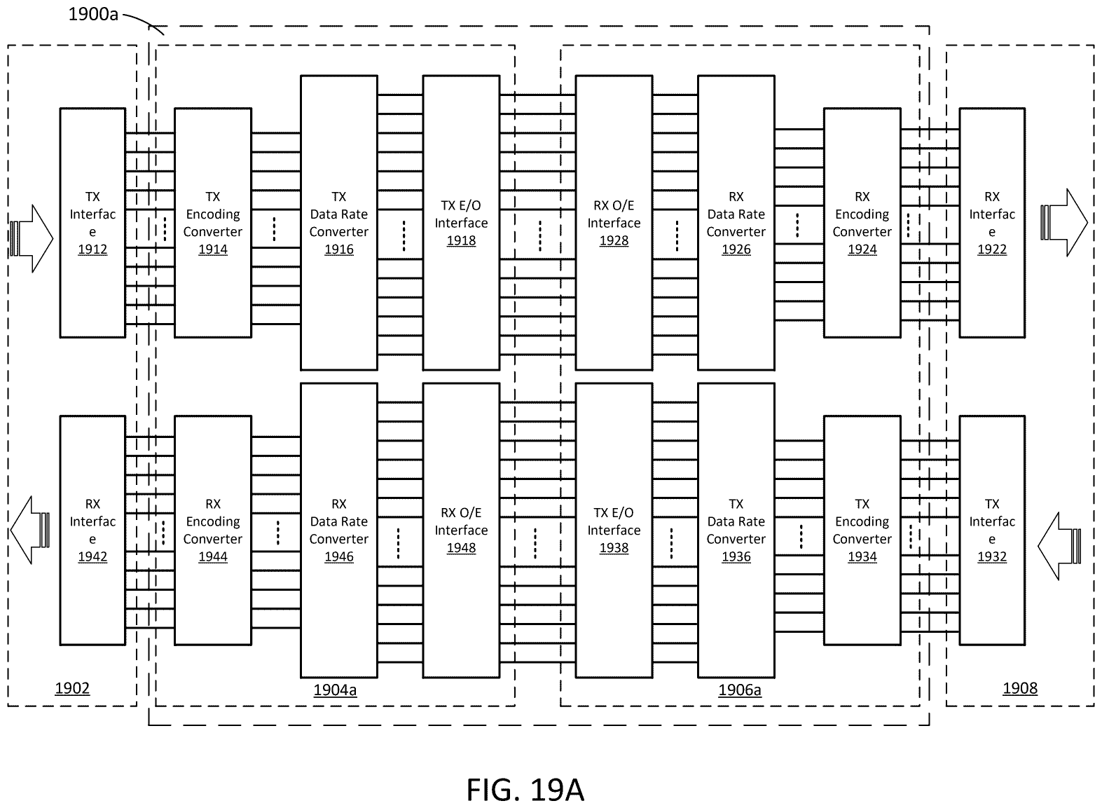

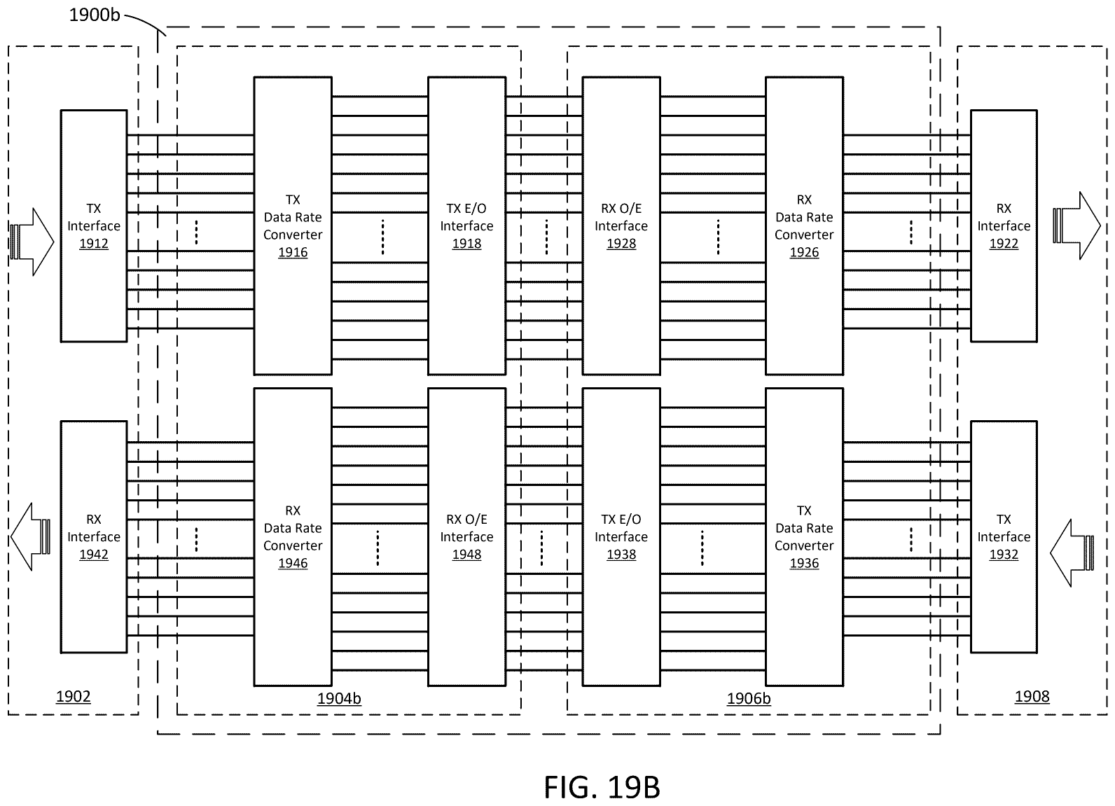

FIG. 19A illustrates an example data transmission between two transceiver interfaces 1902 and 1908 via an optical interconnect 1900a, where the encoding scheme and the per-lane transmission rate associated with the two transceiver interfaces 1902 and 1908 are different from those of the optical transceivers 1904a and 1906a in the optical interconnect 1900a. Each of the transceiver interfaces 1902 and 1908 may be configured to receive, from a processor or memory element (e.g., CPU, GPU, cache, HBM, etc.), data to be transferred to another processor or memory element.

In some implementations, the transceiver interface 1902 includes a first TX interface 1912 configured to transmit data from a first processor/memory element to a second processor/memory element, and a first RX interface 1942 configured to receive data from the second processor/memory element to the first processor/memory element. Similarly, the transceiver interface 1908 includes a second TX interface 1932 configured to transmit data from the second processor/memory element to the first processor/memory element, and a second RX interface 1922 configured to receive data from the first processor/memory element to the second processor/memory element. In some implementations, the transceiver interfaces 1902 and 1908 may be implemented to transmit and receive data using a standard interface such as the PCIe (Peripheral Component Interconnect Express) interface, the Ethernet interface, or any other suitable standard interface. Here, each of the transceiver interfaces 1902 and 1908 is configured to transmit or receive data at a transmission rate of R Gbps with a first encoding scheme over L number of lanes. As an example, each of the transceiver interfaces 1902 and 1908 may transmit or receive data at a transmission rate of 64 Gbps (i.e., 32 GBd) with a PAM4 encoding scheme over 16 lanes, resulting in a total transmission rate of 1,024 Gbps in each direction. With the PAM 4 encoding scheme, each lane may transmit data at a transmission rate of 64 Gbps in each direction.

In some implementations, the optical interconnect 1900a includes a first optical transceiver 1904a and a second optical transceiver 1906a, e.g., the optical transceiver 120 as described in the present disclosure. The first optical transceiver 1904a is electrically coupled to the first transceiver interface 1902, and includes a first TX encoding converter 1914, a first TX data rate converter 1916, a first TX E/O interface 1918, a first RX encoding converter 1944, a first RX data rate converter 1946, and a first RX O/E interface 1948. Similarly, the second optical transceiver 1906a is electrically coupled to the second transceiver interfaces 1908, and includes a second TX encoding converter 1934, a second TX data rate converter 1936, a second TX E/O interface 1938, a second RX encoding converter 1924, a second RX data rate converter 1926, and a second RX O/E interface 1928. The first optical transceiver 1904a is optically coupled to the and second optical transceiver 1906a via an optical medium such as an optical fiber array (e.g., fiber array unit 170).

The first TX encoding converter 1914 is configured to receive first electrical data having a first encoding scheme from the first TX interface 1912, and convert the first electrical data having the first encoding scheme into second electrical data having a second encoding scheme. For example, the first TX encoding converter 1914 may be configured to convert first electrical data in a PAM4 encoding into second electrical data in a NRZ encoding scheme. In some examples, if the transceiver interface 1902 is configured to transmit first electrical data at a transmission rate of 32 GBd with a PAM4 encoding scheme over 16 lanes, the first TX encoding converter 1914 may be configured to convert the first electrical data into second electrical data at a transmission rate of 32 Gbps with a NRZ encoding scheme over 32 lanes (i.e., 2×16 lanes). In some implementations, the first TX encoding converter 1914 may include one or more analog-to-digital (ADC) circuits, where each ADC circuit receives a PAM4 signal, and provides multi-digit NRZ outputs (e.g., two lanes of high and/or low signals representing “00”, “01”, “10”, “11”) based on a comparison between an amplitude of the PAM4 signal and preset thresholds for the multi-digit outputs.

The first TX data rate converter 1916 is configured to receive second electrical data having the second encoding scheme from the first TX encoding converter 1914, and convert the second electrical data into third electrical data having a different data rate. For example, the second electrical data may have a transmission rate of 32 Gbps with a NRZ encoding scheme over 32 lanes, and the first TX data rate converter 1916 may be configured to convert the second electrical data into third electrical data having a transmission rate of 4 Gbps with a NRZ encoding scheme over 256 lanes (i.e., 8×32 lanes). The converted lower data rate can be used to modulate optical sources for parallel data transmissions across multiple channels. In some implementations, the first TX data rate converter 1916 includes one or more deserializers that receive the second electrical data having a higher data rate and a fewer lane count, and deserialize the second electrical data to provide third electrical data having a lower data rate and a higher lane count.

The first TX E/O interface 1918 is configured to receive the third electrical data from the first TX data rate converter 1916, and output first optical signals that includes optical data representing the third electrical data. In some implementations, the first TX E/O interface 1918 includes an optical emitter chip or module (e.g., any of the optical emitter chip or optical emitter module described in this disclosure) having multiple light sources (e.g., micro-LED, VCSEL, LED, etc. in the visible or NIR or SWIR wavelength range) configured to emit the first optical signals in parallel to the optical medium (e.g., fiber array unit 170). As an example, the first TX E/O interface 1918 may receive the third electrical data having a transmission rate of 4 Gbps with a NRZ encoding scheme over 256 lanes from the first TX data rate converter 1916. The third electrical data may be used to modulate a micro-LED array or a VCSEL array having 256 light sources, such that the first TX E/O interface 1918 may output 256 optical signals having a transmission rate of 4 Gbps with a NRZ encoding scheme to a fiber array having 256 corresponding optical fibers. Accordingly, the first TX E/O interface 1918 may output an optical data with an aggregated rate of 1,024 Gbps that corresponds to the first electrical data (at a transmission rate of 64 Gbps with a PAM4 encoding scheme over 16 lanes) provided by the TX interface 1912. In some implementations, the first optical signals further include one or more clock signals.

The second RX O/E interface 1928 is configured to receive the first optical signals from the first TX E/O interface 1918, and output fourth electrical data that corresponds to the third electrical data. In some implementations, the second RX O/E interface 1928 includes an optical receiver chip or module (e.g., any of the optical receiver chip or optical receiver module described in this disclosure) having multiple photodetectors (e.g., array photodetectors for the visible or NIR or SWIR wavelength range as described throughout this disclosure). The photodetectors are configured to receive the first optical signals, and output the fourth electrical data based on the received optical signals. As an example, the second RX O/E interface 1928 may receive 256 optical signals from a fiber array, where the optical signals carry data with a transmission rate of 4 Gbps with a NRZ encoding scheme. The photodetector array then converts the received data into the fourth electrical data having a transmission rate of 4 Gbps with a NRZ encoding scheme over 256 lanes (e.g., electrical wires).

The second RX data rate converter 1926 is configured to receive the fourth electrical data having the first encoding scheme from the second RX O/E interface 1928, and convert the fourth electrical data into fifth electrical data having a different data rate. For example, the fourth electrical data may have a transmission rate of 4 Gbps with a NRZ encoding scheme over 256 lanes, and the second RX data rate converter 1926 may be configured to convert the fourth electrical data into the sixth electrical data having a transmission rate of 32 Gbps with a NRZ encoding scheme over 32 lanes. In some implementations, the second RX data rate converter 1926 includes one or more serializers that receive the fourth electrical data having a lower data rate and a higher lane count, and serialize the fourth electrical data to provide the fifth electrical data having a higher data rate and a lower lane count.

The second RX encoding converter 1924 is configured to receive the fifth electrical data having the second encoding scheme from the second RX data rate converter 1926, and convert the fifth electrical data having the second encoding scheme into sixth electrical data having the first encoding scheme. For example, the second RX encoding converter 1924 may be configured to convert fifth electrical data in a NRZ encoding into sixth electrical data in a PAM4 encoding. In some examples, if the second RX data rate converter 1926 is configured to transmit fifth electrical data at a transmission rate of 32 Gbps with a NRZ encoding scheme over 32 lanes, the second RX encoding converter 1924 can be configured convert the fifth electrical data to output the sixth electrical data at a transmission rate of 32 GBd with a PAM4 encoding scheme over 16 lanes. In some implementations, the second RX encoding converter 1924 may include one or more digital-to-analog (DAC) circuits, where each DAC circuit receives two NRZ signals, and provides a PAM4 output (e.g., one lane of a PAM4-encoded signal representing “00”, “01”, “10”, “11”) based on the amplitudes of the two NRZ signals.

The second RX interface 1922 is configured to receive the sixth electrical data from the second RX encoding converter 1924 and transfer the sixth electrical data to the second processor/memory element. Notably, the data received by the second RX interface 1922 has the same transmission rate with the same encoding scheme over the same number of lanes as the data transmitted by the first TX interface 1912, regardless of the implementations of the optical interconnect 1900a.

In some implementations, the two transceiver interfaces 1902 and 1908 can be configured to provide bidirectional data exchanges. Here, data provided from the second processor/memory element can be sent to the first processor/memory element by transmitting the data from the second TX interface 1932 to the first RX interface 1942. The second TX encoding converter 1934, the second TX data rate converter 1936, the second TX E/O interface 1938, the first RX O/E interface 1948, the first RX data rate converter 1946, and the first RX encoding converter 1944 can be implemented similar to the first TX encoding converter 1914, the first TX data rate converter 1916, the first TX E/O interface 1918, the second RX O/E interface 1928, the second RX data rate converter 1926, and the second RX encoding converter 1924, respectively.

In some implementations, the first TX encoding converter 1914, the first TX data rate converter 1916, the first RX encoding converter 1944, and the first RX data rate converter 1946 may be implemented as circuitry on the same chip (e.g., a part of the circuitry chip 230). Similarly, the second TX encoding converter 1934, the second TX data rate converter 1936, the second RX encoding converter 1924, and the second RX data rate converter 1926 may be implemented as circuitry on the same chip (e.g., a part of the circuitry chip 230). In some other implementations, the first TX encoding converter 1914 and the first RX encoding converter 1944 may be implemented as circuitry on one chip, and the first TX data rate converter 1916 and the first RX data rate converter 1946 may be implemented as circuitry on a different chip. Similarly, the second TX encoding converter 1934 and the second RX encoding converter 1924 may be implemented as circuitry on one chip, and the second TX data rate converter 1936 and the second RX data rate converter 1926 may be implemented as circuitry on a different chip.

FIG. 19B illustrates another example data transmission between two transceiver interfaces 1902 and 1908 via an optical interconnect 1900b, where the encoding scheme associated with the two transceiver interfaces 1902 and 1908 are the same as those of the optical transceivers 1904b and 1906b in the optical interconnect 1900b (e.g., NRZ), but the per-lane transmission rate associated with the two transceiver interfaces 1902 and 1908 (e.g., 32 Gbps) are different from that of the optical transceivers 1904b and 1906b (e.g., 4 Gbps).

The optical interconnect 1900b includes a first optical transceiver 1904b and a second optical transceiver 1906b. The first optical transceiver 1904b is electrically coupled to the first transceiver interface 1902, and includes a first TX data rate converter 1916, a first TX E/O interface 1918, a first RX data rate converter 1946, and a first RX O/E interface 1948. Similarly, the second optical transceiver 1906b is electrically coupled to the second transceiver interfaces 1908, and includes a second TX data rate converter 1936, a second TX E/O interface 1938, a second RX data rate converter 1926, and a second RX O/E interface 1928. The first optical transceiver 1904b is optically coupled to the second optical transceiver 1906b via an optical medium such as an optical fiber array (e.g., fiber array unit 170).

Here, the first TX data rate converter 1916 is configured to receive first electrical data having a first encoding scheme from the first TX interface 1912, and convert the first electrical data into second electrical data having a different data rate. For examples, if the transceiver interface 1902 is configured to transmit first electrical data at a transmission rate of 32 Gbps with a NRZ encoding scheme over 32 lanes, the first TX data rate converter 1916 may be configured to convert the first electrical data into third electrical data having a transmission rate of 4 Gbps with a NRZ encoding scheme over 256 lanes (i.e., 8×32 lanes). The converted lower data rate can be used to modulate optical sources for parallel data transmissions across multiple channels.

The first TX E/O interface 1918 is configured to receive the second electrical data from the first TX data rate converter 1916, and output first optical signals that includes optical data representing the second electrical data. As an example, the first TX E/O interface 1918 may receive the second electrical data having a transmission rate of 4 Gbps with a NRZ encoding scheme over 256 lanes from the first TX data rate converter 1916. The second electrical data may be used to modulate a micro-LED array or a VCSEL array having 256 light sources, such that the first TX E/O interface 1918 may output 256 optical signals having a transmission rate of 4 Gbps with a NRZ encoding scheme to a fiber array having 256 corresponding optical fibers. Accordingly, the first TX E/O interface 1918 may output an optical data with an aggregated rate of 1,024 Gbps that corresponds to the first electrical data (at a transmission rate of 32 Gbps with a NRZ encoding scheme over 32 lanes) provided by the TX interface 1912. In some implementations, the first optical signals further include one or more clock signals.

The second RX O/E interface 1928 is configured to receive the first optical signals from the first TX E/O interface 1918, and output third electrical data that corresponds to the second electrical data. The second RX data rate converter 1926 is configured to receive the third electrical data, and convert the third electrical data into fourth electrical data having a different data rate to the second RX interface 1922. Accordingly, the data received by the second RX interface 1922 has the same transmission rate with the same encoding scheme over the same number of lanes as the data transmitted by the first TX interface 1912, regardless of the implementations of the optical interconnect 1900b.

In some implementations, the two transceiver interfaces 1902 and 1908 can be configured to provide bidirectional data exchanges. Here, data provided from the second processor/memory element can be sent to the first processor/memory element by transmitting the data from the second TX interface 1932 to the first RX interface 1942. The second TX data rate converter 1936, the second TX E/O interface 1938, the first RX O/E interface 1948, and the first RX data rate converter 1946 can be implemented similar to the first TX data rate converter 1916, the first TX E/O interface 1918, the second RX O/E interface 1928, and the second RX data rate converter 1926, respectively.

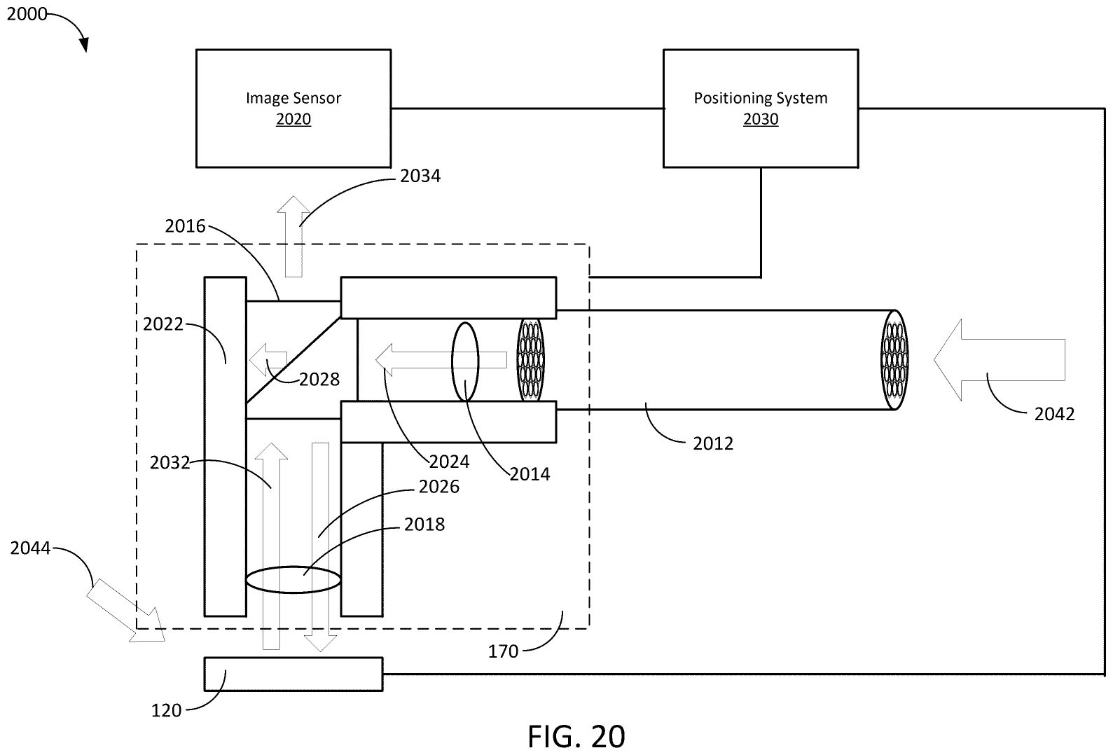

FIG. 20 illustrates an example of an alignment system 2000 for an optical link. As described in reference to previous figures (e.g., FIGS. 1A-1G), the optical link 110 includes an optical transceiver 120 and a fiber array unit 170, where the optical transceiver 120 and the fiber array unit 170 may be packaged (e.g., using epoxy or other adhesives) for mechanical and thermal stability. It is critical that the array-based optical transceiver and optical fiber array are optically aligned after being packaged to reduce intra-channel optical loss and inter-channel optical crosstalk.

Referring to FIG. 20, the alignment system 2000 includes an image sensor 2020 and a positioning system 2030. The image sensor 2020 may be a camera that is configured to detect light in the desirable wavelength range(s) (e.g., visible and/or NIR and/or SWIR), and is configured to capture a magnified or unmagnified image of the optical transceiver 120. In some implementations, the image sensor 2020 may be configured to provide electrical outputs that represent the captured images.

The positioning system 2030 is configured to control an optical alignment between the fiber array unit 170 and the optical transceiver 120 by controlling relative linear (e.g., x, y, or z direction) and/or angular positions between the fiber array unit 170 and the optical transceiver 120. The positioning system 2030 may include one or more processors, a first stage for holding the fiber array unit 170, a second stage for holding the optical transceiver 120, and one or more controllers for moving the first stage and/or the second stage. The one or more controllers may be a combination of manual, motorized, or piezoelectric actuators that can move the first stage and/or the second stage linearly and/or angularly. The positioning system 2030 may be configured to receive electrical outputs from the image sensor 2020, and determine a linear and/or angular movement for the first stage and/or the second stage based on an optical alignment between the fiber array unit 170 and the optical transceiver 120.

Referring to FIG. 20, in some implementations, the fiber array unit 170 includes one or more fiber arrays 2012 (e.g., fiber array 272/274/276/280/290), a first optical element 2014, a beam splitter 2016, a second optical element 2018, and a holder 2022. In some implementations, the first optical element 2014 may include a collimating lens, where one end of the one or more fiber arrays 2012 and the first optical element 2014 are held by the holder 2022 with a separation corresponding to a focal length of the collimating lens. Accordingly, optical signals 2024 exiting the one or more fiber arrays 2012 are collimated after passing through the first optical element 2014. The beam splitter 2016 is held by the holder 2022, and is arranged to receive the optical signals 2024 and to split the optical signals 2024 into optical signals 2026 and optical signals 2028. The beam splitter 2016 can be designed as a 99/1 splitter (i.e., 99% of the split power is in the optical signal 2026, and 1% of the split power is in the optical signal 2028), a 90/10 splitter, or any suitable splitting ratio. The holder 2022 may include an optical absorption material to absorb the optical signal 2028.

In some implementations, the second optical element 2018 may include a collimating/focusing lens, where the second optical element 2018 is held by the holder 2022, and is positioned to be about a focal length from the optical transceiver 120. The optical signals 2026 are focused by the second optical element 2018 onto the optical transceiver 120, where the reflected optical signals 2032 are collimated by the second optical element 2018 and the split reflected optical signals 2034 enter the image sensor 2020. Accordingly, the image sensor 2020 may capture images showing how the one or more fiber arrays 2012 are optically aligned with the optical transceiver 120. In some implementations, the illumination of the one or more fiber arrays 2012 is through a visible, NIR and/or SWIR source from the edge surface of the one or more fiber arrays 2012 (e.g., light 2042). In some implementations, the illumination of the optical transceiver 120 is through a visible, NIR, and/or SWIR source from the lateral side of the optical transceiver 120 (e.g., light 2044).

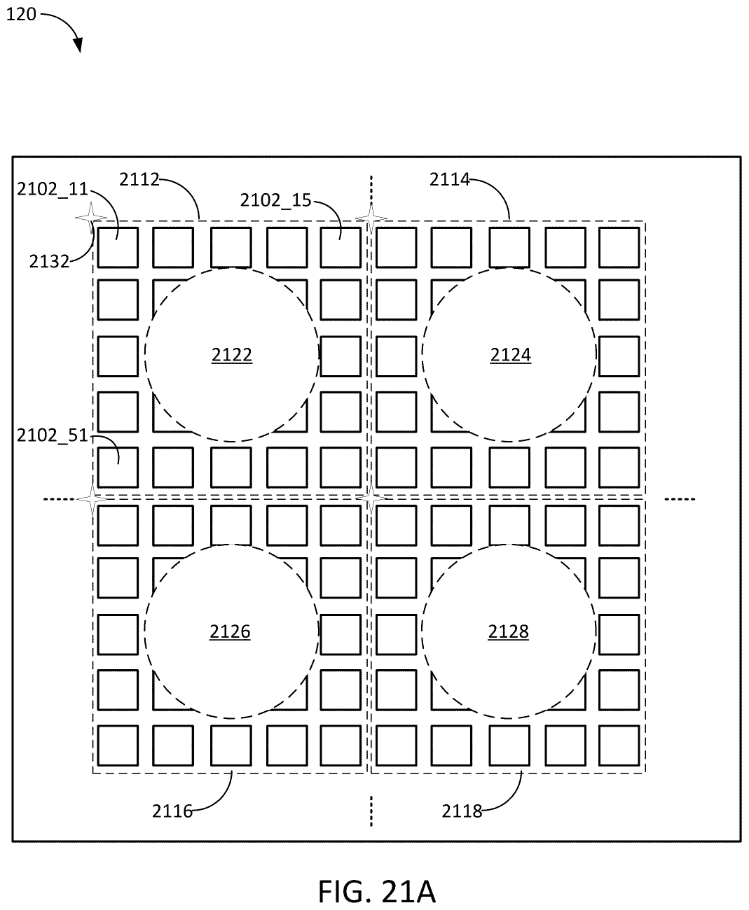

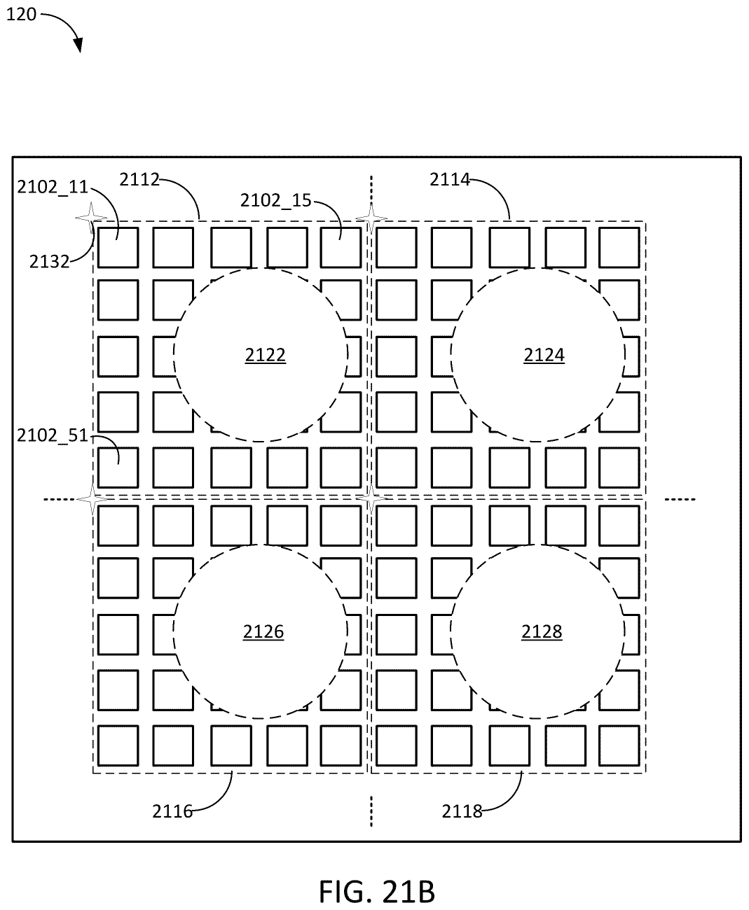

As an example, FIG. 21A shows an example optical alignment between the one or more fiber arrays 2012 and the optical transceiver 120 as captured by the image sensor 2020. In some implementations, the optical transceiver 120 includes a two-dimensional array of photodetectors (e.g., photodetectors 2102_11, 2102_15, 2102_51, etc.). The multiple photodetectors may be divided into different groups for receiving optical signals from different fibers. For example, the multiple photodetectors of the optical transceiver 120 may include four groups of 5-by-5 pixels 2112, 2114, 2116, and 2118, each configured to receive optical signals from one of four fibers of the one or more fiber arrays 2012, respectively. In some implementations, each group may include an alignment mark (e.g., alignment mark 2132) to indicate an identification of a group and/or the boundary of a group. In this example, the spots 2122, 2124, 2126, and 2128 represent reflected optical signals 2034 (in reference to FIG. 20) captured by the image sensor 2020. The positioning system 2030 may determine one or more properties associated with the captured image (e.g., relative position between the pixels/alignment marks and the spots 2122, 2124, 2126, and 2128, the spot size of the spots 2122, 2124, 2126, and 2128, etc.), and determine (e.g., using image analysis, machine-learned model, etc.) a linear and/or angular movement for the first stage and/or the second stage based on one or more properties.

FIG. 21B shows another example optical alignment between the one or more fiber arrays 2012 and the optical transceiver 120 as captured by the image sensor 2020, where the fiber array 2012 is misaligned from the optical transceiver 120. Here, the positioning system 2030 may determine that there is a linear offset of 20 μm between the alignment mark 2132 and the spot 2122. In response to such determination, the positioning system 2030 may then issue a control signal to move the first stage (holding the fiber array unit 170) for 20 μm and then continue with the alignment monitoring.

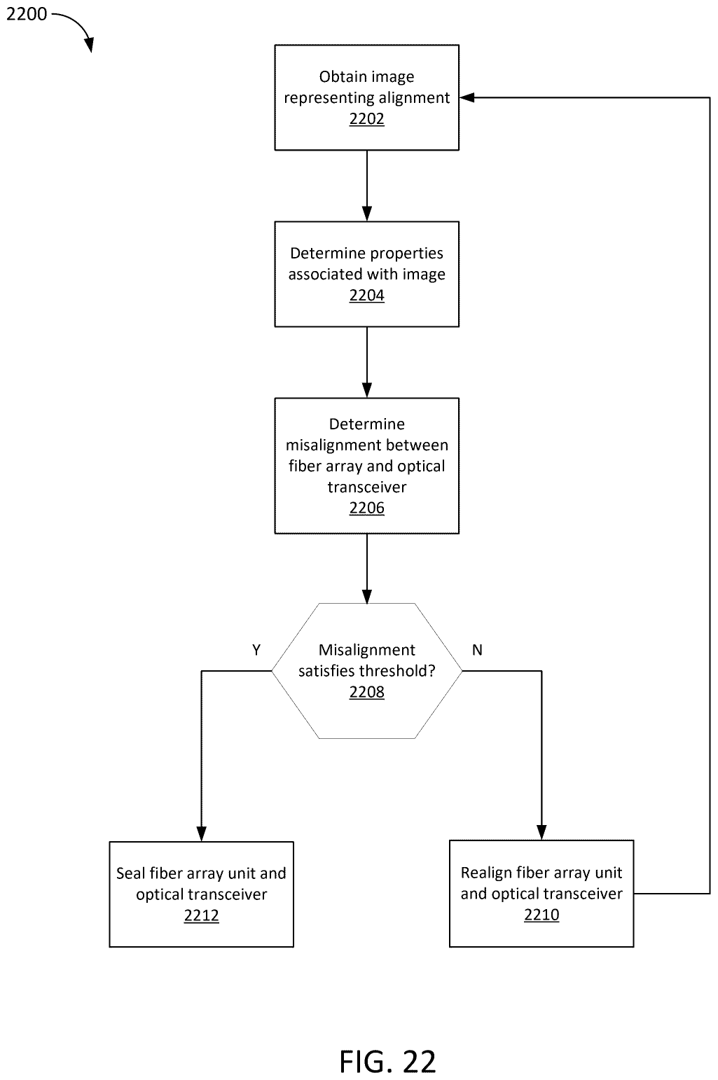

FIG. 22 illustrates an example flowchart of a process 2200 for an optical alignment. The process 2200 may be implemented using a system such as the alignment system described in reference to FIG. 20 and FIGS. 21A-21B. Note that although FIGS. 20, 21A, 21B, and 22 describe an optical alignment between an optical fiber array and an optical transceiver, such optical alignment system and process can also apply to (i) an optical alignment between an optical fiber array and an optical transmitter and/or (ii) an optical alignment between an optical fiber array and an optical receiver. In addition, the optical transceiver (or transmitter or receiver) here may be a die, or a chiplet bonded to a substrate.

At 2202, the system obtains an image representing an alignment between an optical fiber array and an optical transceiver. For example, the image sensor 2020 may capture images showing how the one or more fiber arrays 2012 are optically aligned with the optical transceiver 120 based on reflected optical signals 2034.

At 2204, the system determines one or more properties associated with the images. For example, the positioning system 2030 may determine one or more properties associated with the captured image (e.g., relative position between the pixels/alignment marks and the spots 2122, 2124, 2126, and 2128, the spot size of the spots 2122, 2124, 2126, and 2128, etc.) using image analysis software or machine-learned models.

At 2206, the system determines a misalignment offset between the optical fiber array and the optical transceiver using image analysis software or machine-learned models. The misalignment may be linear (e.g., x, y, and/or z) or angular.

At 2208, the system determines whether the misalignment offset satisfies a predetermined threshold. For example, the positioning system 2030 may determine whether the spots 2122, 2124, 2126, and 2128 are within their designated pixel groups. As another example, the positioning system 2030 may determine whether the spots 2122, 2124, 2126, and 2128 are focused on the surface plane of the optical transceiver 120.

At 2210, in response to determining that the misalignment offset does not satisfy the predetermined threshold, the system may realign the optical fiber array unit and an optical transceiver. For example, the positioning system 2030 may determine that there is a linear offset of 20 μm between the alignment mark 2132 and the spot 2122. In response to such determination, the positioning system 2030 may then issue a control signal to move the first stage (holding the fiber array unit 170) or the second stage (holding the optical transceiver 120) for 20 μm.

At 2212, in response to determining that the misalignment offset satisfies the predetermined threshold, the system may seal the optical fiber array unit and the optical transceiver. For example, once the positioning system 2030 determines that the misalignment offset satisfies the predetermined threshold, the positioning system 2030 may fix the first and second stages, and issue a control signal to apply an epoxy to seal the holder 2022 to the optical transceiver 120.

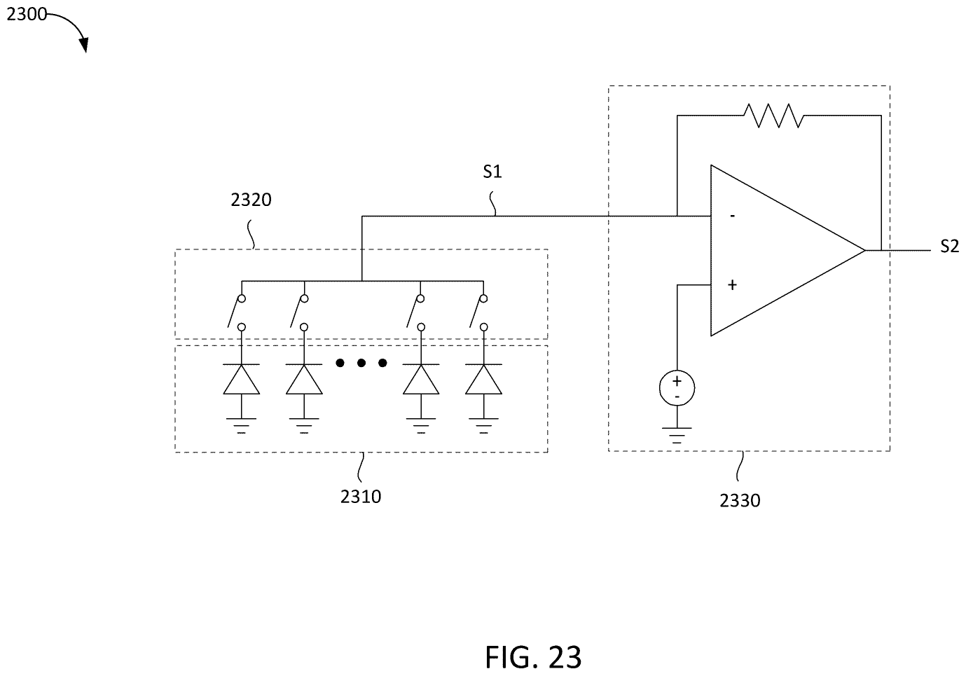

As described in FIG. 21A, in some implementations, optical signals from an optical fiber may be received by a subset of the photodetectors in a photodetector group after packaging. Accordingly, there are technical benefits (e.g., power saving and reducing optical cross talk) to have an optical receiver that can selectively deactivate certain photodetectors that do not receive light during operations. FIG. 23 illustrates an example optical receiver 2300, where one or more photodetectors in a photodetector group 2310 (e.g., any one of the photodetector groups 2112, 2114, 2116, and 2118 in reference to FIG. 21A) may be coupled or decoupled to a readout circuitry.

The optical receiver 2300 includes a photodetector group 2310, a switching array 2320, and a TIA 2330. The switching array 2320 can be configured to selectively couple to the one or more photodetectors formed on the photodetector array 2310 and output one or more signals S1 (e.g., current) to the TIA 2330. The TIA 2330 is configured to convert the one or more signals S1 to one or more analog output signals S2 (e.g., voltage).

In some implementations, multiple photodetectors in the photodetector group 2310 can be coupled to the switching array 2320. For example, referring to FIG. 21A, the spot 2122 from an optical fiber overlaps a 3-by-3 photodetector array in the photodetector group 2112, and the switching array 2320 can be configured to activate these 3-by-3 photodetectors, and deactivate the other photodetectors in the photodetector group 2112. Referring to FIG. 21B as another example, if after packaging, the spot 2122 from an optical fiber overlaps a 3-by-4 photodetector array in the photodetector group 2112, and the switching array 2320 can be configured to activate these 3-by-4 photodetectors, and deactivate the other photodetectors in the photodetector group 2112. By deactivating certain photodetectors, the optical receiver consumes less overall power. In addition, the deactivated photodetectors do not convert optical signals into electrical signals, so optical crosstalk from adjacent fibers (e.g., from spots 2124 and 2126) can be reduced, and thereby increasing a signal-to-noise ratio of the receiver.

In some implementations, the receiver setting shown in FIG. 23 can also be applied to the case of a transmitter setting. For example, the TIA 2330 is replaced by a LDD (laser/light-emitting diode driver), and the photodetector group 2310 is replaced by a laser/light-emitting diode group. Accordingly, there are technical benefits (e.g., power saving and excluding unreliable emitters over time) to have an optical transmitter that can selectively deactivate certain laser/light-emitting diodes that do not emit light during operations.

Unless otherwise specified, as used herein, the terms “photodetector”, “optical sensor”, “optical sensing apparatus”, or other similar terms can include a device that has been designed and/or operated as a photodiode (PD), an avalanche photodiode (APD), a single-photon avalanche diode (SPAD), or a locked-in PD (LIPD).

As used herein, the terms such as “first”, “second”, “third”, “fourth” and “fifth” describe various elements, components, regions, layers and/or sections, these elements, components, regions, layers and/or sections should not be limited by these terms. These terms may be only used to distinguish one element, component, region, layer or section from another. The terms such as “first”, “second”, “third”, “fourth” and “fifth” when used herein do not imply a sequence or order unless clearly indicated by the context. The terms “photo-detecting”, “photo-sensing”, “light-detecting”, “light-sensing” and any other similar terms can be used interchangeably.

Spatial descriptions, such as “above”, “over,”, “under”, “top”, and “bottom” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein and not otherwise defined, the terms “substantially” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the concepts have been described by way of examples and in terms of embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical link, comprising:
an optical transceiver comprising:
an optical-emitter chip having multiple light sources configured to emit first optical signals in parallel, wherein the multiple light sources are arranged in a two-dimensional array;
an optical-receiver chip having multiple photodetectors configured to detect second optical signals in parallel, wherein the multiple photodetectors are arranged in a two-dimensional array; and
a circuitry chip having circuitry configured to control the optical-emitter chip and the optical-receiver chip,
wherein the optical-receiver chip is stacked between the optical-emitter chip and the circuitry chip, and
wherein each of the multiple photodetectors comprises:
a silicon layer having a first surface and a second surface, the silicon layer comprising:
a first p-doped region;
an n-doped region;
a second p-doped region formed between the first p-doped region and the n-doped region;
an absorption region formed between the first p-doped region and the second p-doped region, wherein the absorption region is configured to receive an optical signal of the second optical signals and convert at least a first part of the optical signal into an electrical signal having electrons and holes; and
an amplification region formed between the second p-doped region and the n-doped region, wherein the amplification region is configured to amplify the electrons.

2. The optical link of claim 1, further comprising a fiber-array unit having a first group of fibers and a second group of fibers, wherein the first group of fibers is optically coupled to the multiple light sources, and wherein the second group of fibers is optically coupled to the multiple photodetectors.

3. The optical link of claim 1, wherein each of the multiple light sources comprises a micro-light-emitting-diode (micro-LED) or a vertical-cavity surface-emitting laser (VCSEL).

4. The optical link of claim 1, wherein the optical transceiver is packaged on a printed-circuit-board.

5. The optical link of claim 1, wherein the optical transceiver is packaged on a multi-chip module (MCM) substrate.

6. The optical link of claim 1, wherein the optical transceiver is packaged on an interposer.

7. The optical link of claim 1, wherein the optical transceiver is packaged on a processor chip or a memory, and
wherein the processor chip comprises one or more of a graphics processing unit (GPU) chip, a central processing unit (CPU) chip, or a neural processing unit (NPU) chip.

8. The optical link of claim 1, wherein each of the multiple photodetectors comprises multiple subsets of photodetectors, and wherein each subset of photodetectors is electrically binned together to detect optical signals from a corresponding light source of the multiple light sources.

9. The optical link of claim 1, wherein each of the multiple photodetectors comprises a trench filled with a dielectric material, and wherein the absorption region is between the trench and the amplification region.

10. The optical link of claim 1, wherein the optical transceiver is configured to receive electrical data at a first data rate over a first number of lanes, and to output the first optical signals comprising optical data at a second data rate over a second number of lanes, wherein the first data rate and the second data rate are different, and wherein the first number of lanes and the second number of lanes are different.

11. The optical link of claim 10, wherein the electrical data is encoded using a first encoding scheme, and wherein the optical data is encoded using a second encoding scheme.

12. The optical link of claim 1,
wherein the multiple light sources comprise multiple first light sources optically coupled with a first optical waveguide,
wherein the multiple first light sources comprise one or more first primary light sources and one or more first redundant light sources, and
wherein the optical link further comprises a processor configured to control the multiple first light sources such that at least one of the one or more first primary light sources transmits optical signals, and at least one of the one or more first redundant light sources does not transmit optical signals.

13. The optical link of claim 12, wherein the processor is further configured to:
determine that a primary light source of the one or more first primary light sources has malfunctioned; and
in response to determining that the primary light source of the one or more first primary light sources has malfunctioned, control the multiple first light sources such that the primary light source stops transmitting optical signals, and one of the one or more first redundant light sources transmits optical signals.

14. The optical link of claim 1,
wherein the multiple light sources comprise multiple first light sources optically coupled with a first optical waveguide, and
wherein the optical link further comprises a processor configured to control, based on a pulse-amplitude-modulation (PAM) coding scheme having more than two levels, which one or more of the multiple first light sources to emit optical signals, wherein a specific level of the PAM coding scheme is represented by a number of one or more first light sources of the multiple first light sources that emit the optical signals.

15. An optical link, comprising:
an optical transceiver comprising:
an optical-emitter chip having multiple light sources configured to emit first optical signals in parallel, wherein the multiple light sources are arranged in a two-dimensional array;
an optical-receiver chip having multiple photodetectors configured to detect second optical signals in parallel, wherein the multiple photodetectors are arranged in a two-dimensional array; and
a circuitry chip having circuitry configured to control the optical-emitter chip and the optical-receiver chip,
wherein the optical-receiver chip is stacked between the optical-emitter chip and the circuitry chip, and
wherein each of the multiple photodetectors comprises:
a silicon layer having a first surface and a second surface, the silicon layer comprising:
a trench formed along the first surface;
an n-doped region;
a p-doped region formed along the second surface; and
a first absorption region formed between the n-doped region and the p-doped region; and
a second absorption region formed in the trench, wherein the second absorption region comprises germanium, and
wherein the n-doped region and the p-doped region are biased to form an amplification region in the first absorption region.

16. The optical link of claim 15, wherein, during an operation, the first absorption region is configured to receive an optical signal and convert a first portion of the optical signal into a first electrical signal having holes and electrons, wherein the holes are collected by the p-doped region, and wherein the electrons are amplified by the first absorption region and collected by the n-doped region as a readout signal.

17. The optical link of claim 16,
wherein the second absorption region is configured to receive a second portion of the optical signal and convert the second portion of the optical signal into a second electrical signal having second holes and second electrons, and
wherein the second absorption region comprises a second p-doped region configured to collect the second holes, and wherein the second electrons are drifted to and collected by the n-region as a readout signal.

18. The optical link of claim 15, further comprising a fiber-array unit having a first group of fibers and a second group of fibers, wherein the first group of fibers is optically coupled to the multiple light sources, and wherein the second group of fibers is optically coupled to the multiple photodetectors.

19. An optical link, comprising:
an optical transceiver comprising:
an optical-emitter chip having multiple light sources configured to emit first optical signals in parallel, wherein the multiple light sources are arranged in a two-dimensional array;
an optical-receiver chip having multiple photodetectors configured to detect second optical signals in parallel, wherein the multiple photodetectors are arranged in a two-dimensional array; and
a circuitry chip having circuitry configured to control the optical-emitter chip and the optical-receiver chip,
wherein the optical-receiver chip is stacked between the optical-emitter chip and the circuitry chip, and
wherein each of the multiple photodetectors comprises:
a high-conductivity region that is p-doped;
a high-field region that is n-doped; and
an absorption region arranged between the high-conductivity region and the high-field region,
wherein the absorption region is configured to receive an optical signal of the second optical signals and to generate electrons and holes,
wherein the high-conductivity region is configured to collect at least a portion of the holes,
wherein the high-field region is configured to collect at least a portion of the electrons,
wherein a peak doping concentration of the absorption region is lower than a peak doping concentration of the high-conductivity region, and
wherein a thickness of the high-field region is smaller than an absorption length associated with a wavelength of the optical signal.

20. The optical link of claim 19, wherein a wavelength of the optical signal is in a visible wavelength spectrum.
